(19) United States
(12) Patent Application Publication
(10) Pub. No.: US 2023/0274584 A1
(43) Pub. Date: Aug. 31, 2023

(54) SYSTEM OF PRIVACY ORIENTED AUTOMATED ELECTRIC VEHICLE MILES TRAVELED USAGE FEE ASSESSMENT AND SETTLEMENT USING UTILITY SMART GRID COMMUNICATION NETWORK

(71) Applicant: Explication Automation, LLC, St. Louis, MO (US)

(72) Inventor: Mark S. Dunger, Frontenac, MO (US)

(21) Appl. No.: 18/083,693

(22) Filed: Dec. 19, 2022

Related U.S. Application Data
(62) Division of application No. 17/120,509, filed on Dec. 14, 2020.
(60) Provisional application No. 62/947,052, filed on Dec. 12, 2019.

(51) Int. Cl. G07C 5/00; G01C 21/26; G06F 21/62; G06Q 20/14; G06Q 30/0283; G06Q 30/04; G06Q 50/06; G07C 3/04; G07C 5/04; G07C 5/08

(52) U.S. Cl. CPC G07C 5/008; G01C 21/26; G06F 21/6245; G06Q 20/145; G06Q 30/0284; G06Q 30/04; G06Q 50/06; G07C 3/04; G07C 5/04; G07C 5/0875; G06F 2221/2113

(57) ABSTRACT

Apparatuses and methods for the assessment of electric vehicle usage fees for electric and hybrid-electric vehicles usage of roadways and waypoints over publicly or privately funded thoroughfares are disclosed herein. Exemplary implementations address automated systems of assessing fees charged for roadway and waypoint usage as applied to vehicle mileage traveled over functionally classified thoroughfares, collection of usage charges, settlement of payments to jurisdictional authorities, and/or periodic reconciliation of vehicle mileage traveled. The implementations include electric vehicles with user interfaces that have selectable trust level inputs, systems to calculate and store position information, road classes and waypoints travelled, and vehicles and users information. In one implementation(s) the electric vehicle transmits the report through a local area network based on the selected trust level, to a remotely located receiver node.

### CROSS REFERENCE

The present invention is a divisional of U.S. patent application Ser. No. 17/120,509 filed Dec. 14, 2020, which claims priority to and the benefit of U.S. Provisional Patent Application No. 62/947,052 filed Dec. 12, 2019, the contents of which are incorporated herein by reference in its entirety and made a part hereof.

### BACKGROUND OF THE INVENTION

### Field of Invention

This technology as disclosed herein relates generally to assessment of roadway fees for electric and hybrid-electric vehicles.

### Background

During the past century, excise taxes collected by providers of petroleum-based fuels (e.g., gasoline and diesel) and remitted to government authorities have been utilized to build and maintain the roadways and bridges of the United States' transportation infrastructure. With some exceptions (e.g., farming, off-highway business use, certain buses) those federal and state taxes have been considered to be “user fees” for the use of the infrastructure regardless as to whether the fossil fuels were actually consumed on taxpayer funded roadways, on private roadways or for off-road purposes.

With the growing popularity of hybrid-electric and wholly electric vehicles, for which there is no current standard approach to collect roadway usage fees, United States government and state authorities must develop a means of collecting user fees to supplement the taxes collected on petroleum-based fuels. The lack of adequate excise tax collections on electric vehicles combined with the increasing fuel efficiencies of petroleum powered vehicles is placing increasing pressure on the funds available to maintain roadways, bridges, dams and tunnels.

Mechanisms to collect fees have been attempted (including tolling and congestion pricing) and programs to collect usage fees for vehicle miles traveled have been trialed. Tolling and congestion pricing are problematic as solutions depending on whether the territory is densely or sparsely populated. One approach for collecting user fees for vehicle miles traveled has been disclosed in the trial conducted in Oregon, wherein a flat periodic user fee was offered along with an option for a flat usage fee per mile traveled. The per mile approach included the use of a tracking device installed in the vehicle to measure mileage traveled. The usage fee would be paid by credit or debit card. The state of Washington also completed a trial wherein the vehicle owner could either prepay or post-pay based on an odometer reading, with a GPS option to exclude out of state travel from taxation. Other states that have conducted trials include Iowa, Minnesota and Nevada.

The shortcomings of these trials included: a combination of deficiencies in automation, as many of the participants were either required to manually engage in a mileage reporting process or a vehicle owner would be required to utilize a cellular data plan to transmit vehicle mileage to a collection center; the broad based application of usage fees to all mileage driven as opposed to usage fees applied solely to mileage on publicly funded roadways or specifically authorized private thoroughfares; the collection of specific coordinate data for routes traveled (which fosters privacy concerns); a general lack of standardization in the approach to mileage collection across multiple jurisdictions; and an absence of interjurisdictional settlement processes.

There are currently no comprehensive systems to solve these problems and known systems do not incorporate mechanisms to correct these shortcomings. Better apparatuses and/or methods are needed for improving the ability to assess roadway fees for electric and hybrid-electric vehicles; such apparatuses and methods are disclosed herein.

### BRIEF SUMMARY OF THE INVENTION

The technology as disclosed herein includes methods and apparatuses for the assessment of electric vehicle usage fees for electric and hybrid-electric vehicles, and, more particularly, to systems and methods that utilize an electric utility's smart grid communication network to assist in the automated assessment of fees attributable to the usage of roadways and waypoints (e.g., bridges, dams, tunnels, etc.) traveled by electric or hybrid-electric vehicles over publicly or privately funded thoroughfares. One implementation(s) of the system and/or method includes and/or utilizes: an electric vehicle with a user interface that has selectable trust level inputs; systems to calculate and store data in a report that includes position information of the electric vehicle, road classes and waypoints travelled, and vehicle and user information. In this implementation(s) the electric vehicle transmits the report through a local area network based on the selected trust level, to a remotely located receiver node.

These systems can further include implementations where the remotely located receiver node comprises an electric utility service provider, or third party, vehicle database and a processor that calculates a usage fee owed to a fee collecting jurisdictional authority. Additionally, the systems can further include implementations wherein an electric utility service provider, or a third party, billing system comprising a further processor that receives usage fee information from a plurality of electric utility service provider, and/or third party, vehicle databases and prepares usage fee remittance advice to one or more fee collecting jurisdictional authority. And, the systems can further comprise implementations wherein at least one fee collecting jurisdictional authority can determine the usage fee to be a tax.

These systems can further include one or more of the following such that the report: comprises a sequence of data that is not encrypted, comprises a sequence of data that is encrypted, is not encrypted and comprises compiled data, and is encrypted and comprises compiled data. These systems can further include implementations wherein the datalogger memory is cleared based on the selected trust level or is cleared by an end of life decommissioning of the vehicle. These systems can further include wherein the remotely located receiver node comprises a wireless transceiver, or the remotely located receiver node comprises a modem, or the electric vehicle communicating node comprises a wireless transceiver, or the electric vehicle communicating node comprises a modem, or the local area network comprises a personal area network or home area network.

These systems can further comprise electric vehicle charging equipment in communication with the electric vehicle, and wherein an electric utility meter is a communicating node that collects charging session information and the datalogger report and transmits both as a table to an electric utility service provider vehicle database, and further comprising a processor that calculates a usage fee owed to a fee collecting jurisdictional authority. And further, these systems can further comprise wherein the electric vehicle charging equipment comprises an embedded local area network node, or be configured whereby the user causes the electric vehicle to store in long-term erasable memory the trust level selection for specific electric vehicle charging equipment by means of the electric vehicle user interface.

Another implementation(s) of the system and/or method includes and/or utilizes methods of: configuring an electric vehicle comprising an electric vehicle user interface having a plurality of selectable trust level inputs; also calculating the geographic position of the electric vehicle and distinguishing road classes and waypoints with a navigation system that is in communication with a datalogger; additionally storing information comprising vehicle information and user information with an electronic control unit that is in communication with the datalogger; further creating a report with the datalogger based on a selected trust level that comprises vehicle information and user information retrieved from the electronic control unit, and information from the navigation system comprising mileage traveled by road classes and waypoints; and finally transmitting the report based on the selected trust level to a local area network comprising a plurality of communicating nodes, wherein the electric vehicle is a communicating node that transmits the report, and wherein a remotely located receiver node is a communicating node that receives the report based on the selected trust level.

These methods can further comprise including one or more of the following such that the report: comprises a sequence of data that is not encrypted, comprises a sequence of data that is encrypted, is not encrypted and comprises compiled data, and is encrypted and comprises compiled data.

These methods can further comprise calculating a usage fee owed to one or more fee collecting jurisdictional authority, issuing a usage fee billing to a vehicle user, and collecting a usage fee from a vehicle user. Moreover, these methods can further comprise remitting the collected usage fee: directly to a fee collecting jurisdictional authority, to an authorized third party settlement agency, to an electric utility service provider, or to an electric utility service provider that further remits the collected usage fee to a fee collecting jurisdictional authority or other authorized third party. These methods can further comprise wherein at least one fee collecting jurisdictional authority determines the usage fee to be a tax.

These methods can further comprise wherein the datalogger memory is cleared based on the selected trust level or is cleared by an end of life decommissioning of the vehicle.

These methods can further comprise wherein the remotely located receiver node comprises a wireless transceiver, the remotely located receiver node comprises a modem, the electric vehicle communicating node comprises a wireless transceiver, the electric vehicle communicating node comprises a modem, or the local area network comprises a personal area network or home area network. Alternatively or additionally these methods can further comprise charging the electric vehicle, collecting charging session information and the datalogger report and transmitting both to an electric utility service provider that is a communicating node. Also these methods can further comprise storing the trust level selection for specific electric vehicle charging equipment by means of the electric vehicle user interface.
[reserved]
[reserved]
[reserved]

Apparatuses and methods for assessment of roadway fees for electric and hybrid-electric vehicles. Exemplary embodiments address automated systems of assessing fees charged for roadway and waypoint usage as applied to vehicle mileage traveled over functionally classified thoroughfares, collection of usage charges, settlement of payments to jurisdictional authorities, and/or periodic reconciliation of vehicle mileage traveled. The embodiments include user selected charging session trust level settings for privacy protection and usage data collection processes such that time stamps and specific routes traveled are not to be provided or accessed by any party other than the vehicle owner or lessee absent their express permission. A roadway and waypoint usage report generated one implementation(s) is transmitted to an electric utility by means of the utility's smart grid network. Fees in one implementation(s) are calculated by the utility and said fees and any prepaid credits in one implementation(s) are included in the utility service billing.

The technology as disclosed herein includes methods and apparatuses for the assessment of roadway fees for electric and hybrid-electric vehicles, and, more particularly, to systems and methods that utilize an electric utility's smart grid communication network to assist in the automated assessment of fees attributable to the usage of roadways and waypoints (e.g., bridges, dams, tunnels, etc.) traveled by electric or hybrid-electric vehicles over publicly or privately funded thoroughfares. One implementation of the system and/or method includes and/or utilizes: a specific apparatus within the vehicle, the availability of advanced external vehicle charging equipment, and two-way communications capabilities between the vehicle and the electric utility service provider. The system operation provides methods to identify the respective jurisdiction where roadways and waypoints have been utilized, enabling usage fees to be calculated based upon the jurisdiction and class of roadway or waypoint traversed, while maintaining vehicle user privacy with respect to public routes utilized or public locations visited. Also provided herein are systems and methods for collecting usage fees from electric or hybrid-electric vehicle owners or lessees through periodic utility billings, and for subsequently calculating settlement amounts and efficiently effecting usage fee distributions across multiple jurisdictions by utility companies or their authorized agents.

In one implementation, a computer-implemented method comprises an operator determination that specific electric vehicle charging equipment and related communications apparatus are highly trustworthy leading to confidence in securely transmitting private operator information. In this state an electric vehicle is programmed to automatically prepare an optionally encrypted file containing vehicle, operator and operator's electric utility company identifying information along with vehicle mileage traveled information categorized by each of (a) roadway class and waypoint type and (b) fee collecting jurisdiction where said mileage was traveled. Further, the computer-implemented method calculates the fees owed by the operator to the fee collecting jurisdictions to be automatically billed to the operator through the operator's periodic electric utility company billing. Still further, the computer-implemented method comprises determining, with the one or more processors, settlement obligations between electric utility companies and fee collecting jurisdiction authorities and procedures for efficient payment. Still further, the computer-implemented method encompasses the use of one or more third party processing entity to perform processing, data storage and settlement services as agent to one or more electric utility company.

In another implementation, a computer-implemented method comprises an operator determination that specific electric vehicle charging equipment and related communications apparatus are moderately trustworthy leading to confidence in securely transmitting limited operator information. In this state an electric vehicle is programmed to automatically prepare an encrypted file containing vehicle, operator and operator's electric utility company identifying information but excludes vehicle mileage traveled information. The computer-implemented method initiates a transmission of the vehicle, operator and operator's electric utility company identifying information to the electric utility company that provides service to the specific electric vehicle charging equipment and a deferred billing is initiated for the electricity transferred to the electric vehicle (and any processing fee) to be collected by the operator's electric utility company in a subsequent billing. Further, the computer-implemented method comprises determining, with the one or more processors, settlement obligations between electric utility companies and fee collecting jurisdiction authorities and procedures for efficient payment. Still further, the computer-implemented method encompasses the use of one or more third party processing entity to perform processing, data storage and settlement services as agent to one or more electric utility company.

In still another implementation, a computer-implemented method comprises an operator determination that specific electric vehicle charging equipment and related communications apparatus are not trustworthy leading to a complete lack of confidence in securely transmitting operator information. In this state an electric vehicle is programmed to automatically transmit vehicle identification information and payment method including credit, debit or prepaid mechanisms. No other identifying information is provided and no vehicle mileage traveled information is transmitted. In one implementation(s), the computer-implemented method utilizes the specific electric vehicle charging equipment and related communications apparatus to transmit a receipt to each of the electric vehicle charging equipment host electric utility company and to the electric vehicle itself for temporary storage in an acceptable file format that contains the identification of the electric vehicle charging equipment, the value of the electricity transferred and the amount of respective prepaid tax. Further, the computer-implemented method comprises an automated transmission of the receipt from the vehicle to the operator's electric utility company upon the occurrence of a subsequent highly trustworthy charging session enabling a credit to be confirmed relative to the prepaid tax. The computer-implemented method optionally further comprises a registry of vehicle identification numbers and the associated vehicle operator's corresponding primary electric utility company being made available to electric utility companies thereby allowing the forwarding of the receipt provided by the electric vehicle charging equipment to its host electric utility company that includes the vehicle identification number to the electric vehicle operator's electric utility company to provide a second source of evidence in support of the amount of the prepaid tax. Still further, the computer-implemented method comprises determining, with the one or more processors, settlement obligations between electric utility companies and fee collecting jurisdiction authorities and procedures for efficient allocation or apportionment of prepaid tax. Still further, the computer-implemented method encompasses the use of one or more third party processing entity to perform processing, data storage and settlement services as agent to one or more electric utility company.

The computer-implemented method includes a reconciliation process for comparing an odometer reading to the cumulative mileage reported by the automated usage fee system to occur during the electric vehicle periodic safety inspection to be conducted by an authorized state service facility.

In a further implementation(s) of the system and/or method includes and/or utilizes systems of settling electric vehicle usage fees between electric utility service providers and jurisdictional authorities. These systems comprise: a means of communication for an authorized party to digitally and securely collect electric vehicle user information from an electric utility service provider; an authorized third party database that collects electric vehicle user information and thoroughfare usage attributable to discrete jurisdictions traveled from a plurality of electric utility service provider databases; an authorized third party processor that determines the amount of usage fees to be billed to an individual electric vehicle user; a further authorized third party processor that determines the collective usage fees attributable to one or more electric vehicle user to be collected by an electric utility service provider that will be remitted to a jurisdictional authority for a defined billing period; a means of communication allowing the authorized third party to transmit the remittance calculations to one or more electric utility service provider for inclusion in the electric vehicle user periodic billing; a further authorized third party processor that calculates remittance amounts owed between jurisdictional authorities and prepares a usage fee remittance advice to a fee collecting jurisdictional authority; an authorized third party collection and remittance processor that facilitates payment received from an electric utility service provider and transmits monetary sums to one or more jurisdictional authority; an authorized third party collection and remittance processor that facilitates payment received from a jurisdictional authority and transmits monetary sums to one or more jurisdictional authority.

These systems can further comprise wherein the authorized third party database collects billing determinants and usage information, computes electric vehicle user fees owed to one or more private entity attributable to said users travel over respective private thoroughfare, communicates with utility service providers to enable collection of usage fees from one or more electric vehicle user, provides periodic reports to one or more private entity, facilitates collection of payment from one or more utility service provider and transmits payment to one or more private entity.
[reserved]
[reserved]
[reserved]
[reserved]

The features, functions, and advantages that have been discussed can be achieved independently in various implementations or can be combined in yet other implementations, further details of which can be seen with reference to the following description and drawings.

These and other advantageous features of the present technology as disclosed will be in part apparent and in part pointed out herein below.

### BRIEF DESCRIPTION OF THE DRAWINGS

For a better understanding of the present technology as disclosed, reference can be made to the accompanying drawings in which:

FIG. 1 depicts an implementation of an electric vehicle with a vehicle electronic reporting system including a navigation system, at least one navigation system antenna to receive satellite transmissions; a vehicle communication bus, at least one electronic control unit, a datalogger transceiver with memory, a datalogger report writer, a communication gateway and a transmission access point.

FIG. 2 depicts the components of the datalogger and adjunct report writer;

FIG. 3 depicts an implementation of an electric vehicle connected to electric vehicle charging equipment and the communication path from the electric vehicle to a utility head-end;

FIG. 4 depicts an implementation of the interior of an electric vehicle including a touch-screen graphic user interface and an on-board diagnostics port;

FIG. 5 depicts an implementation of a graphic user interface screen for initiating charger setup and establishing credentials;

FIG. 6 depicts an implementation of a graphic user interface screen for identifying the primary electric utility service provider for the billing address of the electric vehicle owner or lessee and said electric vehicle owner's or lessee's primary electric utility service provider designated account number;

FIG. 7 depicts an implementation of a graphic user interface screen for selecting a trust level of a charging session with given electric vehicle charging equipment;

FIG. 8 depicts an implementation of a graphic user interface screen for selecting settings for one or more charging sessions with given highly trusted electric vehicle charging equipment;

FIG. 9 depicts an implementation of an optionally encrypted file generated by a datalogger report writer associated with a highly trusted electric vehicle charging session;

FIG. 10 depicts an implementation of a graphic user interface screen for selecting settings for one or more charging sessions with given moderately trusted electric vehicle charging equipment;

FIG. 11 depicts an implementation of an encrypted file generated by a datalogger report writer associated with a moderately trusted electric vehicle charging session and an electricity purchase receipt transmitted to the electric vehicle by the electric vehicle charging equipment;

FIG. 12 depicts an implementation of a graphic user interface screen for selecting settings for use of a credit card for payment of one or more charging sessions with given electric vehicle charging equipment in a low trust environment;

FIG. 13 depicts an implementation of a graphic user interface screen for selecting settings for use of a debit card for payment of one or more charging sessions with given electric vehicle charging equipment in a low trust environment;

FIG. 14 depicts an implementation of a graphic user interface screen for selecting settings for use of an alternate payment method for one or more charging sessions with given electric vehicle charging equipment in a low trust environment;

FIG. 15 depicts an implementation of payment credentials transmitted by an electric vehicle associated with an untrusted electric vehicle charging session and an electricity purchase receipt transmitted to the electric vehicle by the electric vehicle charging equipment;

FIG. 16 depicts an illustrative flow diagram of an implementation for transmittal of a vehicle miles traveled usage report through the vehicle gateway over the vehicle communication bus to an access point for transmittal to a communicating electric utility meter for further transmission to an electric utility service provider head-end;

FIG. 17 depicts an illustrative flow diagram of an implementation of a plurality of electric vehicle transmissions through an electric utility meter engaged in a communication session with a given electric vehicle, said electric utility meter transmitting charging session information to an electric utility service provider head-end, said electric utility service provider head-end further transmitting said electric utility meter transmitting charging session information to an authorized third party processor, settlement and storage service provider;

FIG. 18 depicts an illustrative flow diagram of an implementation processing and settlement service including production of usage fee calculations included on an electric vehicle owner's or lessee's periodic electric utility billing;

FIG. 19 depicts an illustrative flow diagram of an implementation of exemplar trust level options (highly trusted, moderately trusted and low trust conditions) associated with a plurality of smart hybrid electric vehicle charging (“SHEVC”) environments, and the associated hybrid-electric vehicle (“HEV”) actions that proceed on the basis of the trust level selected.

The diagram in FIG. 20 depicts an implementation of the summary architecture for the electric vehicle thoroughfare and waypoint usage fee ecosystem(s), inclusive of geolocation satellites and fixed infrastructure transmitters providing coordinates to an electric vehicle(s), available electric vehicle(s) charging equipment positioned in disparate locations, nodes for communications between an electric vehicle(s) and an electric utility service provider(s) represented by smart communicating meters, utility service providers located in disparate jurisdictions in communication with an authorized third party usage fee settlement service provider(s), various pathways for communicating settlement fee calculations and effecting settlement payments and optional information communication pathways between an electric vehicle(s) and the authorized third party service provider(s) and an electric vehicle user(s) and the authorized third party service provider(s). This unique architecture represents a novel approach to the automated collection of usage fees attributable to VMT.
[reserved]
[reserved]

While the technology as disclosed is susceptible to various modifications and alternative forms, specific implementations thereof are shown by way of example in the drawings and will herein be described in detail. It will be understood, however, that the drawings and detailed description presented herein are not intended to limit the disclosure to the particular implementations as disclosed, but on the contrary, the intention is to cover all modifications, equivalents, and alternatives falling within the scope of the present technology as disclosed and as defined by the appended claims.

### DETAILED DESCRIPTION OF THE INVENTION

### Definitions

“HEVs” means electric vehicles and plug-in hybrid-electric vehicles, collectively. Additionally, the term “electric vehicle” generally refers to both electric and hybrid-electric vehicles, but can also refer to either individually or collectively.

“SHEVC” means Smart HEV Charger.

“TSHEVCs” means trusted SHEVCs.

“AT2P3S” means authorized third party processing/settlement/storage service.

“VOPEUSP” means vehicle owner's/lessee's primary electric utility service provider.

“VMT” means Vehicle Miles Traveled.

“VMT Meter Module” means a device deployed to accept GPS data which will be converted into a secure report that identifies the roadway classes and key waypoints traveled by an HEV. The latitude and longitude coordinates that are generated by the GPS receiver and transferred to temporary memory within the data logger for processing (within the HEV) by the VMT Meter Module can be summarized in a report generated by the VMT Meter Module that includes information sufficient to calculate VMT use fees. There are a variety of mediums which are utilized to accomplish the task of transmitting the report, including wired and wireless options.

“V2X” means Vehicle-to-X. “[T]he concept of vehicle-to-X (V2X), which transmits electricity from an on-board battery to infrastructure, is expected to be a key to smart grids. With V2X technology, we can use electricity stored in large-capacity batteries of electric vehicles (EVs) and plug-in hybrid-electric vehicles (PHEVs) when necessary.” (https://global-sei.com/technology/tr/bn79/pdf/79-08.pdf). Further “V2X” is a collective term for vehicle to live (V2L), vehicle to home (V2H) and vehicle to grid (V2G). Id.

An “event” as used herein can refer to an end of life decommissioning of the vehicle.

“Fee collecting jurisdictional authority” refers to a fee collecting authority (whether public utility, private, or hybrid) for either, or both, travel over a publicly funded thoroughfare(s) and travel over a privately funded thoroughfare; a “fee collecting jurisdictional authority” refers to any and all possible combinations, such combinations being either inclusive or exclusive, of local, state, or federal department(s) of revenue or private subdivision for vehicular travel; it is understood that the term “fee collecting jurisdictional authority” encapsulates both government agencies and private roadway authorities.

“Third party vehicle database” or “third party billing system” refer to a vehicle database or billing system of any third party that is not directly a fee collecting jurisdictional authority.

“Remotely located receiver node” refers to a node connected through either wired (e.g. modem and powerline) or wireless (e.g. transceiver) connection, or a combination of two or more such connections that is outside of the confines of the HEV.

“Electric meter table” refers to transmission tables for electric utility providers that are commonly referred to as “Tucker Tables” or ANSI C19.12 data tables.

“Waypoint” means the geolocation of any bridge, dam, tunnel or other specially designated passageway or thoroughfare that may involve a specific surcharge for its usage.

“Trackpoint(s)” includes common usage defining a track formed by connecting the points with lines and the “track” would represent the road, trail, path, etc. that you followed (more information may be found at https://gpsmap.net/DefiningPoints.html).
[reserved]
[reserved]

Implementation(s) of the invention are discussed below with reference to the Figures. However, those skilled in the art will readily appreciate that the detailed description given herein with respect to these figures is for explanatory purposes as the invention extends beyond these limited implementations. For example, it will be appreciated that those skilled in the art will, in light of the teachings of the present invention, recognize a multiplicity of alternate and suitable approaches, depending upon the needs of the particular application, to implement the functionality of any given detail described herein, beyond the particular implementation choices described and shown. That is, there are modifications and variations of the invention that are too numerous to be listed but that all fit within the scope of the invention.

Singular words should be read as plural and vice versa and masculine as feminine and vice versa, where appropriate, and alternative implementations do not necessarily imply that the two are mutually exclusive. It is to be further understood that the present invention is not limited to the particular methodology, material, use, or application described herein, as these can vary. It is also to be understood that the terminology used herein is used for the purpose of describing particular implementations and embodiments only, and is not intended to limit the scope of the present invention.

It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and can include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that can be construed to express approximation should be so understood unless the context clearly dictates otherwise.

It will be further understood that use of the word “can” and/or “may” will be understood to refer to the active, and enabling, dictionary meanings of “is able,” “be able”, “to know,” “be able to through acquired knowledge or skill,” “to know how to do something,” and/or “to have the ability to do something”; and not understood to intend a sense of “maybe” or permissiveness.

Reference in the specification to “one embodiment” or “an embodiment”; “one implementation” or “an implementation” means that a particular feature, structure, or characteristic described in connection with the embodiment or implementation is included in at least one embodiment or implementation of the invention. The appearances of the phrase “in one embodiment,” or “in an embodiment,” or “in one implementation,” or “in an implementation” in various places in the specification are not necessarily all referring to the same embodiment or the same implementation, nor are separate or alternative embodiments or implementations mutually exclusive of other embodiments or implementations.

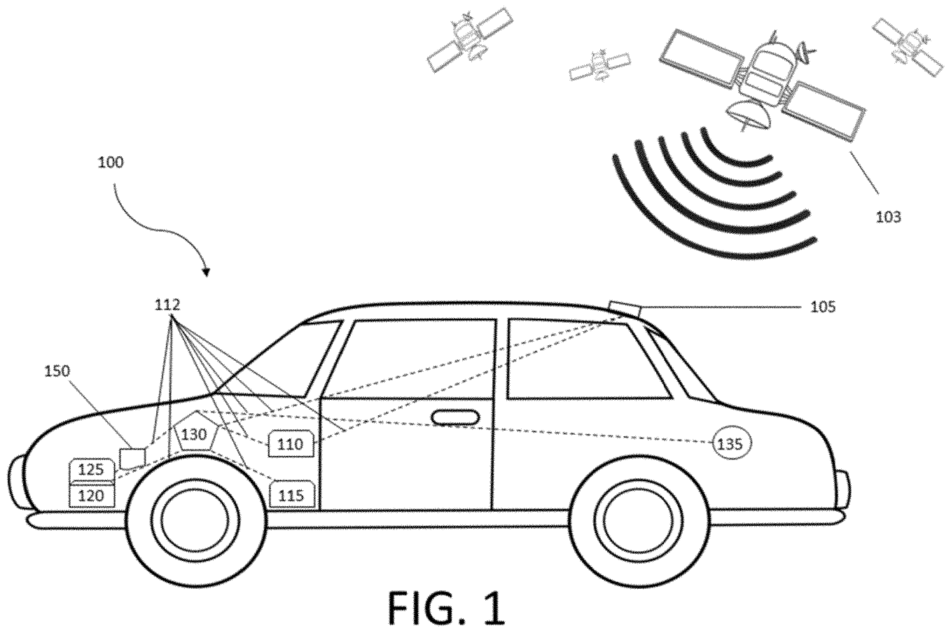

According to the implementation(s) of the present technology as disclosed, various views are illustrated in FIG. 1-20 and like reference numerals are being used consistently throughout to refer to like and corresponding parts of the technology for all of the various views and figures of the drawing. Also, please note that the first digit(s) of the reference number for a given item or part of the technology should correspond to the Fig. number in which the item or part is first identified.

Apparatuses and methods are provided for a system of automated assessment of VMT usage fees. As described in detail herein, in one implementation associated electronic data is acquired from a plurality of sensors (e.g., antennae), sources (e.g., a vehicle electronic control unit or a navigation system), and user inputs. The electronic data is collected by a datalogger in accordance with a software or firmware program. The electronic data includes, for example, any one of, all of, or any sub-combination of information stored by an electronic control unit (such as the vehicle identification number and the odometer value) and user inputs including the vehicle owner's (or lessee's) primary electric utility service provider unique identifier and the vehicle owner's (or lessee's) specific account number assigned by the primary electric utility service provider, trust level preference encryption keys associated with certain electric vehicle charging equipment, credentials for electricity purchase prepayment methods, and navigation system roadway class tags and waypoint tags for purposes of roadway class VMT distance accumulators, etc.

As further described in detail herein, in one implementation(s) electronic data and/or correlated electronic data is stored in, and/or transmitted from, a vehicle datalogger to a communicating electric utility meter either directly by wireless means or indirectly through the electric vehicle charging equipment. As yet further described in detail herein, an encrypted file containing information in a format designed to protect vehicle owner (or lessee) privacy (i.e., a roadway classes traveled summary and waypoints (e.g., bridge, dam, tunnel) traversed summary for each taxing jurisdiction) is produced that includes the vehicle identification number, unique electric utility identifier and electric vehicle owner's/lessee's electric utility account number, along with information concerning taxes paid relative to prepaid electricity purchases. Vehicle owner's/lessee's privacy exceptions are described for travel over private thoroughfares.

Details are provided herein relating to the calculation of roadway class and waypoint usage fees, inter-utility account settlements, issuance of credits for usage taxes collected on prepaid electricity purchases, collection of usage fees from vehicle owners/lessees (net of any prepaid usage tax), payments of collected usage fees to appropriate government authorities, payments of collected usage fees to private thoroughfare custodians, storage of summary information relating to VMT on the basis of the vehicle identification number, and usage of an authorized third party processor, settlement and storage service provider.

Turning to FIG. 1, in one implementation(s) an ELECTRIC VEHICLE 100 includes at least one ANTENNA 105 for receiving transmissions (e.g., from a plurality of SATELLITES 103) providing data sufficient to calculate said electric vehicle positioning by a NAVIGATION SYSTEM 110 connected to the COMMUNICATIONS GATEWAY 130 by an INTERNAL ELECTRIC VEHICLE COMMUNICATIONS NETWORK 112 (e.g., CANBUS, Ethernet, wireless) for analysis and storage by the DATALOGGER 120. An ELECTRONIC CONTROL UNIT 115 transmits data requested by the DATALOGGER 120 through the COMMUNICATIONS GATEWAY 130. The electronic DATALOGGER 120 with adjunct REPORT WRITER 125 generates a vehicle miles and waypoints traveled report, or FILE 150, including information retrieved from one or more ELECTRONIC CONTROL UNIT 115 (vehicle identification number, the vehicle owner's/lessee's primary electric utility provider unique identification number, the vehicle owner/lessee primary electric utility provider assigned account number, the odometer reading, and any receipt for sales tax attributable to prepaid electricity purchases) and information processed by the DATALOGGER 120 from NAVIGATION SYSTEM 110 inputs, such processed information including mileage traveled by road classes (e.g., Federal interstate, U.S. highway, municipal street, etc.) and special waypoints (bridges, tunnels, dams, etc.) within prescribed geographic territories. In one implementation(s), the DATALOGGER 120 FILE 150 is generated by the adjunct REPORT WRITER 125 upon the event of a charging session that is designated by the vehicle owner/lessee as a high trust level charging session, whereupon the DATALOGGER 120 with adjunct REPORT WRITER 125 causes the COMMUNICATIONS GATEWAY 130 to transmit the generated FILE 150 over the INTERNAL ELECTRIC VEHICLE COMMUNICATIONS NETWORK 112 to a vehicle owner's/lessee's predetermined authorized ACCESS POINT 135 or to an authorized transmission point, such as the ANTENNA 105, for external processing.

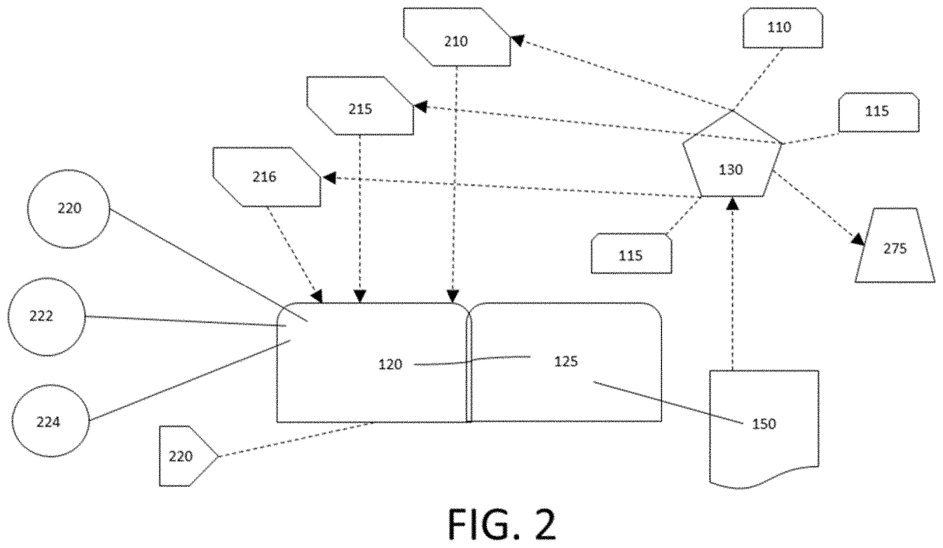

With reference to FIG. 2, in one implementation(s) the electronic DATALOGGER 120 of FIG. 1 is comprised of a (a) MICROPROCESSOR 220 for processing and organizing NAVIGATION SYSTEM INFORMATION 210 received from the COMMUNICATIONS GATEWAY 130 of FIG. 1 originating from the NAVIGATION SYSTEM 110 of FIG. 1, the ELECTRIC VEHICLE INFORMATION (e.g., vehicle identification number and odometer reading) 215 from the COMMUNICATIONS GATEWAY 130 of FIG. 1 originating from an ELECTRONIC CONTROL UNIT 115 of FIG. 1, and OTHER INFORMATION 216 (e.g., the vehicle owner's/lessee's primary electric utility provider unique identification number, the vehicle owner/lessee primary electric utility provider assigned account number, and any receipt for sales tax attributable to prepaid electricity purchases) from the COMMUNICATIONS GATEWAY 130 of FIG. 1 originating from an ELECTRONIC CONTROL UNIT 115 of FIG. 1, (b) INTERNAL MEMORY 222, (c) software or firmware CODE 224, and (d) a POWER SUPPLY 220 providing electricity to the DATALOGGER 120 of FIG. 1. The DATALOGGER 120 adjunct REPORT WRITER 125, both of FIG. 1, generates a FILE 150 of FIG. 1 including vehicle identification number, the vehicle owner's/lessee's primary electric utility provider unique identification number, the vehicle owner/lessee primary electric utility provider assigned account number, the electric vehicle mileage traveled by road classes (e.g., Federal interstate, U.S. highway, municipal street, etc.) and special waypoints (bridges, tunnels, dams, etc.) within prescribed geographic territories, and any receipt for sales tax attributable to prepaid electricity purchases. The FILE 150 of FIG. 1 is transmitted to and through the COMMUNICATIONS GATEWAY 130 for further distribution to authorized RECIPIENTS 275.

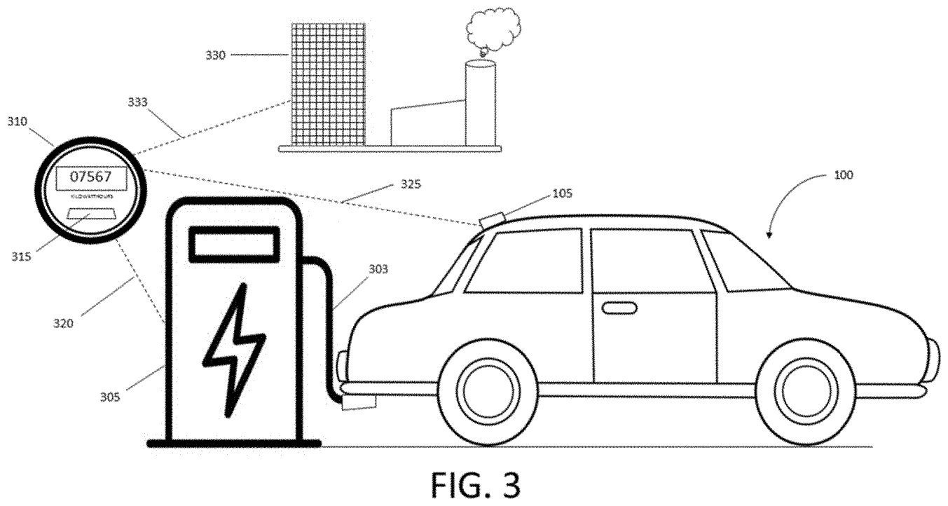

Turning to FIG. 3, in one implementation(s) the ELECTRIC VEHICLE 100 of FIG. 1 with ANTENNA 105 of FIG. 1 in one implementation(s) transmits the FILE 150 of FIG. 1 by WIRELESS MEANS 325 (e.g., BLUETOOTH, WI-FI, cellular, etc.) to a COMMUNICATING ELECTRIC UTILITY METER 310 with EMBEDDED COMMUNICATIONS MODULE 315 or by wired means utilizing the ELECTRIC VEHICLE CHARGING EQUIPMENT 305 CHARGING CORD 303 that is conductively connected to the ELECTRIC VEHICLE 100 of FIG. 1. The COMMUNICATING ELECTRIC UTILITY METER 310 in one implementation(s) is embedded within the ELECTRIC VEHICLE CHARGING EQUIPMENT 305 or conductively connected by WIRING 320 to the ELECTRIC VEHICLE CHARGING EQUIPMENT 305. The COMMUNICATIONS MODULE 315 of the COMMUNICATING ELECTRIC UTILITY METER 310 transmits the FILE 150 of FIG. 1 to the ELECTRIC UTILITY HEAD-END 330 by means of the SMART GRID COMMUNICATIONS NETWORK 333 which is presented as a wireless medium but can be a powerline, fiber optic, cable, etc., medium or a combination of wireless and wired mediums.

FIG. 3 depicts an implementation of a high trust level charging session wherein the FILE of FIG. 1 will be transmitted from the ELECTRIC VEHICLE 100 of FIG. 1 by wireless, wired, or a combination of wired and wireless mediums to the ELECTRIC UTILITY HEAD-END 330.

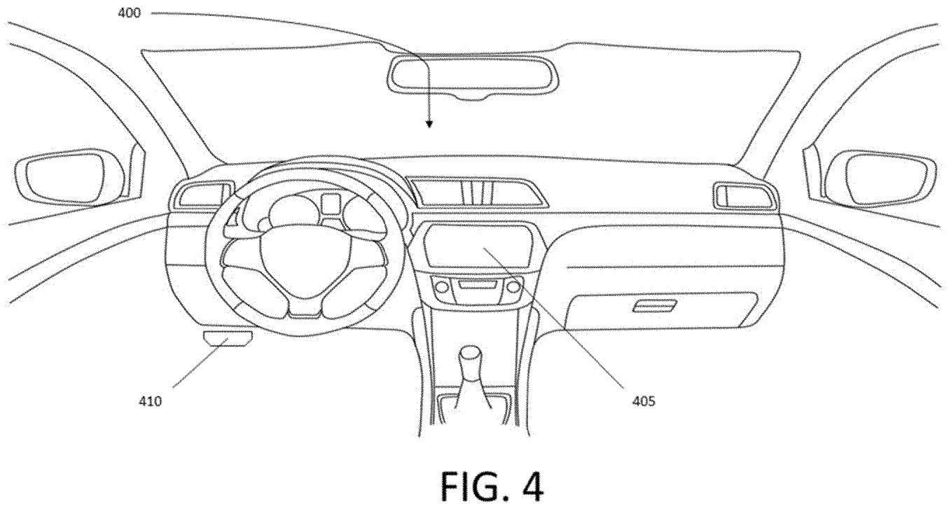

With reference to FIG. 4, an interior view of an ELECTRIC VEHICLE 100 of FIG. 1 DASHBOARD 400 with touchscreen GRAPHIC USER INTERFACE 405. The ELECTRIC VEHICLE 100 of FIG. 1 ON-BOARD DIAGNOSTICS PORT 410 is also identified.

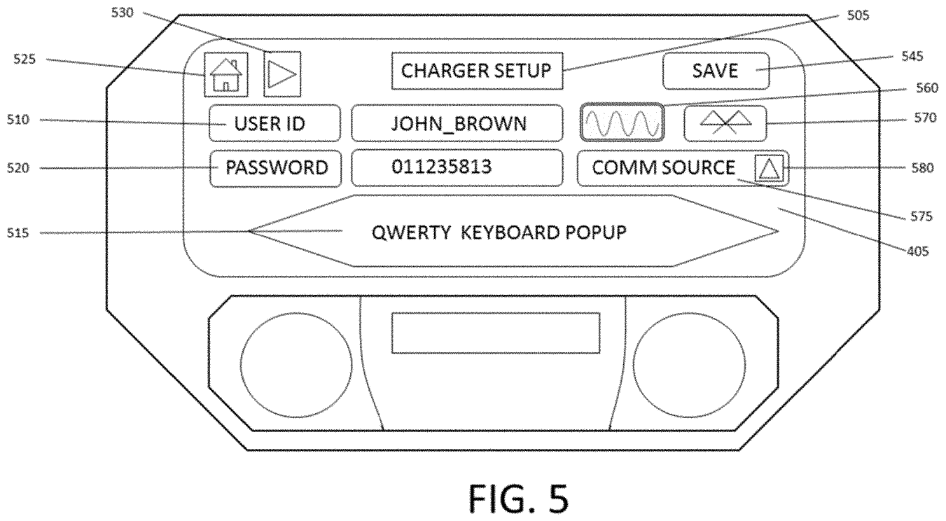

Turning to FIG. 5, the touchscreen GRAPHIC USER INTERFACE 405 of FIG. 4 presents a CHARGER SETUP 505 screen that in one implementation(s) is accessed in accordance with the ELECTRIC VEHICLE 100 of FIG. 1 manual instructions. The ELECTRIC VEHICLE 100 of FIG. 1 is to be engaged with the ELECTRIC VEHICLE CHARGING EQUIPMENT 305 of FIG. 3 if such equipment is designed to conductively transmit electricity to the vehicle. Assuming the conductive ELECTRIC VEHICLE CHARGING EQUIPMENT 305 of FIG. 3 is connected to the vehicle, the GRAPHIC USER INTERFACE would, in this implementation, indicate that wired communications are engaged between the COMMUNICATING ELECTRIC UTILITY METER 310 of FIG. 3 and the COMMUNICATIONS GATEWAY 130 of FIG. 1 by back-lighting the POWERLINE COMMUNICATIONS INDICATOR 560 within a prescribed time (e.g., 10 seconds). If the POWERLINE COMMUNICATIONS INDICATOR 560 fails to be backlit at the direction of the COMMUNICATIONS GATEWAY 130 of FIG. 1 within the prescribed time, then the COMMUNICATIONS GATEWAY 130 of FIG. 1 in one implementation(s) is programmed to engage in a process of searching for wireless communications signals. It is anticipated that the preferred wireless communications protocol for short range transmissions and receptions between the ELECTRIC VEHICLE 100 of FIG. 1 and the COMMUNICATING ELECTRIC UTILITY METER 310 of FIG. 3 will be BLUETOOTH (although options such as WI-FI or Zigbee are possible). In the event that the POWERLINE COMMUNICATIONS INDICATOR 560 is not backlit within the prescribed time and the COMMUNICATIONS GATEWAY 130 of FIG. 1 detects a wireless signal emitted by the ELECTRIC VEHICLE CHARGING EQUIPMENT 305 of FIG. 3 or the COMMUNICATING ELECTRIC UTILITY METER 310 of FIG. 3, then the WIRELESS COMMUNICATIONS INDICATOR 570 in one implementation(s) becomes backlit, indicating an opportunity to connect with the indicated communication source COMM SOURCE 575. In the event that the electric vehicle owner/lessee does not recognize the communication source, or the source is known to be something other than the ELECTRIC VEHICLE CHARGING EQUIPMENT 305 of FIG. 3 or the COMMUNICATING ELECTRIC UTILITY METER 310 of FIG. 3, then the vehicle owner/lessee in one implementation(s) scrolls through other communicating device options by selecting the feature ADVANCE 580.

In the event that the ELECTRIC VEHICLE CHARGING EQUIPMENT 305 of FIG. 3 is an inductive (wireless) charger, then the electric vehicle owner/lessee manually engages in a wireless communication session. For example, in one implementation(s), the WIRELESS COMMUNICATIONS INDICATOR 570 is selected by a finger on a touchscreen GRAPHIC USER INTERFACE 405 of FIG. 4 for a prescribed period of time to initiate a wireless signal scanning process by the COMMUNICATIONS GATEWAY 130 of FIG. 1. Once the WIRELESS COMMUNICATIONS INDICATOR 570 is continuously backlit, for example, the electric vehicle owner/lessee could proceed with selecting the appropriate COMM SOURCE 575.

The vehicle owner/lessee will then utilize the QWERTY KEYBOARD 515 to select a USER ID 510 and PASSWORD 520, at which point the vehicle owner/lessee in one implementation(s) elects to SAVE 545 the selections before proceeding to the NEXT 530 screen or returning to the HOME 525 screen.

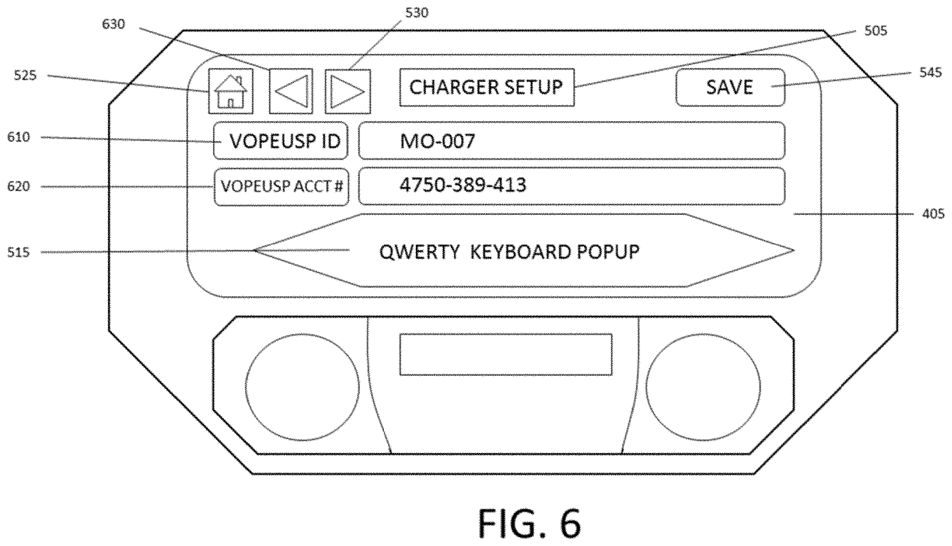

FIG. 6 presents an implementation of a further CHARGER SETUP 505 screen of FIG. 5 wherein the electric vehicle owner/lessee had selected the advance to NEXT 530 screen option of FIG. 5. The electric vehicle owner/lessee would be prompted to input the vehicle owner's/lessee's primary electric utility service provider (VOPEUSP) identification (ID) 610 by accessing the QWERTY KEYBOARD 515 of FIG. 5 and also to input the VOPEUSP ACCOUNT NUMBER 620 assigned by the VOPEUSP to the electric vehicle owner/lessee. The electric vehicle owner/lessee in one implementation(s) elects to SAVE 545 of FIG. 5 the inputs by selecting that feature before opting to proceed to the NEXT 530 of FIG. 5 screen, returning to the PREVIOUS 630 screen or returning to the HOME 525 of FIG. 5 landing screen.

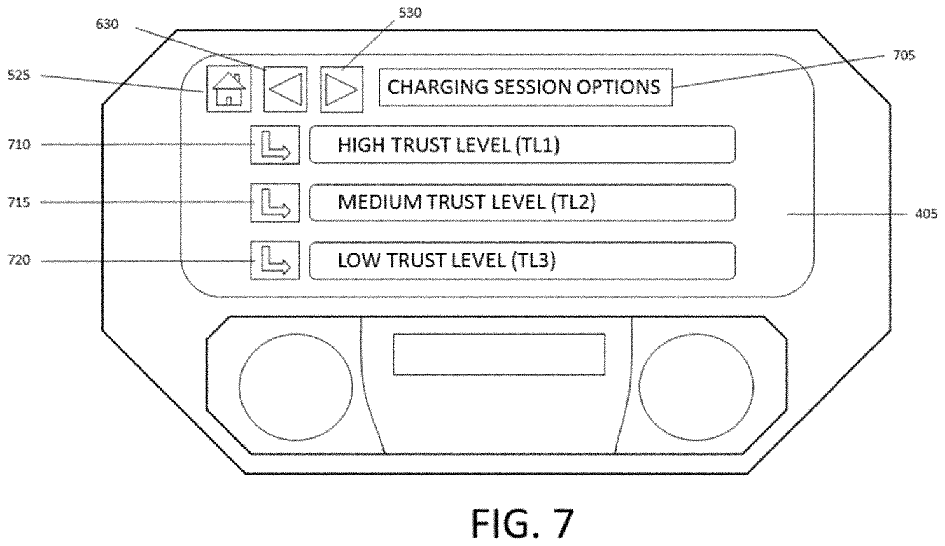

FIG. 7 presents an implementation of a screen providing the electric vehicle owner/lessee an opportunity to determine a level of trust with relation to the specific ELECTRIC VEHICLE CHARGING EQUIPMENT 305 of FIG. 3 connected to the ELECTRIC VEHICLE 100 of FIG. 1 as depicted in the charging session of FIG. 3, wherein the electric vehicle owner/lessee had selected the advance to NEXT 530 screen option of FIG. 6. The CHARGING SESSION OPTIONS 705 available in the implementation include a HIGH TRUST LEVEL (TL1) 710, a MEDIUM TRUST LEVEL (TL2) 715, or a LOW TRUST LEVEL (TL3) 720. Once selected, the charger setup process in one implementation(s) automatically advances to a subsequent screen for further electric vehicle owner/lessee inputs, or the electric vehicle owner/lessee in one implementation(s) makes a selection to proceed to the NEXT 530 screen of FIG. 5, to return to the PREVIOUS 630 screen of FIG. 6 or to return to the HOME 525 landing screen of FIG. 5.

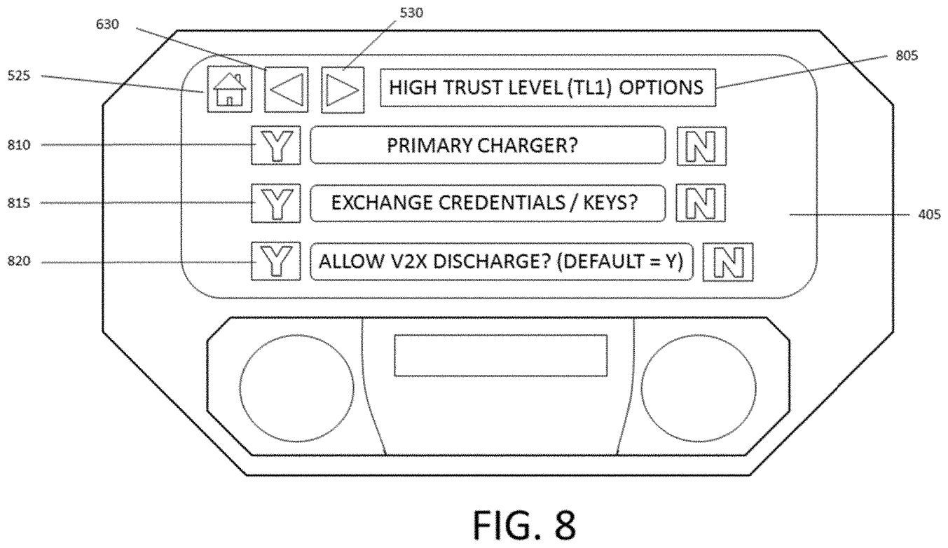

With reference to FIG. 8, an implementation of a screen that prompts the electric vehicle owner/lessee to make certain high trust level elections is provided. In one implementation(s), the vehicle owner/lessee elects to engage with at least one PRIMARY CHARGER 810 to be utilized not only for vehicle miles and waypoints traveled usage fees but also for any system software updates. In the event that the vehicle owner/lessee determines that the ELECTRIC VEHICLE CHARGING EQUIPMENT 305 of FIG. 3 is to be classified as TL1 but is not to be the primary charger, a usage fee settlement process will commence but software or system updates will not be triggered. The vehicle owner/lessee in one implementation(s) elects to EXCHANGE CREDENTIALS/KEYS 815 with the TL1 electric vehicle charging equipment in order to avoid a commissioning process for any future engagement of the specific electric vehicle charging equipment. The electric vehicle owner/lessee in one implementation(s) further affirmatively selects to allow the electric vehicle to discharge electricity to the host facility (e.g., home or business) or to the electric utility grid by selecting Y—ALLOW V2X DISCHARGE 820 or opts out of any such discharge by selecting N at this decision point. In this implementation, the decisions with respect to the specific TL1 electric vehicle charging equipment are automatically saved. The electric vehicle charging equipment in one implementation(s) is re-commissioned in order to change any of the previous settings. In one implementation(s), it is at this point that a TL1 electric vehicle charging session commences and vehicle miles and waypoints traveled usage fee reporting process involving the transmittal of the FILE 150 of FIG. 1 proceeds.

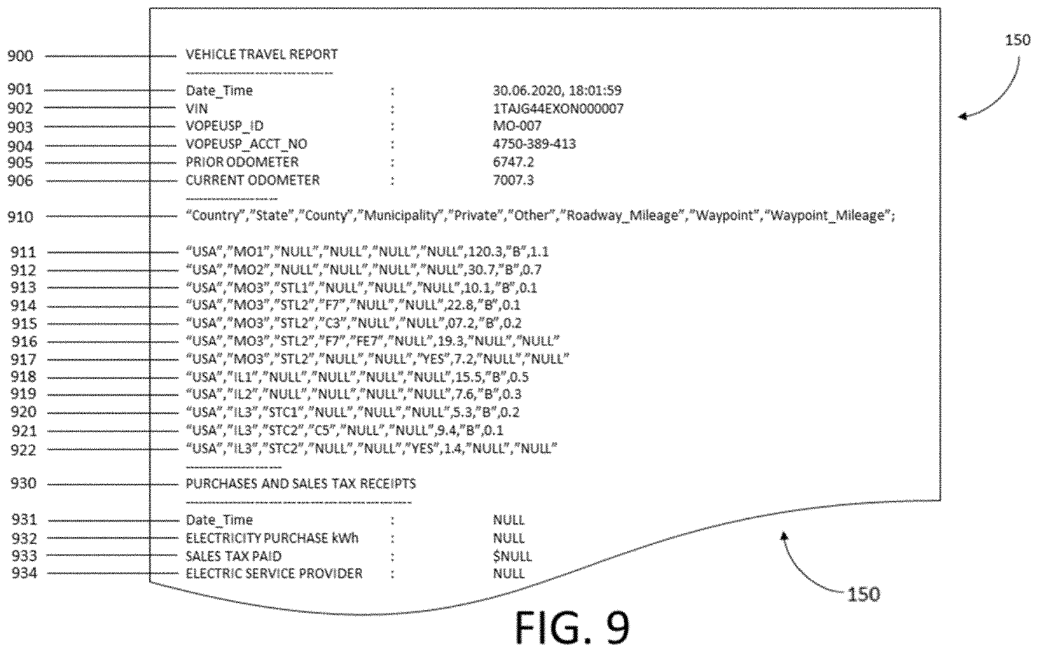

FIG. 9 presents an implementation of a FILE 150 of FIG. 1 that in one implementation(s) is generated by an ELECTRIC VEHICLE 100 of FIG. 1 DATALOGGER 120 of FIG. 1 adjunct REPORT WRITER 125 at the inception of a TL1 electric vehicle charging session. The FILE 150 of FIG. 1 in this implementation contains a HEADER (VEHICLE TRAVEL REPORT 900) and then proceeds to incorporate information polled from an ELECTRONIC CONTROL UNIT 115 of FIG. 1, including the date and time of the file creation (Date_Time 901), the vehicle identification number (VIN 902), the vehicle owner's/lessee's primary electric utility service provider identification (VOPEUSP_ID 903), the account number assigned to the electric vehicle owner/lessee by the primary electric utility service provider (VOPEUSP_ACCT_NO 904), the odometer reading at the instance of the most recent TL1 charging session (PRIOR ODOMETER 905) and the odometer reading at the time of the present TL1 charging session (CURRENT ODOMETER 906).

The implementation continues with a string that identifies the structure of the mileage data to be transmitted, STRING 910, which will include identification of the road class traveled by country, state, county, municipality, private roadways, other (including off-road, parking lots, parking garages, ferries, etc.) and the respective mileage of each, and the waypoints (bridges, dams, tunnels, and other special purpose areas that can be charged a premium for usage) and the respective mileage traversed over or through such waypoints. DATA LINE 911, in this implementation, indicates the road class of a Federal Interstate (MO1) within the state of Missouri driven for 120.3 miles with associated bridges (B) totaling 1.1 miles have been traveled since the most recent TL1 charging session. DATA LINE 912 indicates the road class of a State Highway (MO2) within the state of Missouri driven for 30.7 miles with associated bridges (B) totaling 0.7 miles have been traveled since the most recent TL1 charging session. DATA LINE 913 indicates the road class of a paved County Highway in St. Louis County, M0 (STL1) driven for 10.1 miles with associated bridges (B) totaling 0.1 miles have been traveled since the most recent TL1 charging session. DATA LINE 914 indicates the road class of a paved roadway in the city of Ferguson, Mo. (F7) driven for 22.8 miles with associated bridges (B) totaling 0.1 miles have been traveled since the most recent TL1 charging session. DATA LINE 915 indicates the road class of a paved roadway in the city of Clayton, Mo. (C3) driven for 7.2 miles with associated bridges (B) totaling 0.2 miles have been traveled since the most recent TL1 charging session. DATA LINE 916 indicates the road class of a paved roadway in the private subdivision of Ferguson Estates Drive (FE7) driven for 19.3 miles with associated bridges (B) totaling 0.0 miles have been traveled since the most recent TL1 charging session. DATA LINE 917 indicates the road class of “other” (off-road, parking lots, etc.) in St. Louis County, Mo. for 7.2 miles with associated bridges (B) totaling 0.0 miles have been traveled since the most recent TL1 charging session. DATA LINE 918, in this implementation, indicates the road class of a Federal Interstate (IL1) within the state of Illinois driven for 15.5 miles with associated bridges (B) totaling 0.5 miles have been traveled since the most recent TL1 charging session. DATA LINE 919 indicates the road class of a State Highway (IL2) within the state of Illinois driven for 7.6 miles with associated bridges (B) totaling 0.3 miles have been traveled since the most recent TL1 charging session. DATA LINE 920 indicates the road class of a paved County Highway in St. Clair County, Ill. (STC1) driven for 5.3 miles with associated bridges (B) totaling 0.2 miles have been traveled since the most recent TL1 charging session. DATA LINE 921 indicates the road class of a paved roadway in the city of Cahokia, Ill. (F7) driven for 9.4 miles with associated bridges (B) totaling 0.1 miles have been traveled since the most recent TL1 charging session. DATA LINE 922 indicates the road class of “other” (off-road, parking lots, etc.) in St. Clair County, Ill. for 1.4 miles with associated bridges (B) totaling 0.0 miles have been traveled since the most recent TL1 charging session.

FIG. 9 continues an implementation with a SUB-HEADER 930 for a section which contains receipts for electricity purchases and sales tax paid by the electric vehicle owner/lessee for TL3 electric vehicle charging sessions engaged in since the most recent TL1 charging session was completed. In this implementation, there have been no TL3 charging sessions engaged, as each of the DATA LINES 931 (Date-Time), 932 (ELECTRICITY PURCHASE kWh), 933 (SALES TAX PAID) and 934 (ELECTRIC SERVICE PROVIDER) have returned a value of Null (or zero).

The aforementioned information describe in FIG. 9 would be included in the FILE 150 of FIG. 1 to be transmitted to the UTILITY HEAD-END 330 of FIG. 3 upon the consummation of a TL1 charging session.

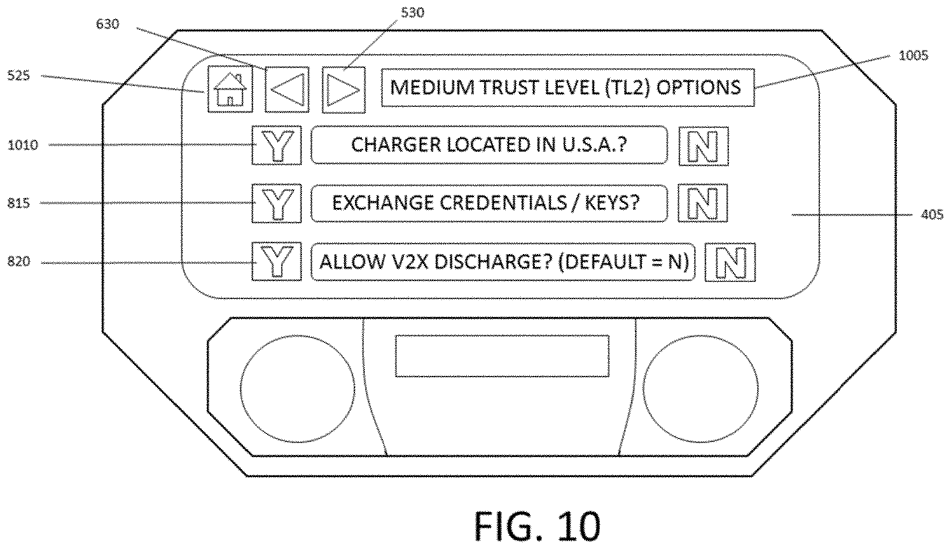

With reference to FIG. 10, provided is an implementation resulting from a decision made by the electric vehicle owner/lessee that the specific electric vehicle charging equipment is not suitable for inclusion in the subset of TL1 electric vehicle charging equipment. The example screen of FIG. 10 provides MEDIUM TRUST LEVEL (TL2) OPTIONS 1005 that prompts the electric vehicle owner/lessee to make certain medium trust level elections. The system of this invention includes a nationwide adoption of a common settlement platform across jurisdictions within the United States of America. Settlements of charging session economics with utilities or government authorities outside of the United States of America are also expected. However, international settlements in one implementation(s) utilize different types or levels of fees, and so it is expected to be of assistance to identify the location of a medium level charger at the time of the commissioning process and, therefore, the vehicle owner/lessee will be prompted to determine whether the location of the electric vehicle charging equipment is within the United States of America, (i.e., CHARGER LOCATED IN THE U.S.A.? 1010). The vehicle owner/lessee in one implementation(s), as in the election of FIG. 8 EXCHANGE CREDENTIALS/KEYS 815, provides a lasting link with the TL2 electric vehicle charging equipment in order to avoid a commissioning process for any future engagement of the specific electric vehicle charging equipment. Similarly, the electric vehicle owner/lessee in one implementation(s) further affirmatively elects to allow the electric vehicle to discharge electricity to the host facility (e.g., home or business) or to the electric utility grid by selecting Y—ALLOW V2X DISCHARGE 820 consistent with FIG. 8 or opts out of any such discharge by selecting N at this decision point. In one implementation, the decisions with respect to the specific TL2 electric vehicle charging equipment are automatically saved. The TL2 electric vehicle charging equipment in one implementation(s) is re-commissioned in order to change any of the previous settings. Many of the features of this GRAPHIC USER INTERFACE 405 of FIG. 4 screen are consistent with other screens, including the option to select to proceed to the NEXT 530 screen of FIG. 5, to return to the PREVIOUS 630 screen of FIG. 6 or to return to the HOME 525 landing screen of FIG. 5.

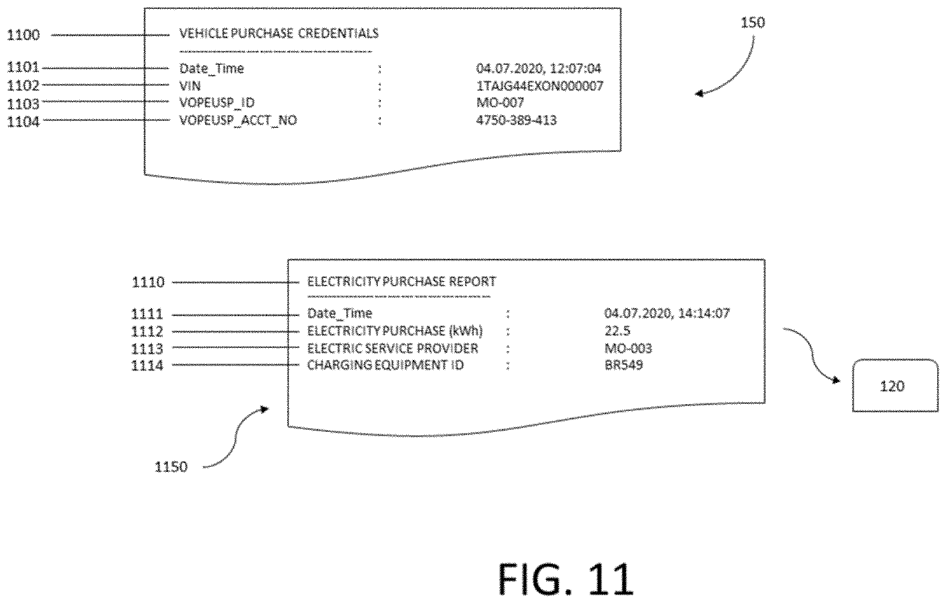

FIG. 11 presents an implementation of a FILE 150 of FIG. 1 that in one implementation(s) is generated by an ELECTRIC VEHICLE 100 of FIG. 1 DATALOGGER 120 of FIG. 1 adjunct REPORT WRITER 125 at the inception of a TL2 electric vehicle charging session prior to the transfer of electricity. The FILE 150 of FIG. 1 in one implementation(s) contains a HEADER (VEHICLE PURCHASE CREDENTIALS 1100) and then proceeds to incorporate information polled from an ELECTRONIC CONTROL UNIT 115 of FIG. 1, including the date and time of the file creation (Date_Time 1101), the vehicle identification number (VIN 1102), the vehicle owner's/lessee's primary electric utility service provider identification (VOPEUSP_ID 1103) and the account number assigned to the electric vehicle owner/lessee by the primary electric utility service provider (VOPEUSP_ACCT_NO 1104). With this information the COMMUNICATING ELECTRIC UTILITY METER 310 of FIG. 3 associated with the ELECTRIC VEHICLE CHARGING EQUIPMENT 305 of FIG. 3 in one implementation(s) transmits the vehicle owner's/lessee's utility billing information, along with the metered electricity purchased by the electric vehicle owner/lessee, to the ELECTRIC UTILITY HEAD-END 330 of FIG. 3.

At the conclusion of the TL2 charging session, the COMMUNICATING ELECTRIC UTILITY METER 310 of FIG. 3 associated with the ELECTRIC VEHICLE CHARGING EQUIPMENT 305 of FIG. 3 in one implementation(s) transmits FILE 1150 containing a HEADER (ELECTRICITY PURCHASE REPORT 1110) along with the results of the TL2 charging session, including the date and time of the file creation (Date_Time 1111), the measure of electricity purchased (ELECTRICITY PURCHASE (kWh) 1112), the electric vehicle charging equipment's primary electric utility service provider identification (ELECTRIC SERVICE PROVIDER 1113) and the electric vehicle charging equipment identification number (CHARGING EQUIPMENT ID 1114). In one implementation(s), at the conclusion of the charging session, FILE 1150 is transmitted to the electric vehicle for storage in the DATALOGGER 120 of FIG. 1 pending a TL1 charging session, at which time the information relating to TL2 charging sessions is included in the FILE 150 of FIG. 9, immediately following which the DATALOGGER INTERNAL MEMORY 222 of FIG. 2 is cleared.

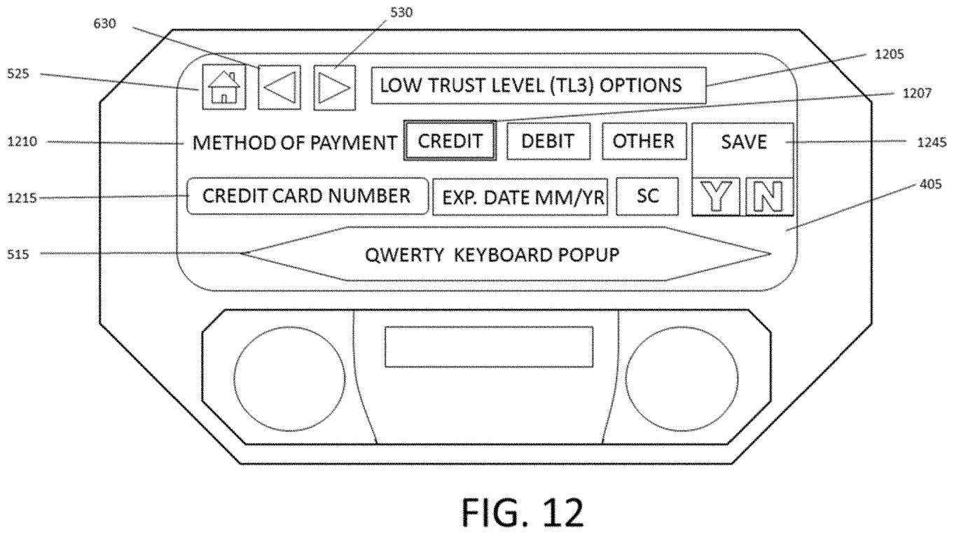

With reference to FIG. 12, provided is an implementation resulting from a decision made by the electric vehicle owner/lessee that the specific electric vehicle charging equipment is not suitable for inclusion in either the subset of TL1 or TL2 electric vehicle charging equipment. The example screen of FIG. 12 provides LOW TRUST LEVEL (TL3) OPTIONS 1205 that prompts the electric vehicle owner/lessee to make certain low trust level elections. The GRAPHIC USER INTERFACE 405 of FIG. 4 includes a variety of options for the METHOD OF PAYMENT 1210 (e.g., credit, debit, other). In the example of this screenshot, the electric vehicle owner/lessee has opted to purchase electricity with CREDIT 1207. Upon selection of CREDIT 1207, the QWERTY KEYBOARD POPUP 515 of FIG. 5 appears, allowing the electric vehicle owner/lessee to input a CREDIT CARD NUMBER 1215 and associated EXP. DATE MM/YR (i.e., the credit card expiration date) and SC (security code). The electric vehicle owner/lessee in one implementation(s) elects to SAVE 1245 the CREDIT information for use in future TL3 charging sessions, or alternatively in one implementation(s) declines to store such information within the electric vehicle. Once these inputs and decisions are made, the electric vehicle owner/lessee in one implementation(s) exits the electric vehicle TL3 charging setup screen by engaging the HOME 525 of FIG. 5 option, in one implementation(s) visits the PREVIOUS 630 screen of FIG. 6, or in one implementation(s) advances to the NEXT 530 screen of FIG. 5. Note that in one implementation the NEXT screen is not defined but, rather, is indicative of the flexibility afforded to vehicle manufacturers to define an implementation(s) of other useful information.

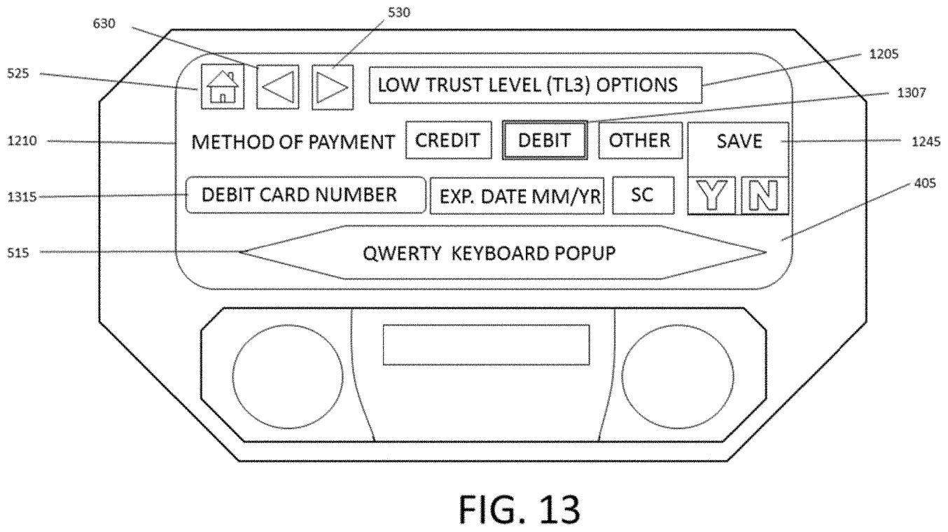

FIG. 13 provides a further implementation of a screen resulting from a decision made by the electric vehicle owner/lessee that the specific electric vehicle charging equipment is not suitable for inclusion in either the subset of TL1 or TL2 electric vehicle charging equipment. The example screen of FIG. 13 also provides LOW TRUST LEVEL (TL3) OPTIONS 1205 of FIG. 12 that prompts the electric vehicle owner/lessee to make certain low trust level elections. The GRAPHIC USER INTERFACE 405 of FIG. 4 continues to provide a variety of options for the METHOD OF PAYMENT 1210 of FIG. 12 (e.g., credit, debit, other). In the example of this screenshot, the electric vehicle owner/lessee has opted to purchase electricity using a direct DEBIT 1307. Upon selection of DEBIT 1307, the QWERTY KEYBOARD POPUP 515 of FIG. 5 appears, allowing the electric vehicle owner/lessee to input a DEBIT CARD NUMBER 1315 and associated EXP. DATE MM/YR (i.e., the credit card expiration date) and SC (security code). The electric vehicle owner/lessee in one implementation(s) elects to SAVE 1245 of FIG. 12 the DEBIT information for use in future TL3 charging sessions, or alternatively in one implementation(s) declines to store such information within the electric vehicle. Once these inputs and decisions are made, the electric vehicle owner/lessee in one implementation(s) exits the electric vehicle TL3 charging setup screen by engaging the HOME 525 of FIG. 5 option, in one implementation(s) visits the PREVIOUS 630 screen of FIG. 6, or in one implementation(s) advances to the NEXT 530 screen of FIG. 5. Note that in this implementation the NEXT screen is not defined but, rather, is indicative of the flexibility afforded to vehicle manufacturers to define implementation(s) of other useful information.

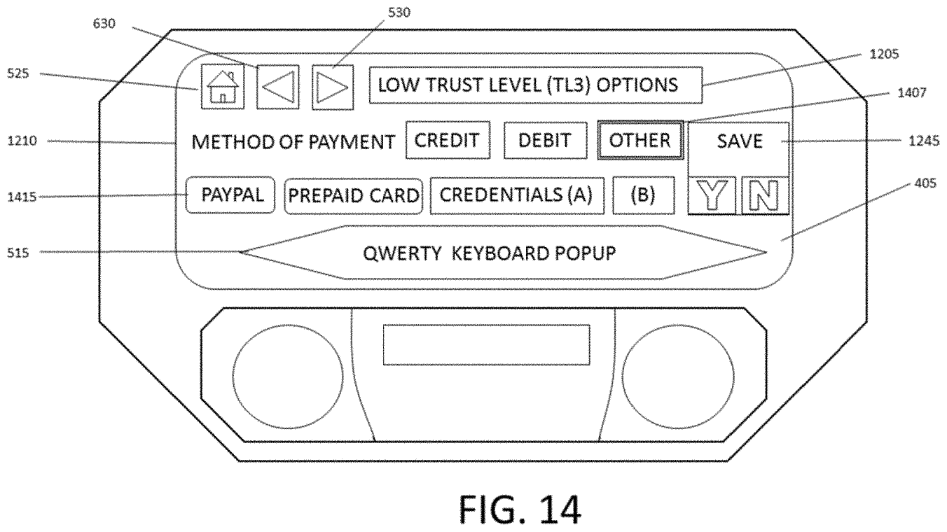

FIG. 14 provides yet another implementation of a screen resulting from a decision made by the electric vehicle owner/lessee that the specific electric vehicle charging equipment is not suitable for inclusion in either the subset of TL1 or TL2 electric vehicle charging equipment. The example screen of FIG. 14 also provides LOW TRUST LEVEL (TL3) OPTIONS 1205 of FIG. 12 that prompts the electric vehicle owner/lessee to make certain low trust level elections. The GRAPHIC USER INTERFACE 405 of FIG. 4 continues to provide a variety of options for the METHOD OF PAYMENT 1210 of FIG. 12 (e.g., credit, debit, other). In the example of this screenshot, the electric vehicle owner/lessee has opted to purchase electricity using an OTHER 1407 payment method. This example screen notes two alternatives (PAYPAL and PREPAID CARD 1415) that appear upon the selection of OTHER 1407 (but other vehicle manufacturer defined alternatives can be included). Upon selection of the payment method (PAYPAL or PREPAID CARD 1415), the QWERTY KEYBOARD POPUP 515 of FIG. 5 appears, allowing the electric vehicle owner/lessee to input a CREDENTIALS (A) 1415 and (B) 1415. The electric vehicle owner/lessee in one implementation(s) elects to SAVE 1245 of FIG. 12 the OTHER payment information for use in future TL3 charging sessions, or alternatively in one implementation(s) declines to store such information within the electric vehicle. Once these inputs and decisions are made, the electric vehicle owner/lessee in one implementation(s) exits the electric vehicle TL3 charging setup screen by engaging the HOME 525 of FIG. 5 option, in one implementation(s) visits the PREVIOUS 630 screen of FIG. 6, or in one implementation(s) advances to the NEXT 530 screen of FIG. 5. Note that in one implementation the NEXT screen is not defined but, rather, is indicative of the flexibility afforded to vehicle manufacturers to define implementation(s) of other useful information.

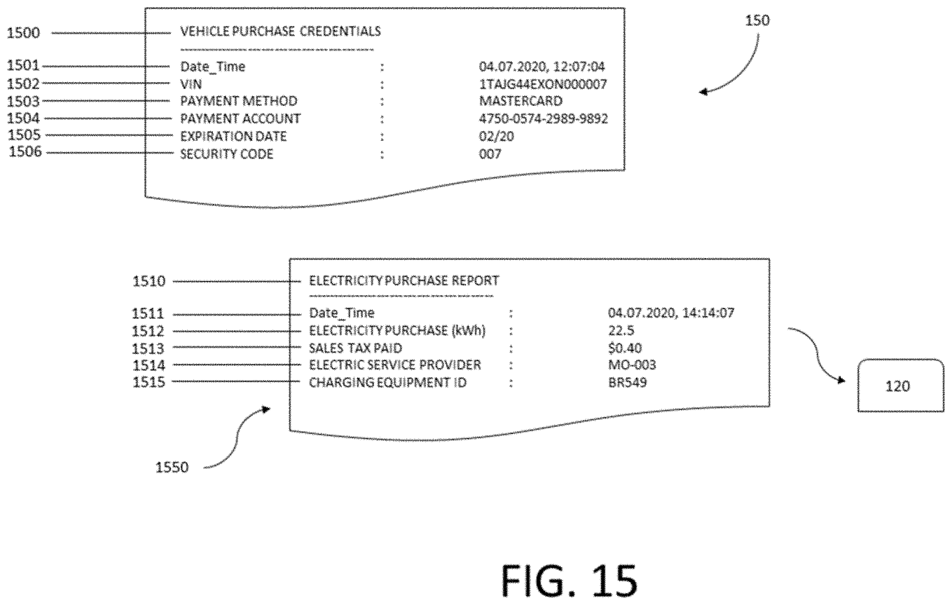

FIG. 15 presents an implementation of a FILE 150 of FIG. 1 that in one implementation(s) is generated by an ELECTRIC VEHICLE 100 of FIG. 1 DATALOGGER 120 of FIG. 1 adjunct REPORT WRITER 125 at the inception of a TL3 electric vehicle charging session prior to the transfer of electricity. The FILE 150 of FIG. 1 in one implementation(s) contains a HEADER (VEHICLE PURCHASE CREDENTIALS 1500) and then proceeds to incorporate information polled from an ELECTRONIC CONTROL UNIT 115 of FIG. 1, including the date and time of the file creation (Date_Time 1501), the vehicle identification number (VIN 1502), the vehicle owner's/lessee's selected method of payment (credit, debit or other) (PAYMENT METHOD 1503), the method of payment account number (PAYMENT ACCOUNT 1504), the expiration date, if applicable, of the method of payment (EXPIRATION DATE 1505) and the security code, if any (SECURITY CODE 1506). With this information the COMMUNICATING ELECTRIC UTILITY METER 310 of FIG. 3 associated with the ELECTRIC VEHICLE CHARGING EQUIPMENT 305 of FIG. 3 in one implementation(s) transmits the vehicle owner's/lessee's payment information, along with the metered electricity purchased by the electric vehicle owner/lessee, to the ELECTRIC UTILITY HEAD-END 330 of FIG. 3 so that a monetary charge and sales tax amount in one implementation(s) is computed.

At the conclusion of the TL3 charging session, the COMMUNICATING ELECTRIC UTILITY METER 310 of FIG. 3 associated with the ELECTRIC VEHICLE CHARGING EQUIPMENT 305 of FIG. 3 in one implementation(s) transmits FILE 1550 containing a HEADER (ELECTRICITY PURCHASE REPORT 1510) along with the results of the TL3 charging session, including the date and time of the file creation (Date_Time 1511), the measure of electricity purchased (ELECTRICITY PURCHASE (kWh) 1512), the associated sales tax charge (SALES TAX PAID 1513), the electric vehicle charging equipment's primary electric utility service provider identification (ELECTRIC SERVICE PROVIDER 1514) and the electric vehicle charging equipment identification number (CHARGING EQUIPMENT ID 1515). In this implementation, at the conclusion of the charging session, FILE 1550 is transmitted to the electric vehicle for storage in the DATALOGGER 120 of FIG. 1 pending a TL1 charging session, at which time the information relating to TL3 charging sessions in one implementation(s) is included in the FILE 150 of FIG. 9, immediately following which the DATALOGGER INTERNAL MEMORY 222 of FIG. 2 is cleared.

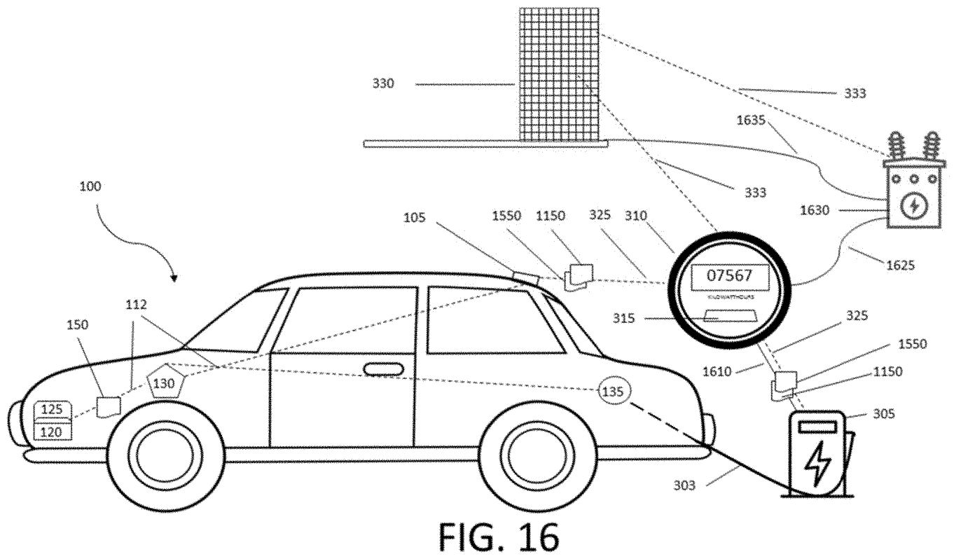

The communications architecture presented within FIG. 16 is an implementation of the backbone for transmitting the vehicle miles and waypoints traveled information from the ELECTRIC VEHICLE 100 of FIG. 1 to the ELECTRIC UTILITY HEAD-END 330 of FIG. 3 for processing. The communication architecture can take a variety of forms: wireline/powerline from the ELECTRIC VEHICLE 100 of FIG. 1 to the ELECTRIC VEHICLE CHARGING EQUIPMENT 305 of FIG. 3 to the COMMUNICATING ELECTRIC UTILITY METER 310 of FIG. 3 to ELECTRIC UTILITY SUBSTATION 1630 and beyond (by fiber, plain old telephone system (POTS), broadband over powerline, etc.) to the ELECTRIC UTILITY HEAD-END 330 of FIG. 3 (shown as CHARGING CORD 303 of FIG. 3 to WIRING 1610 to POWERLINE 1625 to POWERLINE 1635), wireless from the ELECTRIC VEHICLE 100 of FIG. 1 to the COMMUNICATING ELECTRIC UTILITY METER 310 of FIG. 3 (or through a local area network node to the COMMUNICATING ELECTRIC UTILITY METER 310 of FIG. 3) to the ELECTRIC UTILITY HEAD-END 330 of FIG. 3 (shown as WIRELESS MEANS 325 of FIG. 3), or a combination of the two (e.g., CHARGING CORD 303 of FIG. 3 to WIRING 1610 to POWERLINE 1625 to substation, WIRELESS MEANS 325 of FIG. 3 from ELECTRIC UTILITY SUBSTATION 1630 to ELECTRIC UTILITY HEAD-END 330 of FIG. 3).

The communication path from the COMMUNICATING ELECTRIC UTILITY METER 310 of FIG. 3 to the ELECTRIC UTILITY HEAD-END 330 of FIG. 3 in one implementation(s) is predetermined by the utility as part of its SMART GRID COMMUNICATIONS NETWORK 333 of FIG. 3 (or any combination of POWERLINE 1625 and POWERLINE 1635 or SMART GRID COMMUNICATIONS NETWORK 333 of FIG. 3). So long as there is sufficient bandwidth to transmit FILES 150 of FIGS. 1, 150 and 1150 of FIGS. 11 and 150 and 1550 of FIG. 15 over the network, the composition of the architecture in one implementation(s) is irrelevant to the functioning of the usage fee system. Assuming the utility's smart grid network is in place, it will be important to establish a functioning linkage between the COMMUNICATING ELECTRIC UTILITY METER 310 of FIG. 3 and the ELECTRIC VEHICLE 100 of FIG. 1.

As described in FIG. 5, a driver of the ELECTRIC VEHICLE 100 of FIG. 1 to COMMUNICATING ELECTRIC UTILITY METER 310 of FIG. 3 communication path will involve the selection of ELECTRIC VEHICLE CHARGING EQUIPMENT 305 of FIG. 3, whether it is conductive (wireline) charging equipment or inductive (wireless) charging equipment. FIG. 16 provides an implementation of a conductive, or wireline, electric vehicle charging session. In this implementation, the process of connecting the ELECTRIC VEHICLE CHARGING EQUIPMENT 305 of FIG. 3 with the ELECTRIC VEHICLE 100 of FIG. 1 charging port (or ACCESS POINT 135 of FIG. 1) provides a wired communication path between the COMMUNICATING ELECTRIC UTILITY METER 310 of FIG. 3 and the ELECTRIC VEHICLE 100 of FIG. 1 (i.e., WIRING 1610 from the COMMUNICATING ELECTRIC UTILITY METER 310 of FIG. 3 to the ELECTRIC VEHICLE CHARGING EQUIPMENT 305 of FIG. 3 and CHARGING CORD 303 of FIG. 3 from the ELECTRIC VEHICLE CHARGING EQUIPMENT 305 of FIG. 3 to the ELECTRIC VEHICLE 100 of FIG. 1 ACCESS POINT 135 of FIG. 1). The connectivity sensors of the ELECTRIC VEHICLE CHARGING EQUIPMENT 305 of FIG. 3, in one implementation(s), generate a request of the dedicated COMMUNICATING ELECTRIC UTILITY METER 310 of FIG. 3 to engage in a communications session. Alternatively, if the COMMUNICATING ELECTRIC UTILITY METER 310 of FIG. 3 is manufactured to communicate wirelessly (by BLUETOOTH, for example), then the COMMUNICATING ELECTRIC UTILITY METER 310 of FIG. 3 in one implementation(s) transmits an invitation for the ELECTRIC VEHICLE 100 of FIG. 1 to couple for purposes of the charging session.

The ELECTRIC VEHICLE 100 of FIG. 1 COMMUNICATIONS GATEWAY 130 of FIG. 1 in one implementation(s) anticipates a CANBUS or Ethernet (or MOST or other wired vehicle communication protocol) based communications request from the ELECTRIC VEHICLE CHARGING EQUIPMENT 305 of FIG. 3 once the ACCESS POINT 135 of FIG. 1 charging receptacle has been engaged by the ELECTRIC VEHICLE CHARGING EQUIPMENT 305 of FIG. 3. If no such wireline communication request has been processed by the ELECTRIC VEHICLE 100 of FIG. 1 COMMUNICATIONS GATEWAY 130 of FIG. 1 within a prescribed period of time after confirmation of a charging receptacle connection, then the COMMUNICATIONS GATEWAY 130 of FIG. 1 in one implementation(s) is scanning for wireless transmission requests from the COMMUNICATING ELECTRIC UTILITY METER 310 of FIG. 3. As described in FIG. 5, the vehicle owner/lessee in one implementation(s) takes certain actions to initiate communications with inductive charging equipment.

Proceeding with FIG. 16, in one implementation(s) after connections have been made between the ELECTRIC VEHICLE 100 of FIG. 1 COMMUNICATIONS GATEWAY 130 of FIG. 1 and the COMMUNICATING ELECTRIC UTILITY METER 310 of FIG. 3, the presentation focuses further on the FILE 150 of FIG. 1 generation and transmission process (described in FIG. 3 with respect to a TL1 charging session) associated with each of TL1, TL2 and TL3 charging sessions, and the FILE 1150 of FIG. 11 and FILE 1550 receipts returned to the ELECTRIC VEHICLE 100 of FIG. 1 DATALOGGER 120 of FIG. 1 at the consummation of a TL2 or TL3, respectively, charging session.

A FILE 150 of FIG. 1 will be generated at the inception of a charging session. To reiterate, upon a TL1 charging session the ELECTRIC VEHICLE 100 of FIG. 1 DATALOGGER 120 of FIG. 1 adjunct REPORT WRITER 125 of FIG. 1 will generate a FILE 150 as referenced by FIG. 9. Upon a TL2 charging session the ELECTRIC VEHICLE 100 of FIG. 1 DATALOGGER 120 of FIG. 1 adjunct REPORT WRITER 125 of FIG. 1 will generate a FILE 150 as referenced by FIG. 11. Upon a TL3 charging session the ELECTRIC VEHICLE 100 of FIG. 1 DATALOGGER 120 of FIG. 1 adjunct REPORT WRITER 125 of FIG. 1 will generate a FILE 150 as referenced by FIG. 15. In this implementation, the FILE 150 of FIG. 1 is transmitted over the INTERNAL ELECTRIC VEHICLE COMMUNICATIONS NETWORK 112 of FIG. 1 to the COMMUNICATIONS GATEWAY 130 of FIG. 1 and on to an ACCESS POINT 135 of FIG. 1 or to an authorized transmission point, such as the ANTENNA 105 of FIG. 1.

A COMMUNICATING ELECTRIC UTILITY METER 310 of FIG. 3 setup to receive FILE 150 of FIG. 1 by conducted wire would engage with the ELECTRIC VEHICLE CHARGING EQUIPMENT 305 of FIG. 3 by WIRING 1610 which will utilize the CHARGING CORD 303 of FIG. 3 engaged with ACCESS POINT 135 of FIG. 1. Alternatively, a COMMUNICATING ELECTRIC UTILITY METER 310 of FIG. 3 setup to receive FILE 150 of FIG. 1 by wireless transceiver would ping the ELECTRIC VEHICLE of FIG. 1 by WIRELESS MEANS 325 of FIG. 3 to establish a communications link. The wireless transmission setup would commence after the ELECTRIC VEHICLE CHARGING EQUIPMENT 305 of FIG. 3 CHARGING CORD 303 of FIG. 3 is engaged with ACCESS POINT 135 of FIG. 1 but before any transfer of electricity takes place. In one implementation(s), the COMMUNICATING ELECTRIC UTILITY METER 310 of FIG. 3 issues an invitation to couple to the ELECTRIC VEHICLE 100 of FIG. 1.

Upon receipt of FILE 150 of FIG. 1 by the COMMUNICATING ELECTRIC UTILITY METER 310 of FIG. 3, the transmission of the FILE 150 of FIG. 1 to the ELECTRIC UTILITY HEAD-END 330 of FIG. 3 would be governed by the architecture of the SMART GRID COMMUNICATIONS NETWORK 333 of FIG. 3. Multiple paths are disclosed in this implementation, including (a) direct WIRELESS MEANS 325 of FIG. 3 from the COMMUNICATING ELECTRIC UTILITY METER 310 of FIG. 3 to the ELECTRIC UTILITY HEAD-END 330 of FIG. 3, (b) POWERLINE 1625 communications from the COMMUNICATING ELECTRIC UTILITY METER 310 of FIG. 3 to an electric utility substation, and from there the implementation depicts either a POWERLINE 1635 communications option or a WIRELESS MEANS 333 of FIG. 3 approach.

Included in FIG. 16 are an implementation of the indications of the transmission of electronic receipt FILE 1150 of FIG. 11 for a TL2 charging session and FILE 1550 of FIG. 15 for a TL3 charging session, each for electricity purchases which in one implementation(s) includes the payment of sales tax, that are transmitted over the communications architecture of FIG. 16. FILE 1150 of FIG. 11 and/or FILE 1550 of FIG. 15 in one implementation(s) is generated at the ELECTRIC UTILITY HEAD-END 330 of FIG. 3 and transmitted through the smart grid communications network to the COMMUNICATING ELECTRIC UTILITY METER 310 of FIG. 3 to the ELECTRIC VEHICLE 100 of FIG. 1 COMMUNICATIONS GATEWAY 130 of FIG. 1 either entirely wireline or partially wirelessly, to be stored in the DATALOGGER 120 of FIG. 1 pending a TL1 charging session. Alternatively, FILE 1150 of FIG. 11 and/or FILE 1550 of FIG. 15 in one implementation(s) is generated at the COMMUNICATING ELECTRIC UTILITY METER 310 of FIG. 3 or the ELECTRIC VEHICLE CHARGING EQUIPMENT 305 of FIG. 3 and transmitted to the ELECTRIC VEHICLE 100 of FIG. 1 without engaging the SMART GRID COMMUNICATIONS NETWORK 333 of FIG. 3.

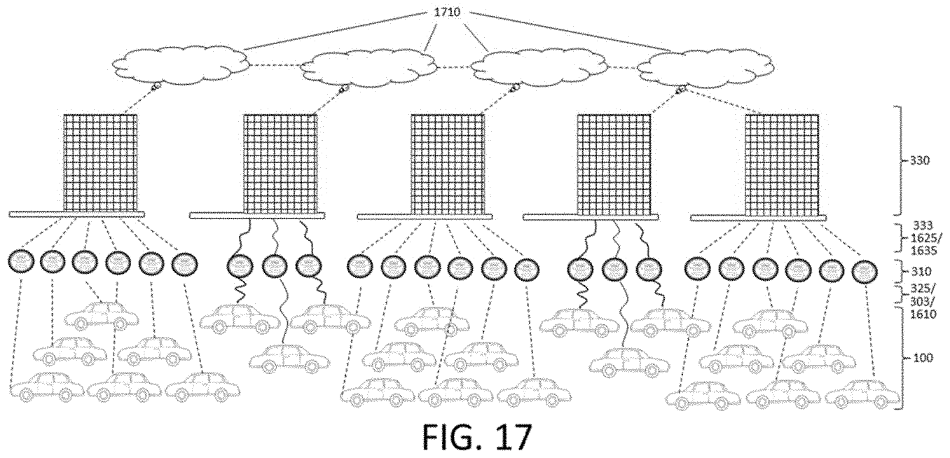

Turning to FIG. 17, an implementation depicted is a plurality of ELECTRIC VEHICLES 100 of FIG. 1 transmitting and or receiving information by any combination or instance of WIRELESS MEANS 325 of FIG. 3, CHARGING CORD 303 of FIG. 3 and/or WIRING 1610 of FIG. 16 communications to a respective COMMUNICATING ELECTRIC UTILITY METER 310 of FIG. 3. One implementation(s) of FIG. 17 further identifies a variety of smart grid communications architectures that are employed for communications from the COMMUNICATING ELECTRIC UTILITY METER 310 of FIG. 3 to the ELECTRIC UTILITY HEAD-END 330 of FIG. 3, including WIRELESS MEANS 325 of FIG. 3, POWERLINE 1625 of FIG. 16 and POWERLINE 1635 of FIG. 16, or a combination thereof. Cloud computing services provided by AUTHORIZED THIRD PARTY PROCESSOR, SETTLEMENT AND STORAGE SERVICE PROVIDERS 1710 are disclosed, wherein the individual FILE 150 of FIG. 1, or FILE 150 of FIG. 11 and associated FILE 1150 of FIG. 11, and/or FILE 150 of FIG. 15 and associated FILE 1550 of FIG. 15 are transmitted via a secured internet connection by an ELECTRIC UTILITY HEAD-END 330 of FIG. 3 to an AUTHORIZED THIRD PARTY PROCESSOR, SETTLEMENT AND STORAGE SERVICE PROVIDERS 1710 for decryption, parsing, analyses, calculation of fees applicable to roadway class and waypoint usage attributable to predetermined geographic jurisdictions, determination of appropriate credits (if any), preparation of encrypted usage fee and credit billing communication packets to be transmitted to other AUTHORIZED THIRD PARTY PROCESSOR, SETTLEMENT AND STORAGE SERVICE PROVIDERS 1710 and to the client ELECTRIC UTILITY HEAD-END 330 of FIG. 3, receipt of encrypted usage fee and credit billing communication packets from other AUTHORIZED THIRD PARTY PROCESSOR, SETTLEMENT AND STORAGE SERVICE PROVIDERS 1710, preparation of encrypted settlement statements for transmittal to certified usage fee collection agencies representing predetermined geographic jurisdictions, facilitation of usage fee collection and transference of said usage fees to certified collection agencies as requested by the ELECTRIC UTILITY HEAD-END 330 of FIG. 3 client and secure storage of data, including analyses and calculations applicable to roadway class and waypoint usage attributable to predetermined geographic jurisdictions on the basis of the vehicle identification number included in a received FILE 150 of FIG. 1 and any associated FILE 1150 of FIG. 1 or any associated FILE 1550 of FIG. 15. The AUTHORIZED THIRD-PARTY PROCESSOR, SETTLEMENT AND STORAGE SERVICE PROVIDERS 1710 in one implementation(s) is also engaged to prepare analyses, perform calculations, create reports or conduct other tasks requested by the client ELECTRIC UTILITY HEAD-END 330 of FIG. 3, including preparation of or support in preparing FILES 1150 of FIG. 11 and/or FILES 1550 of FIG. 15.

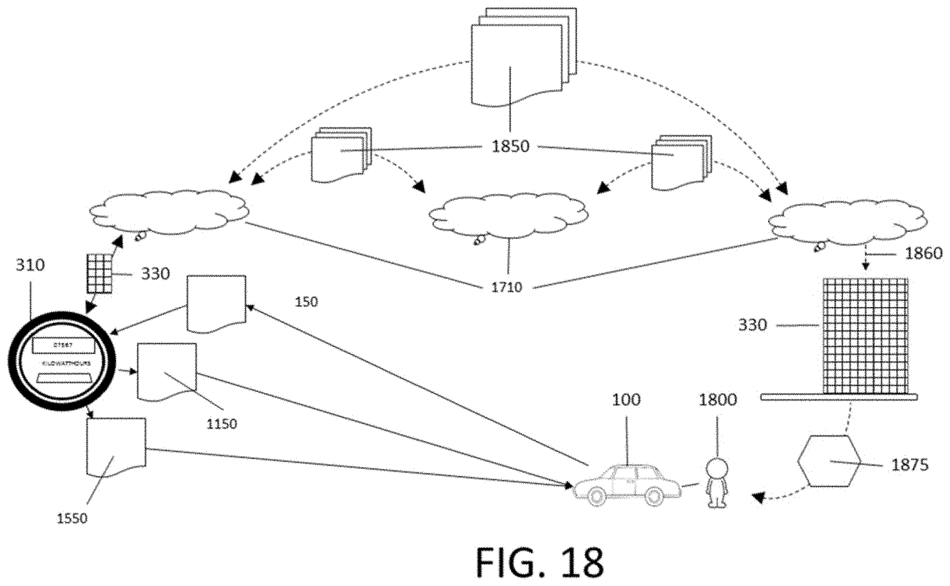

With reference to FIG. 18, an implementation of the data transmittal process and bill generation process is depicted without reference to the communication path. In one implementation(s), the ELECTRIC VEHICLE 100 of FIG. 1 engages in TL2 or TL3 charging sessions during the current billing cycle, upon the conclusion of which a FILE 1150 of FIG. 11 and/or a FILE 1550 of FIG. 15 would be produced (by any of the ELECTRIC VEHICLE CHARGING EQUIPMENT 305 of FIG. 3, the COMMUNICATING ELECTRIC UTILITY METER 310 of FIG. 3, the ELECTRIC UTILITY HEAD-END 330 of FIG. 3, or the AUTHORIZED THIRD PARTY PROCESSOR, SETTLEMENT AND STORAGE SERVICE PROVIDER 1710 of FIG. 17) and transmitted to the ELECTRIC VEHICLE 100 of FIG. 1 (for temporary storage in the memory of the DATALOGGER 120 of FIG. 1 until a subsequent TL1 charging session) and such files would also be transmitted to the ELECTRIC UTILITY HEAD-END 330 of FIG. 3 and then on to an AUTHORIZED THIRD PARTY PROCESSOR, SETTLEMENT AND STORAGE SERVICE PROVIDER 1710.

Upon the described TL1 charging session, the ELECTRIC VEHICLE of FIG. 1 generates FILE 150 of FIG. 1 which is transmitted to the COMMUNICATING ELECTRIC UTILITY METER 310 of FIG. 3 which forwards FILE 150 of FIG. 1 through an ELECTRIC UTILITY HEAD-END 330 of FIG. 3 to an AUTHORIZED THIRD PARTY PROCESSOR, SETTLEMENT AND STORAGE SERVICE PROVIDER 1710 for processing. It is at this point that the ELECTRIC VEHICLE 100 of FIG. 1 in one implementation(s) transmits the TL1 charging session file to a communicating personal computing device controlled by the VEHICLE OWNER/LESSEE 1800 for their review or for their records.

The files transmitted to the AUTHORIZED THIRD PARTY PROCESSOR, SETTLEMENT AND STORAGE SERVICE PROVIDER 1710 of FIG. 17 are processed and analyzed as described in the description of FIG. 17, whereupon BILLING PACKET FILES 1850 are shared with AUTHORIZED THIRD PARTY PROCESSOR, SETTLEMENT AND STORAGE SERVICE PROVIDER 1710 of FIG. 17 with respect to usage fees attributable to utility service territories outside of their client base. For example, authorized third party service provider (A) in one implementation(s) identifies usage fees owed by a vehicle owner for roadway usage in a territory served by authorized third party service provider (B). During the billing cycle the reverse can also be true, wherein authorized third-party service provider (B) in one implementation(s) identifies usage fees owed by a vehicle owner for roadway usage in a territory served by authorized third party service provider (A). To add further complexity, during the billing cycle, authorized third party service provider (A) in one implementation(s) identifies usage fees owed by a vehicle owner for roadway usage in a territory served by authorized third party service provider (C), authorized third party service provider (B) in one implementation(s) identifies usage fees owed by a vehicle owner for roadway usage in a territory served by authorized third party service provider (C), authorized third party service provider (C) in one implementation(s) identifies usage fees owed by a vehicle owner for roadway usage in a territory served by authorized third party service provider (A), authorized third party service provider (C) in one implementation(s) identifies usage fees owed by a vehicle owner for roadway usage in a territory served by authorized third party service provider (B), and so on. Rather than require each separate authorized third-party service provider to process payments to each certified usage fee collection agency, a settlement process between the authorized third-party service providers to minimize the monetary transfers to the certified collection agencies (thereby reducing the overhead burden on the collection agencies).

After settlement of the interjurisdictional usage fee obligations (including the netting of credits), the AUTHORIZED THIRD PARTY PROCESSOR, SETTLEMENT AND STORAGE SERVICE PROVIDER 1710 of FIG. 17 in one implementation(s) provides a set of BILLING PACKET FILES 1850 by SECURE INTERNET TRANSFER 1860 to the ELECTRIC UTILITY HEAD-END 330 of FIG. 3 which will include the pertinent billing and credit information in the PERIODIC ELECTRIC UTILITY BILLING 1875 that is provided to the VEHICLE OWNER/LESSEE 1800. The billing process in one implementation(s) culminates with the VEHICLE OWNER/LESSEE 1800 comparing the details in the FILE 150 of FIG. 1 provided by the ELECTRIC VEHICLE 100 of FIG. 1 sent to his or her communicating personal computing device to the detailed information included in his or her UTILITY BILLING 1875.

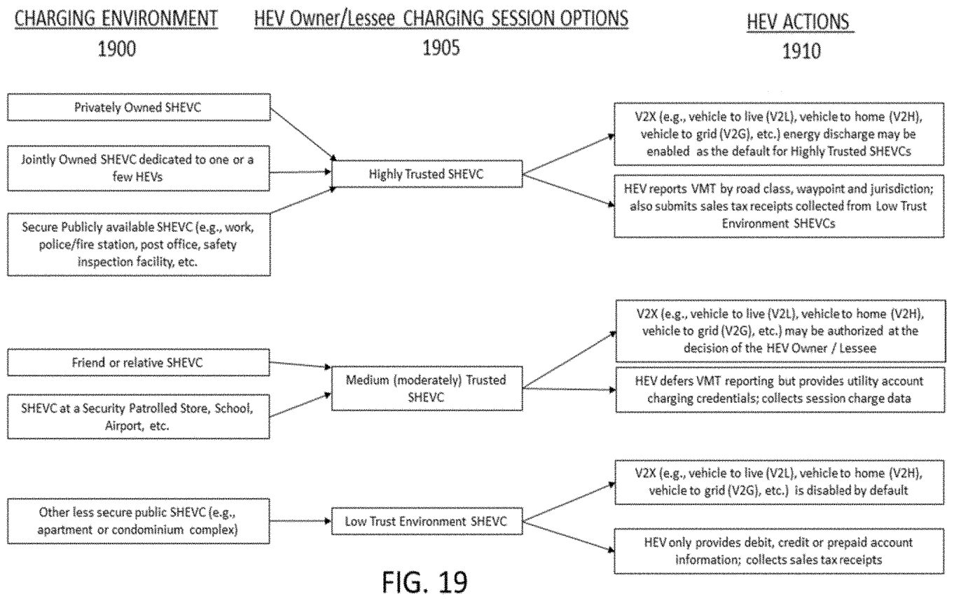

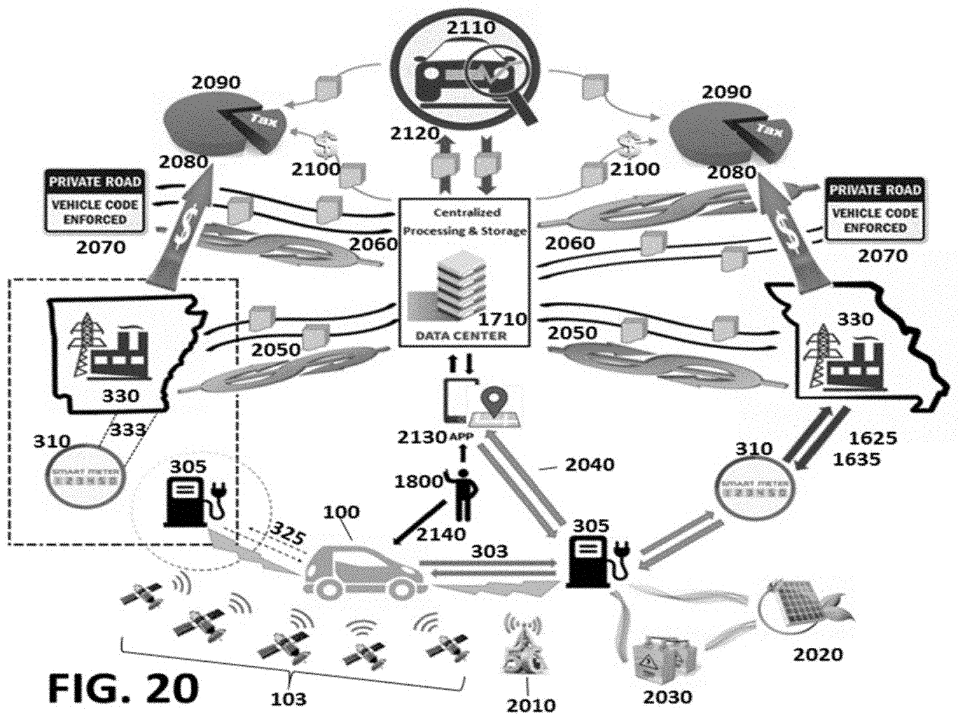

With reference to FIG. 19, in one implementation, an HEV owner selects an applicable TRUST LEVEL OPTION of FIG. 7 (High, Medium or Low) 1905 relative to the CHARGING ENVIRONMENT 1900 of the applicable SHEVC so that appropriate HEV ACTIONS 1910 can proceed. HEV ACTIONS 1910 will vary based on the TRUST LEVEL 1905 in terms of both data transmitted by the HEV during a charging session and possible discharges of energy from the HEV.

With reference to FIG. 20, a non-limiting summary architecture for one or more implementation(s) of the systems described herein is provided. As shown in FIG. 20 ELECTRIC VEHICLE 100 of FIG. 1 receives geolocation coordinates from a plurality of SATELLITES 103 of FIG. 1 and/or transmission TOWERS 2010 which coordinates are processed by the NAVIGATION SYSTEM 110 of FIG. 1 for further processing and transmittal within the FILE 150 of FIG. 1 via POWERLINE COMMUNICATION 303 of FIG. 3 to ELECTRIC VEHICLE CHARGING EQUIPMENT 305 of FIG. 3 or via WIRELESS COMMUNICATION 325 of FIG. 3 to either ELECTRIC VEHICLE CHARGING EQUIPMENT 305 or the COMMUNICATING ELECTRIC UTILITY METER 310 of FIG. 3. In one implementation, the ELECTRIC VEHICLE 100 of FIG. 1 engages with off-grid ELECTRIC VEHICLE CHARGING EQUIPMENT 305 that is energized by a RENEWABLE ENERGY SOURCE 2020 or STORED ENERGY 2030 such that an ALTERNATE COMMUNICATION PATHWAY 2040 will be sufficient to transmit FILE 150 of FIG. 1 to the AUTHORIZED THIRD PARTY PROCESSOR, SETTLEMENT AND STORAGE SERVICE PROVIDER 1710 of FIG. 17. On-grid implementations include transmissions of FILE 150 of FIG. 1 by the COMMUNICATING ELECTRIC UTILITY METER 310 of FIG. 3 to the ELECTRIC UTILITY HEAD-END 330 of FIG. 3 by means of POWERLINE 1625 and POWERLINE 1635 of FIG. 16 communications or WIRELESS MEANS 333 of FIG. 3, following which the ELECTRIC UTILITY HEAD-END 330 of FIG. 3 further transmits FILE 150 to the AUTHORIZED THIRD PARTY PROCESSOR, SETTLEMENT AND STORAGE SERVICE PROVIDER 1710 of FIG. 17 to conduct the USAGE FEE CALCULATIONS AND SETTLEMENT PROCESSES 2050 inclusive of two way communications and data sharing between the parties. In one implementation USAGE FEE CALCULATIONS AND SETTLEMENT PROCESSES 2060 are conducted between the AUTHORIZED THIRD PARTY PROCESSOR, SETTLEMENT AND STORAGE SERVICE PROVIDER 1710 of FIG. 17 and PRIVATE ENTITIES 2070. Collected usage fee REMITTANCES AND DATA FILES 2080 can be made directly to JURISDICTIONAL AUTHORITIES 2090 by an ELECTRIC UTILITY HEAD-END 330 of FIG. 3 or to the JURISDICTIONAL AUTHORITIES 2090 by the AUTHORIZED THIRD PARTY PROCESSOR, SETTLEMENT AND STORAGE SERVICE PROVIDER 1710 of FIG. 17 via an AGENCY TRANSMISSION 2100 of data files and monetary consideration. In one embodiment, a vehicle miles traveled audit process is conducted on the ELECTRIC VEHICLE 100 of FIG. 1 during a VEHICLE INSPECTION 2110 wherein mileage traveled data is requested of the AUTHORIZED THIRD PARTY PROCESSOR, SETTLEMENT AND STORAGE SERVICE PROVIDER 1710 of FIG. 17 and requested mileage traveled data is returned via an AUDIT REQUEST 2120 concluding with the transmission of an audit report by the VEHICLE INSPECTION 2110 agent to the JURISDICTIONAL AUTHORITIES 2090 and the AUTHORIZED THIRD PARTY PROCESSOR, SETTLEMENT AND STORAGE SERVICE PROVIDER 1710 of FIG. 17 either verifying that vehicle mileage traveled has been accounted for by the payment of usage fees or that discrepancies exist. Information inclusive of vehicle inspection and audit reports can be passed from the AUTHORIZED THIRD PARTY PROCESSOR, SETTLEMENT AND STORAGE SERVICE PROVIDER 1710 of FIG. 17 to a registered electric VEHICLE OWNER/LESSEE 1800 of FIG. 18 through a secure APPLICATION 2130. The VEHICLE OWNER/LESSEE 1800 of FIG. 18 can perform DIAGNOSTICS 2140 on the ELECTRIC VEHICLE 100 of FIG. 1 to investigate any audit discrepancy.
[reserved]
[reserved]

Numerous modifications to the apparatuses, systems, and methods disclosed herein will be apparent to those skilled in the art in view of the foregoing description. Accordingly, this description is to be construed as illustrative only, and is presented for the purpose of enabling those skilled in the art to make and use the invention and to teach the one implementation(s) of the mode of carrying out same. The exclusive rights to all modifications within the scope of the disclosure and the appended claims are reserved.

The following References are provided hereby as sources of background information only; such references are neither acknowledged as nor intended to be either prior art or limiting to patentability of the invention disclosed herein:

| | | |
|---|---|---|
| 5,359,528 | October 1994 | Haendel |
| 5,422,473 | June 1995 | Kamata |
| 5,612,875 | March 1997 | Haendel |
| 5,694,322 | December 1997 | Westerlage |
| 5,954,773 | September 1999 | Luper |
| 5,974,356 | October 1999 | Doyle |
| 6,115,655 | September 2000 | Keith |
| 6,393,346 | May 2002 | Keith |
| 6,571,168 | May 2003 | Murphy |
| 6,714,857 | March 2004 | Kapolka |
| 6,718,263 | April 2004 | Glass |
| 6,741,933 | May 2004 | Glass |
| 6,845,318 | January 2005 | Moore |
| 7,117,075 | October 2006 | Larschan |
| 7,522,069 | April 2009 | Tunnell |
| 7,555,378 | June 2009 | Larschan |
| 7,881,838 | February 2011 | Larschan |
| 7,917,251 | March 2011 | Kressner |
| 8,032,277 | October 2011 | Larschan |
| 8,626,377 | January 2014 | Larschan |
| 8,825,280 | September 2014 | Tanaka |
| 9,159,175 | October 2015 | Larschan |
| 9,230,437 | January 2016 | Brinton |
| 9,582,943 | February 2017 | Morrison |
| 9,633,486 | April 2017 | Lesesky |
| 9,646,351 | May 2017 | Harter |
| 9,818,120 | November 2017 | Lesesky |
| 9,937,811 | April 2018 | Tabatowski-Bush |
| 10,127,556 | November 2018 | Lesesky |
| 10,127,743 | November 2018 | Ozturk |
| 10,157,384 | December 2018 | Lesesky |
| 2009/0313103 | December 2009 | Ambrosio |
| 2010/0274570 | October 2010 | Proefke |
| 20140/337253 | November 2014 | Berezin |

“Paying at the Pump: Gasoline Taxes in America”, Jonathan Williams, Tax Foundation Background Paper, October 2007, Number 56 (https://financecommission.dot.gov/Documents/Tax%20Foundation%20paper%20on%20Gas%20Tax.pdf)
“The Path Forward: Funding and Financing our Surface Transportation System; Interim Report of the National Surface Transportation Infrastructure Financing Commission”, February 2008 (https://financecommission.dot.gov/Documents/Interim%20Report%20-%20The%20Path%20Forward.pdf)
“U.S. Department of Treasury Internal Revenue Service Publication 510: Excise Taxes (Including Fuel Tax Credits and Refunds)”, Revised March 2018 (https://www.irs.gov/pub/irs-pdf/p510.pdf)
“Missouri Department of Revenue Motor Fuel Tax FAQ” (https://dor.mo.gov/faq/business/fuel.php#q9)
“Oregon's Road Usage Charge: The OReGO Program Final Report” Oregon Department of Transportation, Kathryn Jones, Maureen Bock, April 2017 (https://www.oregon.gov/ODOT/Programs/RUF/IP-Road%20Usage%20Evaluation%20Book%20WEB_4-26.pdf)
“2010 Status of the Nation's Highways, Bridges and Transit: Conditions & Performance” U.S. Department of Transportation, Federal Highway Administration (https://www.fhwa.dot.gov/policy/2010cpr/chap2.cfm)
“Washington is testing how it could charge drivers for miles they drive to keep up state roads”, Samantha Wohlfeil, Inlander Weekly Newspaper, Mar. 29, 2018 (https://www.inlander.com/spokane/as-cars-get-more-efficient-washington-is-testing-how-it-could-charge-drivers-for-miles-they-drive-in-order-to-keep-up-state-roads/Content?oid=8994398)
“Nevada Vehicle Miles Traveled (VMT) Fee Study”, Nevada Department of Transportation, Scott Rawlins, P. E., C. P. M., Deputy Director, December 2010 (https://www.nevadadot.com/home/showdocument?id=2405)
“Mileage-Based Road User Charges”, Congressional Research Service, Robert S. Kirk, Marc Levinson, Jun. 22, 2016 (https://fas.org/sgp/crs/misc/R44540.pdf)
“National Evaluation of a Mileage-based Road User Charge”, Public Policy Center, The University of Iowa, Jon G. Kuhl, Paul Hanley, 2009 (https://utcm.tti.tamu.edu/mbuf/presentations/pdfs/Kuhl-UIowa-Eval.pdf)
“SmartGrid/AEIC AMI Interoperability Standard Guidelines for ANSI C12.19/IEEE 1377/MC12.19 End Device Communications and Supporting Enterprise Devices Networks and Related Accessories”, Version 2.1, Jul. 26, 2012 (https://aeic.org/wp-content/uploads/2013/07/AEIC-Guidelines-v2.1-2012-07-26clean.pdf)

The various implementations and examples shown herein illustrate methods and systems for assessment of roadway fees for electric and hybrid-electric vehicles. A user of the present methods and systems can choose any of the indicated implementations, or equivalents thereof, depending upon the desired application. In this regard, it is recognized that various forms of the subject assessment of roadway fees for electric and hybrid-electric vehicles methods and systems could be utilized without departing from the scope of the present technology and various implementations as disclosed.

As is evident from the foregoing description, certain aspects of the present implementation are not limited by the particular details of the examples illustrated herein, and it is therefore understood that other modifications and applications, or equivalents thereof, will be apparent to those skilled in the art. It is accordingly intended that the claims shall cover all such modifications and applications that do not depart from the scope of the present implementation(s). Accordingly, the specification and drawings are to be regarded in an illustrative rather than a restrictive sense.

As is evident from the foregoing and subsequent descriptions, certain aspects of the present technology as disclosed are not limited by the particular details of the examples illustrated herein, and it is therefore understood that other modifications and applications, or equivalents thereof, will occur to those skilled in the art. It is accordingly intended that the claims shall cover all such modifications and applications that do not depart from the scope of the present technology as disclosed and claimed.

Other aspects, objects and advantages of the present technology as disclosed can be obtained from a study of the drawings, the disclosure and the appended claims.

### EXAMPLES

### Example 1

Charging Sessions

The VMT fee system will in one implementation(s) utilize a trusted SHEVC system in order to (a) collect private travel information from a vehicle's VMT Meter Module, and (b) facilitate the transference of information to the “head-end” for both use tax/fees due and credits available (from sales taxes paid during “non-trusted” charging sessions AND from credits attributable to any “vehicle-to-grid” discharges).

In one implementation(s), the HEV owner selects a level of “trust” relative to the TSHEVC used as his or her primary charger. This would generally be “Trust Level 1” (TL1) for the home charger (for a home owner), but could also be a dedicated trusted charger at an apartment complex, condominium association, townhomes, etc., or at his or her place of employment. A TL1 TSHEVC in one implementation(s) is also selected as the business owner's charger setting for his or her business vehicle(s), whether a single vehicle or a fleet. A TL1 TSHEVC in one implementation(s) represents a dedicated charger available to taxis or ride-share vehicles (including autonomous vehicles) where privacy is valued at a premium. A TL1 TSHEVC would be authorized to forward the trip report results to the head-end for eventual storage in the cloud. Every HEV, in one implementation(s), has at least one designated TL1 TSHEVC for processing at least annually.

A “Trust Level 2” (TL2) TSHEVC would be a charger where the vehicle owner is unwilling to share any private information with the charging station other than a VIN, the identity of the primary VOPEUSP and the VOPEUSP Account Number (for purposes of billing relating to the purchase of electricity and a respective sales tax). In this case, the amount of electricity consumed (to be added to the owner's next bill) along with the amount of sales tax collected would be shared with the TL2 charger's “head-end” utility service provider, so that the charges can be pursued with the vehicle owner's primary electric utility. Note that if the TL2 TSHEVC is located in a service territory other than the VOPEUSP, the utility that provides energy to the TL2 charger would be entitled to collect a sales tax, which would be collected from the vehicle owner's utility service provider at the end of the billing cycle, regardless as to whether the HEV owner has engaged in a TL1 charging session before the conclusion of the billing cycle.

The lowest level of trust, or “Trust Level 3” (TL3), would be a scenario where the vehicle owner would prefer to share no personal information but, rather, would prefer to purchase a charging session on a prepayment basis (both for electricity and sales tax) by use of a credit or debit card, PayPal or the like. In one implementation(s), the vehicle owner submits a receipt showing tax paid relative to the purchase of the electricity to the utility service provider so that a credit in one implementation(s) is processed on a future bill.

The following table summarizes the expected options with respect to the selection of the Level of Trust based upon privacy tolerances:

| | Trust | | |
|---|---|---|---|
| Storage of Personal Travel Data | Level 1 | Level 2 | Level 3 |
| Cloud based (Travel report) | X | X | |
| Cloud based (VIN, VOPEUSP & Acct No.) | | | |
| Deferred | | | X |

The vehicle owner who would desire the highest level of privacy protection would choose to entrust a dedicated TL1 TSHEVC that utilizes a powerline communication technology as the medium for transmitting a VMT report to the utility head-end to address the “air gap” issue. This would be the safest way to protect against an unauthorized person gaining access to the VIN and associated Utility Account information. Let's pause for a moment to discuss the disclosed process for charging the HEV owner for VMT usage fees. There are many use cases that should be considered, but for now we will consider one implementation of a new (or used) electric vehicle being purchased by an individual who will be installing a new SHEVC in his or her home garage:

In this scenario [where a new/used HEV and new/used SHEVC are placed into service simultaneously, and the SHEVC is selected as a dedicated TL1 TSHEVC at the residential location] the process is understood as follows:
1. At the time of the vehicle purchase (whether new or used) a notice is filed with the electric utility service provider that will be providing primary service to the vehicle owner. This notice may be delivered by the dealer or, in the case of an individual-to-individual sale, by the HEV purchaser to the electric utility. That notice will include the VIN, the (certified) mileage at the time of purchase, the owner's utility account number and his or her email address. The utility service provider will establish an HEV VIN subaccount for its customer, and will further establish a mirror account at an Authorized Third Party Processing/Settlement/Storage Service, also referred to as the AT2P3S.

The third-party will demonstrate (at a minimum) that it is qualified by being able to:
(a) securely receive a VMT report text file from the utility (which file has been transmitted by the vehicle owner to the utility via an AMI or AMR3 enabled meter that receives said file from the TSHEVC which receives the file from the HEV's VMT Meter Module).
(b) parse the VMT report text file so that the data can be analyzed. This will require extracting mileage on the basis of:
   (i) the utility territory, taxing authority (i.e., possibly to the level of the relevant municipality), and jurisdiction (e.g., Ameren Missouri v. Ameren Illinois)
   (ii) road classes corresponding to (b)(i) and
   (iii) specially designated waypoints (such as bridges and tunnels) corresponding to (b)(i)
(c) maintain up-to-date VMT fee schedules across relevant taxing jurisdictions
(d) perform VMT use charge calculations
(e) receive and validate credits for
   (i) sales tax attributable to TL2 charge sessions
   (ii) sales tax paid by the vehicle owner during TL3 charge sessions and
   (iii) sales tax claims filed by the vehicle owner for charges during non-SHEVC sessions
   (iv) include any additional credits that may be available by law or incentive programs (e.g., vehicle to grid discharges to support demand response programs, etc.)
(f) prepare the initial and the subsequent monthly fee/tax settlement statements to be transmitted to the utility service provider(s) (the monthly settlement amounts should be included in the vehicle owner's utility bill);
(g) prepare settlement statements for net fee/tax amounts owed between utilities for fees/taxes collected by them but attributable to other jurisdictions (e.g., fees/taxes collected by a Kansas utility for a TL3 charging session paid by a Missouri resident);
(h) store the information for the respective vehicle for a specified retention period;
(i) produce ancillary reports to share with authorized recipients (e.g., a miles driven history relative to a transfer of title); and coordinate with authorities concerning audit processes and procedures.

Advanced Metering Infrastructure (AMI) refers to a system that measures, collects, and analyzes energy usage, communicates with metering devices (in this report, electricity meters or “smart meters”) either on request or on a schedule. These systems include hardware, software, communications, consumer energy displays and controllers, customer associated systems, meter data management software, and supplier business systems.

Automatic meter reading (AMR) is the technology of automatically collecting consumption, diagnostic, and status data from electric energy metering devices and transferring that data to a central database for billing, troubleshooting, and analyzing.

Originally, AMR devices just collected meter readings electronically and matched them with accounts. As technology has advanced, additional data could then be captured, stored, and transmitted to the utility head-end for processing. Generally, the data in an AMR meter is collected by drive-by or walk-by methods, but short-hop approaches are also sometimes employed so that the metering devices can be accessed remotely. Data from the meter can include event alarms such as tamper, leak detection, low battery, or reverse flow. Many AMR devices can also capture interval data, and log meter events. The logged data can be used to collect or control time of use data that can be used for energy usage profiling, time of use billing, demand forecasting, demand response, remote shutoff, etc. AMI represents the networking technology of fixed network meter systems that go beyond AMR into remote utility management. The meters in an AMI system are often referred to as smart meters, since they often can use collected data based on programmed logic.
2. The TSHEVC is paired with an electric utility meter. In instances where a utility meter is not dedicated to the TSHEVC, this can be accomplished using a standard powerline protocol (e.g., Homeplug) or wirelessly (e.g., using the Zigbee protocol) to pair with an electric utility meter (ideally the one that serves the home, apartment, townhome, etc. of the vehicle owner, or at least one which is located within the vehicle owner's primary service territory). Note, however, as discussed herein, that a wired solution would be preferred.

For instance, a wireless approach to engaging a TSHEVC as a node on a home area network can include a utility (such as Duke Energy) that has a deployment of Itron's Silver Spring network that includes smart meters with home area network capabilities which communicate via the Zigbee protocol.
3. Contact is initiated between the TSHEVC and the utility service provider by means of the electric utility meter. The communication is facilitated by the resident utility's advanced metering infrastructure.

In this step, the installer initiates a node notification request (via the home area network or by phone, etc.) and a response is provided that the head-end has received the request, along with an SHEVC asset tag, serial number, or some other designated form of charger identification.
4. The owner's vehicle that is to become paired with the TSHEVC must be located at or near the TSHEVC. If a wireless approach to transmitting trip reports is selected, then the vehicle and the TSHEVC are paired using an available common protocol (e.g., Bluetooth, DSRC, Zigbee, etc.). If a wired approach is preferred then the vehicle must be connected as if a charging session were in process. Again, a wired approach would be preferred.
5. It is at this stage that the vehicle owner identifies the SHEVC as a TL1 TSHEVC, and security keys are exchanged such that the vehicle and the TSHEVC will remember their pairing (until one of the two affirmatively breaks the relationship).
6. The initiation process will ask the vehicle to transmit a current trip report to the TSHEVC which will then be forwarded to the primary utility service provider (and then along to the qualified third-party service provider, as described in Step 1).
7. The vehicle owner will receive an initial VMT fee report, via email, showing the calculation of the VMT fees that have accrued since the utility's receipt of the purchase statement. For example, if the purchase statement mileage indicated the accumulated mileage on the used vehicle was 20,100 miles and the TL1 TSHEVC transmitted report indicates an odometer reading of 20,134 miles comprised entirely of Class 1 roadways (charged at $0.03 per mile), then the initial report would indicate a VMT charge (yet to be billed) of (20,134−20,100)=34×$0.03=$1.02.

In one implementation(s), the information that is collected and transmitted by the HEV VMT Meter Module would include the following:

Trust Level 1 Charging Session
VIN
Identity of HEV Owner's or Lessee's VOPEUSP
VMT by roadway classification and (generically) by special waypoint classification (e.g. bridges, dams, etc.), in tranches determined on the basis of the taxing jurisdictions where the VMT occurred.
The current Odometer reading
Electronic receipts for sales tax paid during TL3 charging sessions.

Trust Level 2 Charging Session
VIN
Identify of HEV Owner's or Lessee's VOPEUSP (for purposes of deferred charge)
VOPEUSP Account Number

Trust Level 3 Charging Session
VIN (for purposes of corroborating sales tax credit)
Payment method (credit card, electronic transaction, prepaid debit, etc.).

### Example 2

Medium of Data Transmittal

In one implementation, in the case of a VMT User Fee System, an architecture includes a “trusted” remote stationary computer (within the SHEVC) that collects the “roadway class /waypoint/odometer data report” which is generated by the vehicle's VMT Meter Module and transmitted to said SHEVC; which SHEVC further transmits the report (without further processing) to the utility head-end; which utility head-end subsequently transmits the report to an AT2P3S for final VMT fee calculations and settlement processing.

The adjective “trusted” can be important. The vehicle owner in one implementation(s) decides to enable one or more SHEVCs to be authorized to have access to his or her travel report and to forward the report to the utility so that the utility in one implementation(s) calculates use fees (e.g., a charger at home, a charger at work, a charger at a family members house, etc.) depending upon the vehicle owner's confidence that the SHEVC will protect his or her privacy (in terms of the information in the transmitted report); or alternatively, the owner in one implementation(s) is not overly concerned about their summary travel report becoming publicly known and so every SHEVC could be considered as “trusted”. However, the architecture in one implementation(s) is designed to offer maximum protection to those who insist on privacy, and so security measures in one implementation(s) are disclosed.

As previously discussed, GPS Tracking devices are capable of transmitting data wirelessly (using cellular plans, private radio networks and local area networks (WiFi and Bluetooth, for example). GPS receiver units in one implementation(s) are also be connected with cables to computer ports to directly download the travel report(s).

Ideally, in order to protect the privacy of an electric vehicle owner/lessee, steps will be taken to ensure that the transference of the travel report(s) (which contain VIN #, Utility Service Provider Name and Account Number) will not be accessed by unauthorized persons. In order to accomplish that goal, we in one implementation(s) start with the concept of an “air-gapped” system.

### Example 3

HEV Transmission of the VMT Report

As noted, in one implementation(s), a VMT use system will allow the vehicle to provide certain data relative to miles traveled over specific classes of roads (including special waypoints such as bridges and tunnels). Ideally the information will be processed within the vehicle and summarized in a standardized report in the form of a text file by the VMT Meter Module, and then transmitted to an authorized remote processor, to or through an SHEVC, so that (official) VMT fees can be calculated. Of course, since the standardized text file will contain certain identifying information (the VIN, utility and account number), the vehicle owner in one implementation(s) has confidence that the SHEVC will protect the information that is being transferred from a potential invasion of privacy. A starting point for protecting privacy would be in one implementation(s) to specifically designate only select SHEVCs as “trusted” chargers (“TSHEVCs”).

For example, a vehicle owner's home charger in one implementation(s) is designated as a TSHEVC. An SHEVC at the vehicle owner's place of employment in one implementation(s) is also designated as a TSHEVC (should the owner so desire), whereas a charger in a public parking location in one implementation(s) is not considered to be safe for purposes of sharing the travel report.

It is the TSHEVC that would receive the report of information collected by the vehicle since the occurrence of the last trusted charging session, such information report to specifically include the following:
1. [In the case of a newly ordained “trusted” charger] A password—to allow the vehicle to commence a data transfer. It is anticipated that established TSHEVCs can exchange credentials or keys with the HEV so that they become “known” as trusted devices;
2. The Odometer reading at the end of the last trusted charging session/the beginning of the current travel log;
3. The date/time of the last trusted charging session;
4. A report of the mileage driven by road class, including any waypoints traveled that have been designated for special fees (such as bridges or tunnels), since the last trusted charging session;
5. The Vehicle Identification Number (VIN);
6. The Vehicle Owner's Primary Electric Utility Service (“VOPEUS”) that provides electric service to the home of the HEV owner;
7. The vehicle owner's account number with the VOPEUS.

The desired/sufficient information is likely to be stored within or generated by various ECUs in the vehicle (i.e., the VIN within the Engine Control Unit; the Odometer within the Instrument Panel Cluster; the navigation trackpoints and waypoints from the Infotainment network). Currently, the VIN and Odometer readings would appear to be best accessed via the CAN bus, whereas the navigation coordinates would likely be accessed via the MOST or Ethernet network; or, could be accessed via the Central Gateway.

### Example 4

Payment Methods

In one implementation of the HEV Use Fee Collection System, the HEV owner engages in a trust level 1 (TL1) charging session, following which the HEV owner's VOPEUSP will bill the HEV owner for usage fees after the reporting of “taxable” VMT. This post-energy use payment in one implementation(s) is accomplished through any of the available options generally available, including a check, an on-line banking transfer (a debit), a credit card charge, etc. An implementation also includes the TL2 charging option, whereby energy purchases from SHEVCs in one implementation(s) are deferred (which can entail a fee) and billed though the monthly VOPEUSP statement.

TL3 payments, however, are of the nature that payment for the energy transferred along with a prepaid sales tax occurs at the time of the charging session. The payment in one implementation(s) is accomplished via an HEV owner's debit or credit card, a Paypal or similar account, or (for maximum obscurity) a prepaid debit card.

New payment methods in one implementation(s) are also established, such as VOPEUSP issued credit cards or prepaid tokens similar to the method that TouchTunes utilizes for its online juke-box entertainment app (http://api.mytouchtunes.com/mobile-faq). In this scenario, an HEV owner in one implementation(s) purchases credits that are stored in an HEV ECU memory or a smart phone, which devices are to be synced to an SHEVC and which credits are used to pay for energy transferences from TL3 SHEVCs during charging sessions.

With respect to off-grid charges, which will consist of vehicle chargers that do not have functioning communications capabilities, the HEV owner in one implementation(s) transmits its receipt for sales tax paid attributable to such charging sessions to its VOPEUSP (or directly to an AT2P3S) with a request for credit for such sales taxes paid. The method of transmittal can vary, to include traditional postal or other mail (“snail mail”), email or uploading an image of the receipt to a VOPEUSP or AT2P3S portal, for example.

Additional payment methods, such as ApplePay, Bitcoin and similar crypto-currencies or comparable existing electronic payment methods can be employed, and other yet to be developed approaches should be considered as within the scope of this the HEV Use Fee Collection System.

### Example 5

Privacy and Security

The expectation of privacy by the individual is currently a hot topic on Capitol Hill. Chief Executive Officers of social media companies have recently come under fire for utilizing personal information, unbeknownst to the patrons of those sites, for commercial gain. And while Facebook's CEO (Mark Zuckerberg) has of lately postulated that “the future is private” (https://www.washingtonpost.com/lifestyle/style/mark-zuckerberg-claims-that-at-facebook-the-future-is-private-dont-believe-him/2019/05/03/b42f7564-6cf4-11e9-a66d-a82d3f3d96d5_story.html?noredirect=on&utm_term=0.5d6936e06355) (most likely under duress), there are other enterprises that are unabashed about their intent to utilize individuals' personal information, whereabouts and buying habits, for commercial purposes. Foursquare Labs, Inc., for example, is exceptionally transparent in its pursuit of utilizing location data of its app users to generate profits. (https://enterprise.foursquare.com/products/places).

There are, however, companies that hold the goal of maintaining user privacy as a core principle. For example, HERE Global B.V., headquartered in the Netherlands, has made public statements concerning its privacy conscious ideals (https://www.here.com/blog/privacy-and-data-regained-privacy-conscious-machine-learning). HERE Automotive is a leader in the vehicle services market, offering over-the-air software updates, location services (such as identification of fuel stations with associated pricing, as well as sites of electric vehicle charging stations), and navigation solutions (i.e., mapping software, including software-as-a-service). HERE does not address the usage fee assessment and settlement system which is the subject herein, but HERE in one implementation(s) serves as a strategic partner if it is capable of providing navigation software that facilitates the collection of roadway classifications pursuant to the requirements of the described system.

Herein is described an acute awareness of the need to maintain the privacy of individual HEV owners or lessees, and to implement security over information relating to the travel patterns of the HEV operator, both of those concerns addressed as central tenants of a robust system. Rather than accumulate specific location data, the system which is the subject hereof looks to accumulate data in homogenous buckets . . . with some exceptions. Specifically, the VMT data groupings in one implementation(s) are attributed to the HEV owner or lessee such that collection of appropriate usage fee can be facilitated, but in a manner that shelters the identity of the individual.

The author has concluded, therefore, that utilizing the VIN—which has been registered with a VOPEUSP as relating to a specific “primary” utility account number—in one implementation(s) is an acceptable approach to shelter the privacy of the individual HEV owner or lessee. Yes, the utility account number may be traced to the individual, but with appropriate firewalls and related security measures, dissemination of the identification information that would allow a bad actor to collect a VIN and trace that information back to the individual HEV owner through the VMT Use Fee Collection System in one implementation(s) is minimized.

Notwithstanding the above, current Federal Law has taken steps to limit the collection of information relative to VINs in the interest of ensuring privacy. Public Law 114-94, signed into law on Dec. 4, 2015, Subtitle C— Miscellaneous Provisions, Part I, provides us the “Driver Privacy Act of 2015”. This Act is intended to limit data retrieval from vehicle event data recorders unless (1) a court or other judicial or administrative authority having jurisdiction authorizes the retrieval of the data and, to the extent that there is retrieved data, the data is subject to the standards for admission into evidence required by that court or other administrative authority; (2) an owner or lessee of the vehicle provides consent; (3) the data is retrieved pursuant to an investigation authorized under Section 1131(a) or 30166 of Title 49 (each sections dealing with accidents); (4 the data is retrieved for the purpose of emergency medical response or (5) the data is retrieved for traffic safety research without disclosing personal information, including the VIN, in connection with the retrieved data.

Initially, it can be important to determine if a Vehicle Miles Traveled Meter Module, as described herein, is analogous to a “vehicle event data recorder” as described in this Act. If not, then the provisions of the Act should not apply to VMT Meter Modules. Per Sec. 24302(a) of the Act, “Any data retained by an event data recorder (as defined in section 563.5 of title 49, Code of Federal Regulations) . . . is the property of the vehicle owner or lessee . . . ”. Section 563.5 provides the following definition: “Event data recorder (EDR) means a device or function in a vehicle that records the vehicle's dynamic time-series data during the time period just prior to a crash event (e.g., vehicle speed vs. time) or during a crash event (e.g., delta-V vs. time), intended for retrieval after the crash event. For the purposes of this definition, the event data do not include audio and video data.”

Arguably, the phrase “vehicle's dynamic time-series data during the time period just prior to a crash event” could include the collection of VMT roadway classes and waypoints. Therefore, the law in one implementation(s) is amended to allow for VMT Meter Module assessment as described herein (in order to make usage fee reporting compulsory), or, to ensure compliance with the current law, a vehicle owner's consent would need to be obtained in order to participate in the self-reporting usage fee collection program.

In either event, it is clear that public policy is focused on ensuring the privacy of individuals absent a specific consent to share personal information. Therefore, the goal of this system is to obtain VMT information such that the individual's privacy is protected to the maximum extent possible AND that such information is transmitted securely so that bad actors (anyone attempting to gain inappropriate access) will not be able to obtain access to the information and, if the security measures be circumvented, then the personal information is limited to the point of being relatively useless to a hacker.

The steps taken to accomplish that goal include the following:
1. Limit the information collected by the HEV VMT Meter Module to roadway classifications and waypoint classifications. By collecting mileage driven by broad categories (e.g., highways, side roads, parking lots, etc.) without specifying the exact location of the highways, etc. traveled, the privacy of the HEV driver should be maximized. The categories should correspond to the usage brackets put in place by the taxing authorities. For example, if the state of Texas implemented a single usage fee rate of $0.03 per mile for every mile driven within the state, whether highway, side road or bridge, then the simple reporting of “Taxable Texas Mileage” would be sufficient for purposes of the VMT usage fee calculation, but in other states a more detailed delineation of mileage may be required . . . so the VMT Meter Module would need to accommodate the more detailed classification requirements. Note, while the VMT Meter Module would in one implementation(s) collect only mileage values, the report to be provided during TL1 charging sessions (as described below) would require the provision of information from other HEV ECUs in order to provide a complete report (namely, the VIN and VOPEUSP account information—stored elsewhere—along with any required TL3 payment information, and any required username, password or other credentials, as may be necessary).
   A variance to the above may arise in situations where an HEV travels through a private subdivision, and said subdivision has petitioned to collect usage fees from vehicles that utilize those private roadways. For example, the homeowners of the Parkview Subdivision in University City, Mo. (http://www.parkviewneighborhood.org/information) have made their neighborhood indentures available for the public to view. With respect to the subdivision streets, the neighborhood website states the following:
   “As a private subdivision, Parkview maintains its own streets, sidewalks and gates. At least once each year streets are chained for a 24-hour period. This is to maintain the status of a private street. The schedule for these closings is published in the newsletter and a reminder is sent via email.”
   While the streets to the subdivision are clearly inaccessible for a single day during each year, it appears as though the streets are available the other 364 days (+1 for leap year) during the year for non-residents to travel.
   It is understood that, as a feature of the VMT Use Fee Collection System, the residents of the Parkview subdivision can file a petition with the state to request a usage fee from vehicles that have traveled over their streets (potentially excluding residents) to aid in the ongoing repair and maintenance of said streets.
   Assuming that such petitions are granted, the VMT Meter Module can necessarily be required to collect specific mileage driven over such specific private roadways, and that information would need to be shared with the AT2P3S for settlement purposes.
   So, while the privacy of the individual HEV owner/lessee would be maintained to the greatest extent possible, it may be that legislation or regulation views the property rights of the owners of private roadways in higher regard as compared to the HEV owners' privacy rights in such a case.
2. Limit the transmission of VMT data in one implementation(s) from the HEV to only Trust Level 1 Smart (Plug-in) Hybrid-electric Vehicle Charging Systems (TL1 SHEVCSs). TL1 SHEVCSs are designated as such by the HEV Owner, but are to be described as SHEVCs (a) within the control of the HEV Owner (as in the case of a residential homeowner) or (b) within the control of an individual or entity trusted by the HEV Owner to maintain the highest level of security and oversight over the SHEVC. This can include an SHEVC owned by a friend or relative, or an SHEVC maintained by the HEV Owner's employer, one located at a police station, postal office or a certified HEV maintenance and repair facility, for example.
   The preference for limiting the transmission of HEV VMT reports by means of the TL1 SHEVC is to minimize the potential that the information may be intercepted by a bad actor. That said, the format of the VMT report itself would be intended to reduce exposure to a breach of privacy.
3. Limit the information presented by the HEV VMT Meter Module in one implementation(s) to a file containing only the summary information required in order to produce an accurate billing/settlement of usage fee (or sales tax credit). As disclosed herein, in an implementation, the information that can be collected and transmitted by the HEV VMT Meter Module would include the following:

Trust Level 1 Charging Session
VIN
Identity of HEV Owner's or Lessee's VOPEUSP
VMT by roadway classification and (generically) by special waypoint classification (e.g. bridges, dams, etc.), in tranches determined on the basis of the taxing jurisdictions where the VMT occurred.
The current Odometer reading
Electronic receipts for sales tax paid during TL3 charging sessions.

Trust Level 2 Charging Session
VIN
Identify of HEV Owner's or Lessee's VOPEUSP (for purposes of deferred charge)
VOPEUSP Account Number

Trust Level 3 Charging Session
VIN (for purposes of corroborating sales tax credit)
Payment method (credit card, electronic transaction, prepaid debit, etc.).
4. Ensure that the format of the report is structured so as to best protect the information from being manipulated via an in transit interception. The VMT Meter Module should generate a report that best protects the integrity of the data from alteration, and which serves to promote a secure transference of data in a manner that minimizes the potential for infiltration of malware into the broader VMT usage fee collection system. In short, the design of the report should be “read only”, but the report should also be capable of being parsed in order to analyze the information contained therein.
5. Design the VMT Meter Module such that in one implementation(s) it only collects information from vehicle ECUs (i.e., the Navigation System and other modules that contain the VIN, etc.), and in one implementation(s) only transmits innocuous text files. The importance of protecting the VMT Meter Module from extraneous sources of electronic transmissions is paramount, as vehicle hacking will undoubtedly be attempted in an effort to circumvent compliance with fee remittance obligations. In addition, it can be important to guard against constructing the VMT Meter Module in a fashion that it can become an entry point for a hacker.

Vehicle hacking is an important concern for vehicles (especially ones that include electronic components), and the HEV will be no exception. Instances of vehicle hacking have been documented in recent years, certain of which have revealed important and even potentially fatal flaws associated with the electronic systems within modern vehicles.

### Example 6

[reserved]

Implementations:

A non-limiting list of implementations of the present invention follows:
1. An automated system for assessing roadway and waypoint usage fees to an electric vehicle user (e.g. owner or operator) for distance traveled over one or more publicly funded thoroughfare comprising:
an electric vehicle user interface configured to select a high trust level of an electric vehicle charging session;
at least one electric vehicle electronic control unit configured to store accessible information comprising odometer data; vehicle identification number; vehicle user primary electric utility service provider identification; vehicle user primary electric utility service provider account number; high trust level engagement credentials;
a mapping software capable of distinguishing roadway classes consisting of interstate highways; state highways; intermodal connectors; rural and urban routes, loops and spurs; minor arterials; collector streets; county roads; city streets; forest service roads; park roads; Indian reservation roads; one or more roadway or roadway portion designated as special purpose by a government authority; other publicly funded roads and private roads from off-road pathways;
a navigation system configured to generate tracks from trackpoints and waypoints specific to more than one predetermined geographic territory each such territory representing a fee collecting jurisdiction;
a datalogger consisting of a receiver, a report writer, a transmitter and memory configured to temporarily accumulate and store track distances based on roadway class and waypoint distances specific to one or more predetermined fee collecting jurisdiction traveled by an electric vehicle, along with receipts relating to prepaid tax, the memory configured to be cleared upon the occurrence of an event;
a datalogger receiver configured to collect track and waypoint information from a navigation system and vehicle and user data from electronic control unit sources within the electric vehicle; a datalogger report writer configured to create an encrypted file from collected datalogger receiver information for transmission consisting of the electric vehicle track distances based on roadway class and waypoint distances specific to one or more predetermined fee collecting jurisdiction, the electric vehicle identification number, the current odometer reading, the identity of the primary electric utility service provider to the electric vehicle user and the primary electric utility service provider account number of the electric vehicle user;
a datalogger transmitter configured to transmit the encrypted file over the embedded electric vehicle communication bus to an embedded vehicle communications gateway;
the embedded vehicle communications gateway configured to transmit the encrypted file to an authorized remotely located receiver node in a local area network;
an authorized receiver node in a local area network remotely located from the electric vehicle configured to receive the encrypted file;
a communicating electric utility meter local area network node configured to receive the encrypted file directly from the electric vehicle or indirectly from one or more alternate local area network nodes;
electric vehicle charging equipment in communication with the communicating electric utility meter;
a primary electric utility service provider providing electricity to electric vehicle charging equipment utilized by the electric vehicle user, the primary electric utility service provider further collecting the encrypted file in a vehicle identification number specific folder in a primary electric utility service provider file collection database;
an electric utility communication network configured to transmit encrypted information including the encrypted file from the electric utility meter local area network node to the primary electric utility service provider file collection database;
a means wherein the primary electric utility service provider receives documentary evidence of sales tax paid by the electric vehicle user on prepaid electricity purchased for the electric vehicle during the period, the evidence to be collected by the electric utility file collection database pursuant to the associated vehicle identification number;
a processor with software configured to determine a usage fee by applying a determinant promulgated by one or more government authority to track distances based on roadway class and waypoint distances reported in one or more the encrypted file and configured to calculate the usage fee obligation of an electric vehicle user owed to one or more fee collecting jurisdictional authority for the period including at least one high trust level authorized charging session of the electric vehicle during a primary electric utility service provider billing cycle;
a billing generated by the primary electric utility service provider to the electric vehicle user configured for the collection of payment for electricity purchases and for track distances based on roadway class and waypoint distances usage fees processed during the period, the billing to provide credit for the documented sales tax paid during the period and credit for any government incentive or utility incentive; and
a net settlement payment or payments by the primary electric utility service provider to one or more fee collecting jurisdictional authority for track distances based on roadway class and waypoint distances usage fees collected from one or more the electric vehicle user during the billing cycle.
2. The system of implementation 1, wherein one or more of the fee collecting jurisdictional authority determine the usage fee to be a tax.
3. The system of implementation 1, wherein the electric vehicle is a hybrid-electric vehicle.
4. The system of implementation 1, wherein the vehicle user is a vehicle lessee.
5. The system of implementation 1, wherein the usage fee is collected for track distance and waypoint distance traveled over a designated privately funded thoroughfare.
6. The system of implementation 5, wherein one or more custodian of a privately funded thoroughfare collects the usage fee for maintenance of the privately funded thoroughfare.
7. The system of implementation 1, wherein the thoroughfare includes bridges, dams and tunnels.
8. The system of implementation 7, wherein a bridge, dam or tunnel is a waypoint.
9. The system of implementation 1, wherein an event causing the clearing of the datalogger memory is a file transmission trigged by an authorized high trust level charging session.
10. The system of implementation 1, wherein the means of receiving vehicle information is a transceiver.
11. The system of implementation 1, wherein the means of transmitting the encrypted file is a wireless transceiver.
12. The system of implementation 1, wherein the local area network is a personal area network or home area network.
13. The system of implementation 1, wherein the electric vehicle charging equipment includes an embedded local area network node.
14. The system of implementation 1, wherein the electric vehicle user causes the electric vehicle to store in long-term erasable memory the trust level selection for specific electric vehicle charging equipment by means of the electric vehicle user interface.
15. An automated system for assessing roadway and waypoint usage fees to an electric vehicle user for distance traveled over one or more publicly funded thoroughfare comprising: an electric vehicle user interface configured to select a high trust level of an electric vehicle charging session;
at least one electric vehicle electronic control unit configured to store accessible information comprising odometer data; vehicle identification number; vehicle user primary electric utility service provider identification; vehicle user primary electric utility service provider account number; high trust level engagement credentials;
a mapping software capable of distinguishing roadway classes consisting of interstate highways; state highways; intermodal connectors; rural and urban routes, loops and spurs; minor arterials; collector streets; county roads; city streets; forest service roads; park roads; Indian reservation roads; one or more roadway or roadway portion designated as special purpose by a government authority; other publicly funded roads and private roads from off-road pathways;
a navigation system configured to generate tracks from trackpoints and waypoints specific to more than one predetermined geographic territory each such territory representing a fee collecting jurisdiction;
a datalogger consisting of a receiver, a report writer, a transmitter and memory configured to temporarily accumulate and store track distances based on roadway class and waypoint distances specific to one or more predetermined fee collecting jurisdiction traveled by an electric vehicle, the memory configured to be cleared upon the occurrence of an event;
a datalogger receiver configured to collect track and waypoint information from a navigation system and vehicle and user data from electronic control unit sources within the electric vehicle;
a datalogger report writer configured to create an encrypted file from collected datalogger receiver information for transmission consisting of the electric vehicle track distances based on roadway class and waypoint distances specific to one or more predetermined fee collecting jurisdiction, the electric vehicle identification number, the current odometer reading, the identity of the primary electric utility service provider to the electric vehicle user and the primary electric utility service provider account number of the electric vehicle user;
a datalogger transmitter configured to transmit the encrypted file over the embedded electric vehicle communication bus to an embedded vehicle communications gateway;
the embedded vehicle communications gateway configured to transmit the encrypted file to an authorized remotely located receiver node in a local area network;
an authorized receiver node in a local area network remotely located from the electric vehicle configured to receive the encrypted file;
a communicating electric utility meter local area network node configured to receive the encrypted file directly from the electric vehicle or indirectly from one or more alternate local area network nodes;
electric vehicle charging equipment in communication with the communicating electric utility meter;
a primary electric utility service provider providing electricity to electric vehicle charging equipment utilized by the electric vehicle user, the primary electric utility service provider further collecting the encrypted file in a vehicle identification number specific folder in a primary electric utility service provider file collection database;
an electric utility communication network configured to transmit encrypted information including the encrypted file from the electric utility meter local area network node to the primary electric utility service provider file collection database;
a means wherein the primary electric utility service provider receives documentary evidence of sales tax paid by the electric vehicle user on prepaid electricity purchased for the electric vehicle during the period, the evidence to be collected by the electric utility file collection database pursuant to the associated vehicle identification number;
an authorized third party processor configured to receive the encrypted files from the electric utility file collection database for processing with software for applying a fee determinant promulgated by one or more fee collecting jurisdictional authority to track distances based on roadway class and waypoint distances reported in one or more the encrypted file and configured to calculate the usage fee obligation of an electric vehicle user owed to one or more fee collecting jurisdictional authority for a period including at least one high trust level authorized charging session of the electric vehicle during a primary electric utility service provider billing cycle, storing the files and calculation records for each vehicle identification number in the electric utility file collection database, performing settlement analyses, reconciling settlement analyses with one or more unrelated authorized third party processor engaged by one or more electric utility for track distances and waypoint distances traveled by one or more electric vehicle in one or more fee collecting jurisdiction outside of the utility service territory of one or more the electric vehicle user, directly performing settlement analyses with one or more electric utility, providing settlement statements to an electric utility for amounts owed to or to be received from one or more unrelated electric utility, and providing billing calculations to an electric utility for amounts owed by each the electric vehicle user to be included on the electric utility service provider billing statement for the upcoming billing cycle;
a billing generated by the primary electric utility service provider to the electric vehicle user configured for the collection of payment for electricity purchases and for track distances based on roadway class and waypoint distances usage fees processed during the period, the billing to provide credit for the documented sales tax paid during the period and credit for any government incentive or utility incentive; and
a net settlement payment or payments including payment by a primary electric utility service provider to one or more fee collecting jurisdictional authority for track distances based on roadway class and waypoint distances usage fees collected from one or more the electric vehicle user during the billing cycle, or a net settlement payment by the primary electric utility service provider to the authorized third party processor for payment to one or more fee collecting jurisdictional authority for track distances based on roadway class and waypoint distances usage fees collected from one or more the electric vehicle user during the billing cycle and for settlement with none, one or a plurality of unrelated electric utility service providers or their authorized third party processor.
16. The system of implementation 15, wherein one or more of the fee collecting jurisdictional authority determine the usage fee to be a tax.
17. The system of implementation 15, wherein the electric vehicle is a hybrid-electric vehicle.
18. The system of implementation 15, wherein the vehicle user is a vehicle lessee.
19. The system of implementation 15, wherein the usage fee is collected for track distance and waypoint distance traveled over a designated privately funded thoroughfare.
20. The system of implementation 19, wherein one or more custodian of a privately funded thoroughfare collects the usage fee for maintenance of the privately funded thoroughfare.
21. The system of implementation 15, wherein the thoroughfare includes bridges, dams and tunnels.
22. The system of implementation 21, wherein a bridge, dam or tunnel is a waypoint.
23. The system of implementation 15, wherein an event causing the clearing of the datalogger memory is a file transmission trigged by an authorized high trust level charging session.
24. The system of implementation 15, wherein the means of receiving vehicle information is a transceiver.
25. The system of implementation 15, wherein the means of transmitting the encrypted file is a wireless transceiver.
26. The system of implementation 15, wherein the local area network is a personal area network or home area network.
27. The system of implementation 15, wherein the electric vehicle charging equipment includes an embedded local area network node.
28. The system of implementation 15, wherein the electric vehicle user causes the electric vehicle to store in long-term erasable memory the trust level selection for specific electric vehicle charging equipment by means of the electric vehicle user interface.
29. A system for temporarily deferring electric vehicle charging session payment comprising: an electric vehicle user interface configured to select a medium trust level of an electric vehicle charging session;
at least one electric vehicle electronic control unit configured to store accessible information comprising odometer data; vehicle identification number; vehicle user primary electric utility service provider identification; vehicle user primary electric utility service provider account number; high trust level engagement credentials;
a datalogger receiver configured to collect information from electronic control unit sources within the electric vehicle;
a datalogger report writer configured to create an encrypted file from collected datalogger receiver information for transmission consisting of the electric vehicle identification number, the current odometer reading, the identity of the primary electric utility service provider to the electric vehicle user and the primary electric utility service provider account number of the electric vehicle user;
a datalogger transmitter configured to transmit the encrypted file consisting of the electric vehicle identification number, the electric vehicle user primary electric utility service provider identification and the electric vehicle user primary electric utility service provider account number over an electric vehicle communication bus to an embedded vehicle communications gateway;
the embedded vehicle communications gateway configured to transmit the encrypted file to an authorized remotely located receiver;
an authorized receiver node in a local area network remotely located from the electric vehicle configured to receive the encrypted file;
a communicating electric utility meter local area network node configured to receive the encrypted file directly from the electric vehicle or indirectly from one or more alternate local area network nodes;
electric vehicle charging equipment in communication with the communicating electric utility meter;
a primary electric utility service provider providing electricity to electric vehicle charging equipment utilized by the electric vehicle user, the primary electric utility service provider further collecting the encrypted file in a vehicle identification number specific folder in a primary electric utility service provider file collection database;
an electric utility communication network configured to transmit encrypted information including the encrypted file from the electric utility meter local area network node to the primary electric utility service provider file collection database;
a communicating electric utility meter local area network node configured to generate an encrypted file containing electricity purchase information to the electric vehicle directly or indirectly from one or more alternate local area network nodes;
a datalogger receiver configured to collect electricity purchase information from the remotely located communicating electric utility meter local area network node or through an authorized transmitter as conveyed through the embedded electric vehicle communications gateway to the datalogger;
datalogger memory configured to temporarily store electricity purchase information, the memory configured to be cleared upon the occurrence of an event;
an electric utility communication network configured to transmit the electric vehicle charging session encrypted electricity purchase information file from the communicating electric utility meter to the electric vehicle charging equipment primary electric utility service provider, the primary electric utility service provider further collecting the electric vehicle charging session information in a vehicle identification number specific folder in a primary electric utility service provider file collection database;
a medium trust level electric vehicle charging session transaction reconciliation between one or more primary electric utility service provider by the primary electric utility service provider to the electric vehicle user comparing the electric vehicle charging equipment meter values to the electric vehicle identification number datalogger stored values upon the occurrence of a high trust level charging session;
a billing generated by the primary electric utility service provider to the electric vehicle user configured for the collection of payment for electricity purchases including any reconciled deferred medium trust level charging session; and
a net settlement payment by the electric vehicle user primary electric utility service provider to an unrelated primary electric service provider of the electric vehicle charging equipment.
30. The system of implementation 29, wherein settlement payments are made or received by or between an authorized third-party processor.
31. The system of implementation 29, wherein the vehicle user is a vehicle lessee.
32 The system of implementation 29, wherein the electric vehicle is a hybrid-electric vehicle.
33. The system of implementation 29, wherein the electric vehicle communicates with the communicating electric meter by wireless means.
34. The system of implementation 29, wherein an event causing the clearing of the datalogger memory is a file transmission trigged by an authorized high trust level charging session.
35. An automated system for payment and reporting of sales tax on electricity purchased to charge an electric vehicle comprising:
an electric vehicle user interface configured to select a low trust level of an electric vehicle charging session;
at least one electric vehicle electronic control unit configured to store accessible information comprising odometer data; vehicle identification number; vehicle user primary electric utility service provider identification; vehicle user primary electric utility service provider account number; high trust level engagement credentials; vehicle user credit, debit or prepayment account credentials;
a datalogger receiver configured to collect information from electronic control unit sources within the electric vehicle;
a datalogger report writer configured to create an encrypted file from collected datalogger receiver information for transmission consisting of at least the electric vehicle payment credentials and the electric vehicle identification number;
a datalogger transmitter configured to transmit the encrypted file over an electric vehicle communication bus to an embedded vehicle communications gateway;
the embedded vehicle communications gateway configured to transmit the encrypted file to an authorized remotely located receiver;
an authorized receiver node in a local area network remotely located from the electric vehicle configured to receive the encrypted file;
a communicating electric utility meter local area network node configured to receive the encrypted file directly from the electric vehicle or indirectly from one or more alternate local area network nodes;
electric vehicle charging equipment in communication with the communicating electric utility meter;
electric vehicle charging equipment in communication with or including a communicating electric utility meter configured to determine the transaction cost of the low trust electric vehicle charging session and further configured to transmit electric vehicle charging session metered transaction cost, comprised of an electricity amount and a sales tax paid, to the electric vehicle datalogger and to the primary electric utility service provider of the electric vehicle charging equipment along with an encrypted file comprised of the electric vehicle identification number and the payment credentials;
an electric utility communication network configured to transmit the electric vehicle charging session metered electricity amount and sales tax amount from the electric vehicle charging equipment communicating electric meter to the primary electric utility service provider, the primary electric utility service provider further collecting the electric vehicle charging session transaction costs and the electric vehicle charging session encrypted file in a vehicle identification number specific folder in a primary electric utility service provider file collection database;
a datalogger receiver configured to collect electricity purchase and sales tax paid information directly from the remotely located communicating electric utility meter or indirectly through an authorized transmitter as conveyed through the electric vehicle communications gateway to the datalogger;
datalogger memory configured to temporarily store electricity purchase and sales tax paid information, the memory configured to be cleared upon the occurrence of a high trust level electric vehicle charging session;
a low trust level electric vehicle charging session transaction reconciliation between one or more primary electric utility service provider by the primary electric utility service provider to the electric vehicle user comparing the electric vehicle charging equipment meter value transaction costs to the electric vehicle identification number datalogger stored values upon the occurrence of an event;
a billing generated by the primary electric utility service provider to the electric vehicle user configured for identifying the prepaid sales tax as a credit against the collection of track distances based on roadway class and waypoint distances usage fees to be assessed during the period ending with the most recent authorized high trust charging session of the electric vehicle user within the primary electric utility service provider billing cycle; and
a net settlement payment by or to the primary electric utility service provider of the electric vehicle charging equipment to or from the electric vehicle user primary electric utility service provider to include credit for sales tax collected.
36. The system of implementation 35, wherein settlement payments are made or received by or between an authorized third-party processor.
37. The system of implementation 35, wherein the vehicle user is a vehicle lessee.
38. The system of implementation 35, wherein the electric vehicle is a hybrid-electric vehicle.
39. The system of implementation 35, wherein the electric vehicle communicates with the communicating electric meter by wireless means.
40. The system of implementation 35, wherein an event causing the clearing of the datalogger memory is a file transmission trigged by an authorized high trust level charging session.
41. A system to audit roadway and waypoint mileage reported to one or more primary electric utility service provider, comprised of:
a government authorized safety inspection facility configured to perform periodic inspections;
a vehicle on-board diagnostic port accessible by the safety inspection facility configured to probe electric vehicle electronic control units and configured to collect odometer data;
a secure internet connection to the primary electric utility service provider of the electric vehicle user configured to issue an authorized request for cumulative mileage reported for roadway and waypoint classes traveled by the vehicle identification number;
a certification issued by the government authorized safety inspection facility to the vehicle user and to one or more government authority confirming that the cumulative mileage reported for roadway and waypoint classes traveled by the vehicle identification number to the primary electric utility service provider of the electric vehicle user reconciles to the odometer value; and
a notification issued by the government authorized safety inspection facility to the vehicle user and to one or more government authority identifying that the cumulative mileage reported for roadway and waypoint classes traveled by the vehicle identification number to the primary electric utility service provider of the electric vehicle user does not reconcile to the odometer value.
42. The system of implementation 41, wherein the vehicle user is a vehicle lessee.
43. The system of implementation 41, wherein the electric vehicle is a hybrid-electric vehicle.
44. A system to request an electric vehicle energy discharge, comprised of:
a communicating electric utility meter configured to determine the transaction cost, the communicating electric utility meter acting as an electric utility service provider medium to request an energy discharge from a connected electric vehicle;
a graphic user interface configured to select predetermined preferences of the electric vehicle user in response to discharge requests based upon the level of trust of the respective electric vehicle charging equipment;
the communicating electric utility meter further transmitting electric vehicle discharge session metered transaction value, comprised of an electricity amount and a tax credit, to the electric vehicle datalogger and to the primary electric utility service provider of the electric vehicle charging equipment along with an encrypted file comprised of the electric vehicle identification number and metered discharge values;
an electric vehicle discharge session transaction reconciliation between one or more primary electric utility service provider by the primary electric utility service provider to the electric vehicle user comparing the electric vehicle charging equipment meter value transaction costs to the electric vehicle identification number datalogger stored values upon the occurrence of a high trust level charging session;
a billing generated by the primary electric utility service provider to the electric vehicle user identifying the discharge tax credit against the collection of track distances based on roadway class and waypoint distances usage fees to be assessed during the period ending with the most recent authorized high trust charging session of the electric vehicle user within the primary electric utility service provider billing cycle; and
a net settlement payment by or to the primary electric utility service provider of the electric vehicle charging equipment to or from the electric vehicle user primary electric utility service provider to include credit for discharge values.
45. The system of implementation 44, wherein settlement payments are made or received by or between an authorized third-party processor.
46. The system of implementation 44, wherein the vehicle user is a vehicle lessee.
47. The system of implementation 44, wherein the electric vehicle is a hybrid-electric vehicle.
48. The system of implementation 44, wherein the source of the request for payment for discharge is not an electric utility service provider.
49. A system for assessing electric vehicle usage fees comprising:
an electric vehicle comprising an electric vehicle user interface;
an electronic control unit configured to store accessible vehicle and/or vehicle user information and/or credentials;
mapping software configured to distinguish roadway classes;
a navigation system configured to generate tracks from trackpoints and waypoints;
a datalogger comprising a receiver, a report writer, a transmitter, and a memory configured to accumulate and store track distances and waypoint distances traveled based on roadway class; wherein the datalogger report writer is configured to collect and compile data for vehicle electronic control unit information and for vehicle distances and waypoints traveled based on roadway classes from navigation system and mapping software information;
wherein the datalogger transmitter is configured to transmit the data over an electric vehicle communication bus to a vehicle communications gateway, wherein the vehicle communications gateway is configured to transmit the data to an authorized remotely located receiver node, wherein the authorized receiver node is configured to receive the file;
a local area network comprising a plurality of communicating nodes;
wherein the electric vehicle is a communicating node,
wherein an electric utility meter is a communicating node, and
wherein the authorized remotely located receiver node is a communicating node and is configured to communicate with a vehicle user designated electric utility service provider, wherein the communicating electric utility node is configured to receive the data directly from the electric vehicle and/or indirectly from one or more alternate local area network nodes, and wherein the data is transmitted to the vehicle user designated electric utility service provider database;
a processor configured to receive the data from the vehicle database and calculate a usage fee, based on roadway class, tracks and waypoints traveled, owed to one or more fee collecting jurisdictional authority.
50. The system of Implementation 49, further comprising:
an electric utility service provider billing system configured to assess roadway and waypoint usage fees from at least one vehicle user,
a further processor configured to receive roadway and waypoint usage fee information from a plurality of electric utility service providers for settlement between the plurality of electric utility service providers and for preparation of usage fee remittance advice to one or more jurisdictional authority;
51. A system for deferring electric vehicle charging session payment comprising:
an electric vehicle comprising an electric vehicle user interface;
an electronic control unit configured to store accessible vehicle and/or vehicle user information and/or credentials;
a datalogger receiver configured to collect information from the electronic control unit sources;
a datalogger report writer configured to compile electronic control unit information and to create an encrypted file from the collected datalogger receiver information comprising at least the electric vehicle identification number and the identity of the vehicle user designated electric utility service provider;
a datalogger transmitter configured to transmit the compiled electronic control unit information encrypted file over an electric vehicle communication bus to an vehicle communications gateway,
wherein the vehicle communications gateway is configured to transmit the compiled electronic control unit encrypted file to an authorized remotely located receiver,
wherein the authorized receiver is configured to receive the compiled electronic control unit encrypted file;
a local area network comprised of a plurality of communicating nodes;
   wherein an electric vehicle is a communicating node within the local area network,
   wherein an electric utility meter is a communicating node within the local area network,
   wherein a node is configured to communicate with an electric utility service provider, a communicating electric utility local area network node configured to receive the compiled electronic control unit information encrypted file directly from the electric vehicle and/or indirectly from one or more alternate local area network nodes;
wherein the communicating electric utility meter local area network node is further configured to generate a file containing electricity purchase information;
electric vehicle charging equipment in communication with the communicating electric utility meter,
wherein electricity to the electric vehicle charging equipment is provided by an electric utility service provider, and
wherein the compiled electronic control unit information encrypted file is collected by the electric utility service provider;
an electric utility communication network configured to transmit information including the compiled electronic control unit information encrypted file;
wherein the communicating electric utility meter local area network node is further configured to generate an additional file containing electricity purchase information;
wherein the datalogger receiver is further configured to collect the electricity purchase information,
an electric utility communication network configured to transmit electric vehicle charging session electricity purchase information file from the communicating electric utility meter to the electric vehicle charging equipment electric utility service provider vehicle database,
wherein the electric utility service provider generates a billing to the electric vehicle user designated electric utility service provider for the collection of payment for electricity purchases wherein the electric vehicle user designated electric utility service provider produces a settlement billing to the electric vehicle user.
52. The system of Implementation 51, wherein electric vehicle user settlement payments are made or received by or between an authorized third-party processor.
53. The system of Implementation 51, wherein the vehicle user is a vehicle lessee.
54. The system of Implementation 51, wherein the electric vehicle is a hybrid-electric vehicle.
55. The system of Implementation 51, wherein the electric vehicle is configured to communicate with the communicating electric meter by wireless means.
56. The system of Implementation 51, wherein the datalogger memory is cleared by an event and wherein the event is a file transmission trigged by an authorized high trust level charging session or wherein the event is an end of life decommissioning of the vehicle.
57. A system for sales tax payment and reporting of electricity purchased to charge an electric vehicle comprising:
an electric vehicle comprising an electric vehicle user interface;
an electronic control unit configured to store accessible vehicle and/or vehicle user information and/or credentials;
a datalogger comprising a receiver, a report writer, a transmitter, and a memory configured to store electricity purchase and sales tax paid information, optionally wherein the memory is further configured to be cleared;
wherein the datalogger receiver is configured to collect information from the electronic control unit sources;
wherein the datalogger report writer is configured to create an encrypted file from collected datalogger receiver information comprising at least the electric vehicle payment credentials and the electric vehicle identification number;
wherein the datalogger transmitter is configured to transmit the encrypted file over an electric vehicle communication bus to a vehicle communications gateway,
wherein the vehicle communications gateway is configured to transmit the encrypted file to an authorized remotely located receiver,
wherein the authorized receiver is configured to receive the encrypted file;
a communicating electric utility local area network node configured to receive the encrypted file directly from the electric vehicle and/or indirectly from one or more alternate local area network nodes;
wherein a communicating electric utility meter is a node in the local area network electric vehicle charging equipment in communication with, or including, the communicating electric utility meter, configured to determine and transmit the transaction cost of an electric vehicle charging session to the electric vehicle datalogger and to the electric utility service provider of the electric vehicle charging equipment and further to transmit the electric vehicle identification number and the payment credentials;
wherein the transaction cost comprises an electricity amount and/or sales tax paid; an electric utility communication network inclusive of the communicating electric utility local area network configured to transmit the electric vehicle charging session transaction costs information and the electric vehicle charging session encrypted file to a vehicle database of the electric utility service provider;
wherein the datalogger receiver is further configured to collect the electricity purchase and sales tax paid information directly from the communicating electric utility meter or indirectly through an authorized transmitter as conveyed through the electric vehicle communications gateway to the datalogger;
wherein the electric utility service provider receiving electric vehicle charging session transaction cost information and the electric vehicle charging session encrypted file engages in a sales tax settlement process with the vehicle user designated electric utility service provider; wherein the vehicle user designated electric utility service provider generates a billing to the electric vehicle user for identifying the prepaid sales tax as a credit against the collection of track distances based on roadway class and waypoint distances usage fee.
58. The system of Implementation 57, wherein settlement payments are made or received by or between an authorized third-party processor.
59. The system of Implementation 57, wherein the user is a vehicle lessee.
60. The system of Implementation 57, wherein the electric vehicle is a hybrid-electric vehicle.
61. The system of Implementation 57, wherein the electric vehicle communicates with the communicating electric utility meter by wireless means.
62. The system of Implementation 28, wherein the datalogger memory is cleared by an event and wherein the event is a file transmission trigged by an authorized high trust level charging session or wherein the event is an end of life decommissioning of the vehicle.
63. A system to audit roadway and waypoint mileage reported to one or more electric utility service provider, comprising:
an electric vehicle and user;
a government authorized safety inspection facility;
a vehicle on-board diagnostic port accessible by the safety inspection facility, wherein the diagnostic port is configured to probe electric vehicle electronic control units and collect odometer data;
a secure internet connection between the safety inspection facility and an electric utility service provider of the electric vehicle user,
wherein the connection is configured to issue an authorized request for cumulative mileage reported for roadway and waypoint classes traveled by the vehicle identification number; optionally wherein a certification is issued by the government authorized safety inspection facility to the vehicle user and to one or more government authority confirming that the cumulative mileage reported for roadway and waypoint classes traveled by the vehicle identification number to the primary electric utility service provider of the electric vehicle user reconciles to the odometer value;
optionally wherein a notification is issued by the government authorized safety inspection facility to the vehicle user and to one or more government authority identifying that the cumulative mileage reported for roadway and waypoint classes traveled by the vehicle identification number to the primary electric utility service provider of the electric vehicle user does not reconcile to the odometer value.
64. The system of Implementation 63, wherein the user is a vehicle lessee.
65. The system of Implementation 63, wherein the electric vehicle is a hybrid-electric vehicle.
66. A system to process a third-party request for an electric vehicle energy discharge, comprising:
a local area network comprised of a plurality of communicating nodes;
wherein an electric vehicle is a communicating node within the local area network,
wherein an electric utility meter is a communicating node within the local area network,
wherein a node is configured to communicate with a vehicle user designated electric utility service provider,
wherein the communicating electric utility meter is configured to determine a transaction cost;
wherein at least one communicating node of the local area network acts as an electric utility service provider medium to request an energy discharge from a connected electric vehicle;
a user interface configured to select predetermined preferences of the electric vehicle user in response to discharge requests based upon the level of trust of the respective electric vehicle charging equipment;
wherein the communicating electric utility node further transmits electric vehicle discharge session metered transaction value, comprising an electricity amount and a tax credit, to an electric vehicle datalogger and to the electric utility service provider, along with a file comprising the electric vehicle identification number and metered discharge values;
an electric vehicle discharge session transaction reconciliation between one or more electric utility service provider and the vehicle user designated electric utility service provider;
wherein the vehicle user designated electric utility service provider delivers notice to the electric vehicle user comparing the electric vehicle charging equipment meter value transaction costs to the electric vehicle identification number datalogger stored values upon the occurrence of a high trust level charging session;
wherein the vehicle user designated electric utility service provider generates a billing to the electric vehicle user identifying the discharge tax credit against the collection of track distances based on roadway class and waypoint distances usage fees to be assessed during the period ending with the most recent authorized high trust charging session of the electric vehicle user within the vehicle user designated electric utility service provider billing cycle.
67. The system of Implementation 66, wherein the file is an encrypted file.
68. The system of Implementation 66, wherein settlement payments are made or received by or between an authorized third-party processor.
69. The system of Implementation 66, wherein the electric vehicle is a leased vehicle.
70. The system of Implementation 66, wherein the electric vehicle is a hybrid-electric vehicle.
71. The system of Implementation 66, wherein the request for payment for discharge is by an electric utility service provider.
72. A system for assessing electric vehicle usage fees comprising:
an electric vehicle comprising an electric vehicle user interface;
at least one electronic control unit configured to store accessible vehicle and/or vehicle user information and/or credentials;
mapping software configured to distinguish roadway classes;
a navigation system configured to generate tracks attributable to distances traveled over and from trackpoints and distances traveled over waypoints distinguished by roadway class;
a datalogger comprising a receiver, a memory, a report writer and a transmitter; wherein the datalogger receiver is configured to accept vehicle identification information and user payment credentials from one or more electronic control units and vehicle distances and waypoints traveled based on roadway classes from the navigation system;
wherein the datalogger memory temporarily stores information accepted by the datalogger receiver,
wherein the datalogger memory will be cleared upon the successful transmission of a datalogger report to an authorized external node;
wherein the datalogger report writer is configured to create a report from information obtained from the datalogger memory summarizing vehicle identification, user credentials, and distances of tracks and waypoints traveled based on roadway class;
wherein the datalogger transmitter is configured to transmit the datalogger report over an electric vehicle communication bus to a vehicle communications gateway,
wherein the vehicle communications gateway is configured to transmit the report to an authorized remotely located receiver node,
wherein the authorized receiver node is configured to receive the report;
a local area network comprising a plurality of communicating nodes;
wherein the electric vehicle is a communicating node,
wherein an electric utility meter is a communicating node, and
wherein the authorized remotely located receiver node is a communicating node and is configured to communicate with a vehicle user designated electric utility service provider,
wherein the communicating electric utility node is configured to receive the report directly from the electric vehicle and/or indirectly from one or more alternate local area network nodes, and
wherein the report is transmitted to the vehicle user designated electric utility service provider database;
a processor configured to receive the report from the designated electric utility service provider vehicle database and to calculate a usage fee based on roadway class, tracks and waypoints traveled owed to one or more fee collecting jurisdictional authority.
73. The system of Implementation 72, further comprising:
an electric utility service provider billing system configured to assess usage fees from at least one vehicle user,
a further processor configured to receive usage fee information from a plurality of electric utility service providers for settlement between the plurality of electric utility service providers and for preparation of usage fee remittance advice to one or more jurisdictional authority;
74. A method of assessing electric vehicle usage fees comprising:
configuring an electric vehicle user interface of an electric vehicle;
storing accessible vehicle and/or vehicle user information and/or credentials in at least one electronic control unit;
distinguishing roadway classes using mapping software;
generating tracks attributable to distances traveled over and from trackpoints and distances traveled over waypoints distinguished by roadway class with a navigation system; creating a report summarizing vehicle identification, user credentials, and distances of tracks and waypoints traveled based on roadway class;
transmitting the report to a vehicle communications gateway,
wherein the vehicle communications gateway is configured to transmit the report to an authorized remotely located receiver node in a local area network that is configured to receive the report;
transmitting the report to a vehicle user designated utility service provider vehicle database by means of a communicating electric utility local area network node configured to receive the report directly from the electric vehicle and/or indirectly from one or more alternate local area network nodes;
calculating a usage fee owed to one or more fee collecting jurisdictional authority.

### Example 7

Non-limiting implementations are provided as “use cases” in Table 1.

TABLE 1
Use Case 1: HEV Owner Commissions Residential SHEVC as Trusted Level 1; Trust Level 1
Charging also occurs at a remote location (employer site).
Goal in Context: Secure and successful transmission of Hybrid plug-in/Electric Vehicle (“HEV”)
Vehicle Miles Traveled (“VMT”) information to Vehicle Owner's Primary Electric Utility Service
Provider (“VOPEUSP”) via an Advanced Metering Infrastructure (“AMI”) Network, dissemination
of appropriate information to an Authorized Third Party Processing/Settlement/Storage Service
(AT2P3S) via the Cloud (i.e., the internet), and return of VMT billing and settlement values via the
Cloud to the VOPEUSP for inclusion in monthly billing.

| | |
|---|---|
| Scope: | VMT reported through trusted charging sessions. |
| Level: | Trust Level 1 |
| Preconditions: | HEV owner purchases a Smart Hybrid-electric Vehicle Charger (“SHEVC”) that |
| | includes communication capabilities that are interoperable with the VOPEUSP |
| | meter or a VOPEUSP supported Home Area Network (HAN) or Local Area |
| | Network (LAN) |
| Success End | An accurate VMT usage fee billing included within HEV owner's utility bill; |
| Condition: | privacy maintained. |
| Failed End | Inaccurate billing and/or disclosure of confidential information to unauthorized |
| Condition: | recipients. |
| Primary Actors: | HEV Seller, HEV Buyer, HEV, SHEVC, AMI Meter, AMI Network, Han or LAN, |
| | VOPEUSP, Authorized Third Party Processing/Settlement/Storage Service, Taxing |
| | Authorities |
| Trigger: | HEV Charging Session |

MAIN SUCCESS SCENARIO

| 1. | Prior to the purchase or lease of an HEV, the prospective owner or lessee determines that he | | | | | |
|---|---|---|---|---|---|---|
| | or she will also purchase or lease a dedicated SHEVC for the vehicle (or for the premise if | | | | | |
| | more than one owned, leased or authorized HEV will be serviced by the SHEVC). The | | | | | |
| | VOPEUSP that serves the territory where the SHEVC will reside shall be contacted to | | | | | |
| | determine the type of AMI communications technology that has been placed in service | | | | | |
| | within such territory to ensure that the SHEVC will be able to connect to the AMI Network | | | | | |
| | (either directly or indirectly as part of a HAN or a LAN; for purposes of this Use Case, the | | | | | |
| | AMI Network will be defined as including the HAN or LAN node, any SHEVC submeter or | | | | | |
| | the SHEVC as a node itself). The VOPEUSP will specify which manufacturer(s) and | | | | | |
| | respective models of SHEVCs may be purchased (or leased) that have been registered for | | | | | |
| | use in its service territory for the make/model of vehicle that may be prospectively | | | | | |
| | acquired. | | | | | |
| 2. | The prospective HEV owner purchases or leases an HEV that includes an integrated VMT | | | | | |
| | Meter Module that is capable of (a) preparing VMT trip reports/files and (b) further | | | | | |
| | transmitting the reports/files for analysis. | | | | | |
| | During the commissioning process of programming the HEV dashboard/display settings, | | | | | |
| | pre-setting radio stations, etc., the new HEV owner/lessee will establish password | | | | | |
| | credentials and will access a password protected user interface screen to (a) identify his or | | | | | |
| | her VOPEUSP and (b) insert his or her VOPEUSP Account Number (to be used for VMT | | | | | |
| | settlement purposes). | | | | | |
| | Note: | | | | | |
| | For purposes of this Success Scenario, the integrated HEV VMT Meter Module is | | | | | |
| | defined as an Electronic Control Unit (ECU) within the vehicle that accumulates mileage | | | | | |
| | traveled by the vehicle over (A) prescribed roadway classifications (e.g., highways, local | | | | | |
| | roads, private drives, parking lots, etc.) and (B) predefined taxing jurisdictions (e.g., states | | | | | |
| | or local jurisdictions); this information will be accumulated through the VMT Meter | | | | | |
| | Module's access to the vehicle's navigation system. The VMT Meter Module will | | | | | |
| | accumulate the VMT use information in tables which the VMT Meter Module will format | | | | | |
| | into files or reports suitable for transmitting over a utility's AMI network upon the initiation | | | | | |
| | of an authorized charging session. The VMT Meter Module can also be capable of storing | | | | | |
| | sales tax paid information from SHEVC charging sessions that are not authorized a “Trust | | | | | |
| | Level 1 VMT use charge“ session and can also store information relating to the amount of | | | | | |
| | energy transferred in to the vehicle during a TL2 charging session so that billing amounts | | | | | |
| | can be compared for accuracy during the settlement process. A TL3 charging session will | | | | | |
| | be prepaid, so no additional energy billing should be included in the HEV owner's | | | | | |
| | VOPEUSP bill, but TL3 charging session sales tax should be stored for purposes of final | | | | | |
| | VMT settlement. Finally, the VMT Meter Module (or another ECU) can be capable of | | | | | |
| | storing payment information that can be transmitted upon an authorized TL2 or TL3 | | | | | |
| | session. The VMT Meter Module will have access to other of the vehicle's ECUs so that it is | | | | | |
| | able to include certain additional information (other than VMT data) within the HEV trip | | | | | |
| | report (e.g., VIN, certain owner identification information, etc.). The HEV's VMT Meter | | | | | |
| | Module includes communication capabilities that will enable the HEV to (1) connect with | | | | | |
| | an SHEVC or an authorized local area network (either directly or indirectly through a | | | | | |
| | specified communication capability of another of the HEV's available systems, such as the | | | | | |
| | infotainment system) (2) transmit VMT files during an authorized charging session and (3) | | | | | |
| | clear its registers at the conclusion of an authorized charging session/VMT file | | | | | |
| | transmission. | | | | | |
| 3. | In conjunction with the transfer of title or execution of the lease agreement (whether the | | | | | |
| | vehicle is sold/leased by a dealership or the transaction is consummated without the | | | | | |
| | assistance of a dealer), the required Odometer Disclosure Statement (which may be obtained | | | | | |
| | at https://www.dmv.org/odometer-disclosure-statement.php) must also be sent to the | | | | | |
| | VOPEUSP designated by the new HEV owner/lessee. The odometer reading must be | | | | | |
| | associated with the specific Vehicle Identification Number (VIN). Ideally, the VOPEUSP | | | | | |
| | will maintain a web portal capable of accepting Odometer Disclosure Statements, such that | | | | | |
| | the statements can be uploaded and held in a queue and ultimately assigned to a specific | | | | | |
| | customer Account Number once the HEV is registered (step 7 below). The Odometer | | | | | |
| | Disclosure Statement can also be transmitted by the VOPEUSP to its designated AT2P3S | | | | | |
| | for its processing and record retention purposes. | | | | | |
| | Simultaneous with the production of the Odometer Disclosure Statement, a certification | | | | | |
| | should be provided that the VMT Meter Module register has been cleared (i.e., the tax | | | | | |
| | obligation for mileage as of that point in time has been paid or will be paid by the seller). | | | | | |
| 4. | The VOPEUSP (or the AT2P3S (as defined below) that has been engaged to process its | | | | | |
| | filings) notifies the relevant State and/or Local Department(s) of Transportation and taxing | | | | | |
| | authority/authorities that a new VIN Odometer Disclosure Statement has been received | | | | | |
| | and has been attributed to an account in its service territory. As indicated above, this | | | | | |
| | notification can be processed by use of the authorized third party | | | | | |
| | processing/settlement/storage service (the “AT2P3S”). | | | | | |
| 5. | The HEV owner purchases (or leases) an SHEVC that is appropriate for charging the HEV | | | | | |
| | as referenced in step 1, and which contains communication equipment capable of (a) | | | | | |
| | transmitting messages to the HEV and (b) receiving messages, data and/or prepared files | | | | | |
| | from the HEV's VMT Meter Module. Further, the SHEVC will be capable of transmitting | | | | | |
| | files or other information to the VOPEUSP, and capable of receiving requests or other | | | | | |
| | information from the VOPEUSP. | | | | | |
| 6. | Upon installation of the SHEVC, the charger is commissioned for service by (a) | | | | | |
| | establishing a communication path with the VOPEUSP either (i) directly via the SHEVC's | | | | | |
| | internal AMI Meter with integrated communications capabilities or (ii) as a node in a HAN | | | | | |
| | or LAN that relies on a master smart/AMI Meter to relay files and other information; and | | | | | |
| | (b) establishing a communication path with the HEV itself, whether (i) wired through either | | | | | |
| | an Ethernet or CAN bus (or similar) connection (via the charging cable), or (ii) wireless via | | | | | |
| | Bluetooth or WiFi (or similar) connection (which could be necessary especially in the event | | | | | |
| | of an inductive charger or wireless SHEVC). | | | | | |
| 7. | The SHEVC and HEV are registered with the VOPEUSP by contacting the VOPEUSP and | | | | | |
| | specifying the SHEVC Manufacturer and Serial Number of the SHEVC located on the HEV | | | | | |
| | owner's premise and the VIN (or VINs) that will be associated with the HEV owner's | | | | | |
| | VOPEUSP Account Number. Other identifying information may be required at that time, | | | | | |
| | such as an SHEVC specific submeter identification number, an IP address for the SHEVC | | | | | |
| | (if applicable), login credentials, etc., as determined by the VOPEUSP. | | | | | |
| | The registration process will ideally occur through the VOPEUSP's web portal, but can also | | | | | |
| | be accomplished with alternative means (such as a VOPEUSP customer service | | | | | |
| | representative). It is anticipated that a primary email address will be requested of the HEV | | | | | |
| | owner. | | | | | |
| 8. | The HEV engages in its initial charging session with the newly commissioned SHEVC. At | | | | | |
| | this point, a VMT file/report will be requested by the SHEVC of the HEV's VMT Meter | | | | | |
| | Module and the HEV will forward said file to the SHEVC (or to the HAN/LAN or AMI | | | | | |
| | Meter or submeter if the SHEVC is wireless). Upon receipt of the file, the SHEVC will | | | | | |
| | forward the file to the VOPEUSP or, in the case of a wireless SHEVC, the HAN/LAN/AMI | | | | | |
| | Meter or submeter which will then forward the file to the VOPEUSP via an appropriate | | | | | |
| | path. | | | | | |
| | In addition to the VIN and the VOPEUSP identifier, the VMT Meter Module file will | | | | | |
| | contain the mileage driven by roadway classification AND the ending Odometer reading. | | | | | |
| | Ideally, the HEV owner will be logged in to the VOPEUSP's web portal and will monitor | | | | | |
| | his or her account for acknowledgement that the SHEVC has been registered and is | | | | | |
| | communicating with the VOPEUSP. The HEV owner should be able to observe (1) the | | | | | |
| | presence of the mileage reported on the Odometer Disclosure Statement (as the starting | | | | | |
| | point for calculating the VMT charge owed) and (2) the current odometer reading (as | | | | | |
| | transmitted within the report). The portal should also disclose the mileage driven by | | | | | |
| | roadway classification and the total mileage driven for roadway classifications as reported | | | | | |
| | in the registers. | | | | | |
| | In the event that the beginning odometer reading as registered with the VOPEUSP by means | | | | | |
| | of the Odometer Disclosure Statement plus the total mileage driven by roadway | | | | | |
| | classifications does not agree with the ending or current odometer reading, an error message | | | | | |
| | or alert will be triggered. While not specifying the exact cause of the error, the message | | | | | |
| | will nevertheless signal that either (a) the VMT Module is not accurately accumulating | | | | | |
| | mileage by classification or (b) that the registers were not cleared at the time that the title | | | | | |
| | was transferred or the lease was executed. | | | | | |
| | In such event, the VMT charges should be quarantined. The VOPEUSP should either | | | | | |
| | directly, or through the AT2P3S, notify the taxing authorities that an abnormality occurred | | | | | |
| | and a request should be made to obtain a tax clearance certification stating the mileage that | | | | | |
| | had previously been reported to the taxing authorities (including tax exempt mileage). If | | | | | |
| | such reported mileage is considerably less than the Odometer Disclosure Statement, then the | | | | | |
| | taxing authorities should pursue the prior HEV owner to collect any unpaid tax. If the | | | | | |
| | mileage differential is minor, then the HEV should be examined to determine if the VMT | | | | | |
| | Meter Module is malfunctioning (or needs to be adjusted to compensate for potential | | | | | |
| | anomalies, such as a miscalculation due to a mismatched tire size (considered “rounding” | | | | | |
| | errors)). | | | | | |
| | It is possible, perhaps even likely, that the sum of the mileage collected by roadway | | | | | |
| | classification may not agree exactly with the difference between the beginning and ending | | | | | |
| | odometer readings, but the differences should be minimal and largely attributable to | | | | | |
| | rounding errors. Therefore, some allowance should likely be made within the regulations | | | | | |
| | for such possible rounding errors so that alarm events that require tax clearance certificates | | | | | |
| | are minimized. | | | | | |
| 9. | Assuming that the newly commissioned SHEVC has been successful in accessing the VMT | | | | | |
| | report/file from the HEV (or the wireless charging session initiation has caused the HEV to | | | | | |
| | transmit the VMT report/file to an authorized node in the AMI Network), and the VMT | | | | | |
| | report/file has been successfully transmitted to the VOPEUSP, then the HEV Owner should | | | | | |
| | be able to view a summary of his or her VMT mileage in the web portal made available by | | | | | |
| | the VOPEUSP. The personal account on the web portal should present pertinent | | | | | |
| | information, which can include all (or a subset of) the following: | | | | | |
| | VOPEUSP Utility Account Number | | | | | |
| | Vehicle Identification Number associated with Utility Account Number | | | | | |
| | Odometer Reading at time of HEV acquisition (per the Odometer Disclosure | | | | | |
| | Statement) | | | | | |
| | (Ending) Odometer Reading as of the most recent charging session (which, in the | | | | | |
| | case of an initial charge of a newly acquired HEV, should be the same as the | | | | | |
| | odometer reading per the Odometer Disclosure Statement) | | | | | |
| | Mileage driven per (state or other taxing jurisdiction)/per roadway classification | | | | | |
| | since the last charging session (e.g.): | | | | | |
| | MO-Highway Miles | | | | | |
| | MO-Bridge Miles | | | | | |
| | MO-Local Road Miles | | | | | |
| | MO-Private Drive Miles | | | | | |
| | MO-Parking Lot Miles | | | | | |
| | MO-Off-road Miles | | | | | |
| | MO-Etc. Miles | | | | | |
| | Ending Odometer Reading | | | | | |
| | [Other: Prior charging session usage fee?; Prepaid tax credits?; Tax/fees paid to | | | | | |
| | non VOPEUSP taxing jurisdictions, etc.] | | | | | |
| | [Other: V2G discharges and related metrics? Historical cost (by mile; by “taxable” | | | | | |
| | mile, etc.) metrics? Other analytics/metrics?] | | | | | |
| | While the VMT usage fee amounts can be prepared by the VOPEUSP and immediately | | | | | |
| | disclosed on the web portal, it is expected that the tax calculation and settlement process | | | | | |
| | will entail the use of an AT2P3S. This expectation is driven by the anticipated complexity | | | | | |
| | that will be associated with calculating usage fees for VMT across multiple taxing | | | | | |
| | jurisdictions and the settlement process that can potentially include credits for payments | | | | | |
| | made during charging sessions outside of the VOPEUSP territory or during Trust Level 2 or | | | | | |
| | lower sessions. | | | | | |
| | Therefore, it is anticipated that Step 9 involves transmitting the VMT file information to an | | | | | |
| | AT2P3S so that further analyses can be performed. | | | | | |
| 10. | The AT2P3S will have previously established an agreement with the VOPEUSP to | | | | | |
| | protect and treat confidentially information received from the VOPEUSP. | | | | | |
| | The AT2P3S will establish a database that is maintained on the basis of the HEV | | | | | |
| | VIN. Each VIN will be associated with the HEV's VOPEUSP by the VOPEUSP | | | | | |
| | designator and the HEV owner's VOPEUSP Account Number. No other personal | | | | | |
| | information relative to the HEV owner will be collected by the AT2P3S. The | | | | | |
| | VOPEUSP designator will be determined by the Public Utility Commission that | | | | | |
| | maintains oversight of the utility. | | | | | |
| | The AT2P3S will parse the information included in each VMT report received | | | | | |
| | relative to each VIN, and will calculate VMT taxes and/or fees based upon the rules | | | | | |
| | established by each relevant taxing authority where the HEV has logged VMT. | | | | | |
| | This will require that AT2P3S continually update its tax or fee schedules for each | | | | | |
| | tax jurisdiction in the contiguous United States and, to the extent that tax or fee | | | | | |
| | treaties are ratified with contiguous countries, then the AT2P3S can be required to | | | | | |
| | maintain respective tax/fee schedules for those sovereignties as well. | | | | | |
| | AT2P3S will calculate the taxes or fees that are due and payable to each appropriate | | | | | |
| | jurisdiction. | | | | | |
| | It can be important, legislatively, to ensure that AT2P3S's interface with each other | | | | | |
| | to, at a minimum, share information relative to VINs that are (a) registered or (b) | | | | | |
| | engage in charging sessions “within the VOPEUSP territories for which they are | | | | | |
| | engaged to process and store information”. | | | | | |
| | For example, there should not be duplicates of the same VIN throughout the North | | | | | |
| | American continent. If that occurs, then fraud is being perpetrated and an | | | | | |
| | investigation should ensue. | | | | | |
| | Separately, if an HEV owner determines that he or she would prefer to engage in a | | | | | |
| | TL1 charging session not only at home but, also, at the HEV owner's place of | | | | | |
| | employment then care must be taken to ensure that there is no duplication of VMT | | | | | |
| | taxes or fees charged. Should the HEV owner designate the employer's SHEVC as | | | | | |
| | a Trust Level 1 or 2 SHEVC, then usage fees should be determined on the basis of | | | | | |
| | taxable VMT and such charges should be included in the HEV owner's periodic | | | | | |
| | utility bill received from the VOPEUSP. | | | | | |
| | In the event that the HEV owner lives in an area where the VOPEUSP is being | | | | | |
| | serviced by an AT2P3S that is separate and distinct from the AT2P3S that services | | | | | |
| | the HEV owner's employer's primary utility, then the two AT2P3S's need to | | | | | |
| | communicate so that appropriate charges can be included in the HEV owner's | | | | | |
| | periodic billing. | | | | | |
| | It is also anticipated that the AT2P3S's will perform analytics to effectively “net” | | | | | |
| | the settlement payments that VOPEUSPs would make to each other. | | | | | |
| | For example, assume that there are only two HEVs in existence, each with a | | | | | |
| | different VOPEUSP that supports its respective residential Trust Level 1 SHEVC | | | | | |
| | and each that has an employer in the opposite HEV owner's VOPEUSP territory. | | | | | |
| | Each HEV owner identifies its employer as a Trust Level 1 SHEVC location. | | | | | |
| | Assume the following facts: | | | | | |
| | | | VOPEUSP 1 | VOPEUSP 2 | Totals | |
| | HEV 1 Mileage | | 100 | 75 | 175 | |
| | HEV 2 Mileage | | 150 | 90 | 240 | |
| | Use Tax @ $0.06 | HEV 1 | 6.00 | | Owed to | VOPEUSP 1 |
| | per mile | | | | | |
| | | HEV 2 | 9.00 | | Owed to | VOPEUSP 2 |
| | Use Tax @ $0.07 | HEV 1 | | 5.25 | Owed to | VOPEUSP 1 |
| | per mile | | | | | |
| | | HEV 2 | | 6.30 | Owed to | VOPEUSP 2 |
| | Total owed to | | 15.00 | | | |
| | Tax Authority 1 | | | | | |
| | Total owed to | | | 11.55 | | |
| | Tax Authority 2 | | | | | |

| | |
|---|---|
| | In this example, HEV Owner 1 would owe tax of ($6.00 + $5.25) $11.25 for |
| | mileage driven during the trip, and those charges would be reflected on his or her |
| | periodic (e.g., month end) bill. HEV Owner 2 would owe ($9.00 + 6.30) $15.30 for |
| | the same period. |
| | VOPEUSP 1 would collect $11.25 of tax from HEV Owner 1. $6.00 of that tax |
| | would need to be sent to Tax Authority 1, and $5.25 of that tax would need to be |
| | paid to Tax Authority 2. Similarly, VOPEUSP 2 would collect $15.30 from HEV |
| | Owner 2. $9.00 of that tax would need to be sent to Tax Authority 1 and $6.30 |
| | would need to be sent to Tax Authority 2. |
| | With this limited number of HEVs, it wouldn't seem to be too much of a burden to |
| | have each VOPEUSP remit the tax collected to the appropriate tax authority without |
| | the assistance of an AT2P3S. However, if you extend the population of Tax |
| | Authorities to 50 states and 1 Federal Government (and possibly the District of |
| | Columbia), and to Canada and Mexico, in theory every VOPEUSP could be |
| | obligated to make monthly remittances to over 50 separate and distinct taxing |
| | authorities. |
| | The recommended approach will be for the AT2P3S's to perform the remittance |
| | services (analysis, assessment, settlement and collection and payment) between and |
| | on behalf of VOPEUSP's under contract. If a single AT2P3S is representing both |
| | VOPEUSP 1 and VOPEUSP 2, then each of the VOPEUSPs will forward the taxes |
| | collected to the AT2P3S. The $11.25 collected from VOPEUSP 1 and the $15.30 |
| | collected from VOPEUSP 2 will be remitted to Tax Authority 1 in the amount of |
| | $15.00 (less an authorized processing fee) and to Tax Authority 2 in the amount of |
| | $11.55 (less an authorized processing fee). The VIN numbers and associated |
| | mileage (taxable and non-taxable) will be included in the report to the taxing |
| | authorities in support of the amounts remitted. |
| | The AT2P3S will transmit a file/report for the benefit of the VINs to each |
| | respective VOPEUSP so that the web portal can be updated to reflect the tax |
| | payments made and the settlement of those taxes. |
| | In this example, if separate AT2P3S's represent the two VOPEUSP, the settlement |
| | can still occur at the AT2P3S level, and the VOPEUSPs would not be troubled with |
| | the tax authority reporting aspects. |
| 11. | As described in Step 10 above, it is anticipated that the usage fee charges for VMT traveled |
| | by an HEV will be calculated by an AT2P3S provider, on an individual basis, well before |
| | any netting process is initiated. |
| | The AT2P3S will submit its calculations (on the basis of the VIN) to the VOPEUSP who |
| | will, in turn, assign the calculations to the HEV owner's account. |
| | Thus, the HEV owner will receive a periodic billing that includes VMT usage fee charges. |
| | Summary |
| | There are many benefits to the Actors from the proposed approach: |
| | The HEV Owner |
| | pays in one implementation(s) only for the use of taxable roadways (not |
| | private drives, parking lots, off-road usage); |
| | provides an automated system so periodic manual reports are not |
| | necessarily required; and |
| | pays in one implementation(s) only after the fact (as opposed to an upfront |
| | sales tax) in the case of TL1 or TL2 charging (but in advance if TL3 |
| | charging). |
| | The VOPEUSP |
| | has further visibility into the load that is on its network, along with the |
| | potential for V2G discharge should the need arise. |
| | The value of its AMI Network is further enhanced, making further |
| | investments in such infrastructure even more palatable to the PUC. |
| | There is the potential that the utility could receive a fee from the taxing |
| | authorities for reimbursement of costs incurred to implement an HEV |
| | information portal, etc. |
| | The use of third party settlement services would relieve a potentially |
| | onerous administrative burden. |
| | The AT2P3S |
| | Sustains a business model: Receives compensation from the tax authorities |
| | to administer the tax collection/settlement/reporting and remittance |
| | functions. |
| | Opportunities for additional service revenues may exist (e.g., can support |
| | the VMT tax clearance process, especially for used HEVs) |
| | Can provide assistance to auditing process |
| | Taxing Authorities |
| | Introduces an automated approach to ensure that HEVs pay their fair share |
| | into roadway construction and maintenance funds |
| | Provides a method to allocate funds based on miles traveled within specific |
| | jurisdictions |
| | O Provides a mechanism to establish higher rates for higher maintenance |
| | roadway classifications (e.g., bridges, dams, tunnels). |

Use Case 2: HEV Owner Commissions Residential SHEVC as Trusted Level 1; Trust Level 2
Charging occurs at a remote/third party utility location (site not specified).
Goal in Context: Secure and successful transmission of Hybrid plug-in/Electric Vehicle (“HEV”)
Vehicle Miles Traveled (“VMT”) information to Vehicle Owner's Primary Electric Utility Service
Provider (“VOPEUSP”) during a Trust Level 1 charging session via an Advanced Metering
Infrastructure (“AMI”) Network, billing of an energy purchase and a related sales tax during a
Trust Level 2 charging session through a third party utility's AMI Network, dissemination of
appropriate information by each of the VOPEUSP and the third party utility to an Authorized Third
Party Processing/Settlement/Storage Service (AT2P3S) via the Cloud (i.e., the internet), and return
of VMT billing and settlement values (including billings for “out of network” charges for energy)
via the Cloud to the VOPEUSP for inclusion in periodic billing.

| | |
|---|---|
| Scope: | Energy transference and sales tax charged (which will be credited against usage fee) for |
| | energy transferred during Trust Level 2 charging session, and VMT subsequently |
| | reported for settlement through Trusted Level 1 charging session. |
| Level: | Trust Levels 1 & 2 |
| Preconditions: | HEV Owner (Buyer) purchases or leases an SHEVC as described in Use Case 1; also, |
| | HEV Owner travels to areas where recharging can be necessary but HEV owner is |
| | concerned about security of transmitting roadway classifications traveled (which can |
| | contain waypoints, such as bridges) over the available SHEVCs. Therefore, HEV |
| | owner is willing to pay sales tax upfront. |
| Success End | An accurate VMT usage fee billing (with credit for sales tax charges) included within |
| Condition: | HEV owner's utility bill; privacy maintained. |
| Failed End | Inaccurate billing and/or disclosure of confidential information to unauthorized |
| Condition: | recipients. |
| Primary | HEV Seller, HEV Buyer, HEV, Trust Level 1 SHEVC, Trust Level 2 SHEVC, AMI |
| Actors: | Meter, AMI Network, Han or LAN, VOPEUSP, Third Party Utility, Authorized Third |
| | Party Processing/Settlement/Storage Service (AT2P3S), Taxing Authorities |
| Trigger: | Trust Level 2 HEV Charging Session followed by Trust Level 1 HEV Charging |
| | Session |

MAIN SUCCESS SCENARIO

| 1. | Prior to the purchase or lease of an HEV, the prospective owner or lessee determines | | | |
|---|---|---|---|---|
| | that he or she will also purchase or lease a dedicated SHEVC for the vehicle (or for the | | | |
| | premise if more than one owned, leased or authorized HEV will be serviced by the | | | |
| | SHEVC). The VOPEUSP that serves the territory where the SHEVC will reside shall | | | |
| | be contacted to determine the type of AMI communications technology that has been | | | |
| | placed in service within such territory to ensure that the SHEVC will be able to connect | | | |
| | to the AMI Network (either directly or indirectly as part of a HAN or a LAN; for | | | |
| | purposes of this Use Case, the AMI Network will be defined as including the HAN or | | | |
| | LAN node, any SHEVC submeter or the SHEVC as a node itself). The VOPEUSP will | | | |
| | specify which manufacturer(s) and respective models of SHEVCs may be purchased | | | |
| | (or leased) that have been registered for use in its service territory for the make/model | | | |
| | of vehicle that may be prospectively acquired. | | | |
| 2. | The prospective HEV owner purchases or leases an HEV that includes an integrated | | | |
| | VMT Meter Module that is capable of (a) preparing VMT trip reports/files and (b) | | | |
| | further transmitting the reports/files for analysis. | | | |
| | During the commissioning process of programming the HEV dashboard/display | | | |
| | settings, pre-setting radio stations, etc., the new HEV owner/lessee will establish | | | |
| | password credentials and will access a password protected user interface screen to (a) | | | |
| | identify his or her VOPEUSP and (b) insert his or her VOPEUSP Account Number (to | | | |
| | be used for VMT settlement purposes). | | | |
| | Note: | | | |
| | For purposes of this Success Scenario, the integrated HEV VMT Meter Module is | | | |
| | defined as an Electronic Control Unit (ECU) within the vehicle that accumulates | | | |
| | mileage traveled by the vehicle over (A) prescribed roadway classifications (e.g., | | | |
| | highways, local roads, private drives, parking lots, etc.) and (B) predefined taxing | | | |
| | jurisdictions (e.g., states or local jurisdictions); this information will be accumulated | | | |
| | through the VMT Meter Module's access to the vehicle's navigation system. The VMT | | | |
| | Meter Module will accumulate the VMT use information in tables which the VMT | | | |
| | Meter Module will format into files or reports suitable for transmitting over a utility's | | | |
| | AMI network upon the initiation of an authorized charging session. The VMT Meter | | | |
| | Module can also be capable of storing sales tax paid information from SHEVC | | | |
| | charging sessions that are not authorized a “Trust Level 1 VMT use charge” session | | | |
| | and can also store information relating to the amount of energy transferred in to the | | | |
| | vehicle during a TL2 charging session so that billing amounts can be compared for | | | |
| | accuracy during the settlement process. A TL3 charging session will be prepaid, so no | | | |
| | additional energy billing should be included in the HEV owner's VOPEUSP bill, but | | | |
| | TL3 charging session sales tax should be stored for purposes of final VMT settlement. | | | |
| | Finally, the VMT Meter Module (or another ECU) can be capable of storing payment | | | |
| | information that can be transmitted upon an authorized TL2 or TL3 session. The VMT | | | |
| | Meter Module will have access to other of the vehicle's ECUs so that it is able to | | | |
| | include certain additional information (other than VMT data) within the HEV trip | | | |
| | report (e.g., VIN, certain owner identification information, etc.). The HEV's VMT | | | |
| | Meter Module includes communication capabilities that will enable the HEV to (1) | | | |
| | connect with an SHEVC or an authorized local area network (either directly or | | | |
| | indirectly through a specified communication capability of another of the HEV's | | | |
| | available systems, such as the infotainment system) (2) transmit VMT files during an | | | |
| | authorized charging session and (3) clear its registers at the conclusion of an | | | |
| | authorized charging session/VMT file transmission. | | | |
| 3 | In conjunction with the transfer of title or execution of the lease agreement (whether | | | |
| | the vehicle is sold/leased by a dealership or the transaction is consummated without | | | |
| | the assistance of a dealer), the required Odometer Disclosure Statement (which may be | | | |
| | obtained at https://www.dmv.org/odometer-disclosure-statement.php) must also be sent | | | |
| | to the VOPEUSP designated by the new HEV owner/lessee. The odometer reading | | | |
| | must be associated with the specific Vehicle Identification Number (VIN). Ideally, the | | | |
| | VOPEUSP will maintain a web portal capable of accepting Odometer Disclosure | | | |
| | Statements, such that the statements can be uploaded and held in a queue and | | | |
| | ultimately assigned to a specific customer Account Number once the HEV is registered | | | |
| | (step 7 below). The Odometer Disclosure Statement can also be transmitted by the | | | |
| | VOPEUSP to its designated AT2P3S for its processing and record retention purposes. | | | |
| | Simultaneous with the production of the Odometer Disclosure Statement, a certification | | | |
| | should be provided that the VMT Meter Module register has been cleared (i.e., the tax | | | |
| | obligation for mileage as of that point in time has been paid or will be paid by the | | | |
| | seller). | | | |
| 4. | The VOPEUSP (or the AT2P3S (as defined below) that has been engaged to process its | | | |
| | filings) notifies the relevant State and/or Local Department(s) of Transportation and | | | |
| | taxing authority/authorities that a new VIN Odometer Disclosure Statement has been | | | |
| | received and has been attributed to an account in its service territory. As indicated | | | |
| | above, this notification can be processed by use of the authorized third party | | | |
| | processing/settlement/storage service (the “AT2P3S”). | | | |
| 5. | The HEV owner purchases (or leases) an SHEVC that is appropriate for charging the | | | |
| | HEV as referenced in step 1, and which contains communication equipment capable of | | | |
| | (a) transmitting messages to the HEV and (b) receiving messages, data and/or prepared | | | |
| | files from the HEV's VMT Meter Module. Further, the SHEVC will be capable of | | | |
| | transmitting files or other information to the VOPEUSP, and capable of receiving | | | |
| | requests or other information from the VOPEUSP. | | | |
| 6. | Upon installation of the SHEVC, the charger is commissioned for service by (a) | | | |
| | establishing a communication path with the VOPEUSP either (i) directly via the | | | |
| | SHEVC's internal AMI Meter with integrated communications capabilities or (ii) as a | | | |
| | node in a HAN or LAN that relies on a master smart/AMI Meter to relay files and | | | |
| | other information; and (b) establishing a communication path with the HEV itself, | | | |
| | whether (i) wired through either an Ethernet or CAN bus (or similar) connection (via | | | |
| | the charging cable), or (ii) wireless via Bluetooth or WiFi (or similar) connection | | | |
| | (which could be necessary especially in the event of an inductive charger or wireless | | | |
| | SHEVC). | | | |
| 7. | The SHEVC and HEV are registered with the VOPEUSP by contacting the VOPEUSP | | | |
| | and specifying the SHEVC Manufacturer and Serial Number of the SHEVC located on | | | |
| | the HEV owner's premise and the VIN (or VINs) that will be associated with the HEV | | | |
| | owner's VOPEUSP Account Number. Other identifying information can be required at | | | |
| | that time, such as an SHEVC specific submeter identification number, an IP address for | | | |
| | the SHEVC (if applicable), login credentials, etc., as determined by the VOPEUSP. | | | |
| | The registration process will ideally occur through the VOPEUSP's web portal, but can | | | |
| | also be accomplished with alternative means (such as a VOPEUSP customer service | | | |
| | representative). It is anticipated that a primary email address will be requested of the | | | |
| | HEV owner. | | | |
| 8. | The HEV engages in its initial charging session with the newly commissioned SHEVC. | | | |
| | At this point, a VMT file/report will be requested by the SHEVC of the HEV's VMT | | | |
| | Meter Module and the HEV will forward said file to the SHEVC (or to the HAN/LAN | | | |
| | or AMI Meter or submeter if the SHEVC is wireless). Upon receipt of the file, the | | | |
| | SHEVC will forward the file to the VOPEUSP or, in the case of a wireless SHEVC, the | | | |
| | HAN/LAN/AMI Meter or submeter which will then forward the file to the VOPEUSP | | | |
| | via an appropriate path. | | | |
| | In addition to the VIN and the VOPEUSP identifier, the VMT Meter Module file will | | | |
| | contain the mileage driven by roadway classification AND the ending Odometer | | | |
| | reading. | | | |
| | Ideally, the HEV owner will be logged in to the VOPEUSP's web portal and will | | | |
| | monitor his or her account for acknowledgement that the SHEVC has been registered | | | |
| | and is communicating with the VOPEUSP. The HEV owner should be able to observe | | | |
| | (1) the presence of the mileage reported on the Odometer Disclosure Statement (as the | | | |
| | starting point for calculating the VMT charge owed) and (2) the current odometer | | | |
| | reading (as transmitted within the report). The portal should also disclose the mileage | | | |
| | driven by roadway classification and the total mileage driven for roadway | | | |
| | classifications as reported in the registers. | | | |
| | In the event that the beginning odometer reading as registered with the VOPEUSP by | | | |
| | means of the Odometer Disclosure Statement plus the total mileage driven by roadway | | | |
| | classifications does not agree with the ending or current odometer reading, an error | | | |
| | message or alert will be triggered. While not specifying the exact cause of the error, | | | |
| | the message will nevertheless signal that either (a) the VMT Module is not accurately | | | |
| | accumulating mileage by classification or (b) that the registers were not cleared at the | | | |
| | time that the title was transferred or the lease was executed. | | | |
| | In such event , the VMT charges should be quarantined . The VOPEUSP should either | | | |
| | directly, or through the AT2P3S, notify the taxing authorities that an abnormality | | | |
| | occurred and a request should be made to obtain a tax clearance certification stating the | | | |
| | mileage that had previously been reported to the taxing authorities (including tax | | | |
| | exempt mileage). If such reported mileage is considerably less than the Odometer | | | |
| | Disclosure Statement, then the taxing authorities should pursue the prior HEV owner to | | | |
| | collect any unpaid tax. If the mileage differential is minor, then the HEV should be | | | |
| | examined to determine if the VMT Meter Module is malfunctioning (or needs to be | | | |
| | adjusted to compensate for potential anomalies, such as a miscalculation due to a | | | |
| | mismatched tire size (considered “rounding” errors)). | | | |
| | It is possible, perhaps even likely, that the sum of the mileage collected by roadway | | | |
| | classification may not agree exactly with the difference between the beginning and | | | |
| | ending odometer readings, but the differences should be minimal and largely | | | |
| | attributable to rounding errors. Therefore, some allowance should likely be made | | | |
| | within the regulations for such possible rounding errors so that alarm events that | | | |
| | require tax clearance certificates are minimized. | | | |
| 9. | Assuming that the newly commissioned SHEVC has been successful in accessing the | | | |
| | VMT report/file from the HEV (or the wireless charging session initiation has caused | | | |
| | the HEV to transmit the VMT report/file to an authorized node in the AMI Network), | | | |
| | and the VMT report/file has been successfully transmitted to the VOPEUSP, then the | | | |
| | HEV Owner should be able to view a summary of his or her VMT mileage in the web | | | |
| | portal made available by the VOPEUSP. The personal account on the web portal | | | |
| | should present pertinent information, which can include all (or a subset of) the | | | |
| | following: | | | |
| | VOPEUSP Utility Account Number | | | |
| | Vehicle Identification Number associated with Utility Account Number | | | |
| | Odometer Reading at time of HEV acquisition (per the Odometer Disclosure | | | |
| | Statement) | | | |
| | (Ending) Odometer Reading as of the most recent charging session (which, in | | | |
| | the case of an initial charge of a newly acquired HEV, should be the same as | | | |
| | the odometer reading per the Odometer Disclosure Statement) | | | |
| | Mileage driven per (state or other taxing jurisdiction)/per roadway | | | |
| | classification since the last charging session (e.g.): | | | |
| | MO-Highway Miles | | | |
| | MO-Bridge Miles | | | |
| | MO-Local Road Miles | | | |
| | MO-Private Drive Miles | | | |
| | MO-Parking Lot Miles | | | |
| | MO-Off-road Miles | | | |
| | MO-Etc. Miles | | | |
| | IL-Highway Miles | | | |
| | IL-Bridge Miles | | | |
| | IL-Local Road Miles | | | |
| | IL-Private Drive Miles | | | |
| | IL-Parking Lot Miles | | | |
| | Ending Odometer Reading | | | |
| | [Other: Prior charging session usage fee?; Prepaid tax credits?; Tax/fees paid | | | |
| | to non VOPEUSP taxing jurisdictions, etc.] | | | |
| | [Other: V2G discharges and related metrics? Historical cost (by mile; by | | | |
| | “taxable” mile, etc.) metrics? Other analytics/metrics?] | | | |
| | While the VMT usage fees amounts can be prepared by the VOPEUSP and | | | |
| | immediately disclosed on the web portal, it is expected that the tax calculation and | | | |
| | settlement process will entail the use of an AT2P3S. This expectation is driven by the | | | |
| | anticipated complexity that will be associated with calculating usage fees for VMT | | | |
| | across multiple taxing jurisdictions and the settlement process that can potentially | | | |
| | include credits for payments made during charging sessions outside of the VOPEUSP | | | |
| | territory or during Trust Level 2 or lower sessions. | | | |
| | Therefore, it is anticipated that Step 9 involves transmitting the VMT file information | | | |
| | to an AT2P3S so that further analyses can be performed. | | | |
| 10. | For purposes of this use case, the HEV owner will travel such that the HEV will need | | | |
| | to be charged in a location that the owner does not have a high level of trust in terms of | | | |
| | sharing waypoint information, or the HEV owner is visiting a friend or relative but | | | |
| | does not want to designate their SHEVC as a TL1 SHEVC. In this case, the HEV | | | |
| | owner is willing to share enough information such that an immediate payment for | | | |
| | transferred energy (i.e., with a debit or credit card) is not required, but rather, is | | | |
| | deferred until the HEV owner receives his or her periodic utility bill from his or her | | | |
| | VOPEUSP. | | | |
| | In this case, the HEV owner would engage in a charging session with the SHEVC by | | | |
| | designating the SHEVC as a Trust Level 2 SHEVC, and the SHEVC (and possibly the | | | |
| | HEV's VMT Meter Module) would meter the energy transferred during the charging | | | |
| | session. The SHEVC would collect the VIN number and the VOPEUSP identifier/ | | | |
| | designator (at a minimum), and perhaps the HEV owner's VOPEUSP Account Number | | | |
| | or other information to ensure the integrity of the individual account to be billed. The | | | |
| | VOPEUSP designator will be determined by the Public Utility Commission that | | | |
| | maintains oversight of the utility. | | | |
| | At the conclusion of the charging session, the Trust Level 2 SHEVC will communicate | | | |
| | with the HEV's VMT Meter Module and transmit (for storage), at a minimum, the | | | |
| | following data: | | | |
| | The VOPEUSP designator for the TL2 SHEVC | | | |
| | The amount of the energy transmitted (e.g., in watt-hours) | | | |
| | The amount of money that will be billed for the energy transmitted | | | |
| | A sales tax (which can reflect a percentage that is substantially higher than the | | | |
| | average usage fee charged on taxable VMT so as to ensure that there is an | | | |
| | incentive to engage in a TL1 settlement charging session) | | | |
| | The TL2 SHEVC will also transmit the energy consumption, billing amount and sales | | | |
| | tax amount to the TL2 SHEVC's VOPEUSP. This VOPEUSP will forward the billing | | | |
| | information along to its AT2P3S (see below) so that a settlement process can be | | | |
| | initiated with the HEV owner's specified VOPEUSP. | | | |
| | Upon a subsequent HEV TL1 charging session, the HEV will transmit its stored | | | |
| | information regarding the TL2 charging session from the HEV VMT Meter Module | | | |
| | memory to the TL1 SHEVC, which will transmit the information to the HEV owner's | | | |
| | VOPEUSP, which will further transmit the data to the HEV owner's VOPEUSP's | | | |
| | AT2P3S. | | | |
| | The HEV owner's VOPEUSP's AT2P3S will compare the HEV VMT Meter Module | | | |
| | data received from the HEV Owner's VMT Meter Module to the data received from the | | | |
| | TL2 SHEVC's VOPEUSP's AT2P3S relative to the TL2 charging session (that is, such | | | |
| | data can be received either directly or from a separate AT2P3S). Assuming that the | | | |
| | data agrees, then the AT2P3S will facilitate a settlement process, whereby the utility | | | |
| | account of the TL2 SHEVC owner will be credited for the energy consumed and the | | | |
| | related tax. Further, the utility account of the HEV owner will be debited to include the | | | |
| | value of the energy transference, and the sale tax will also be added to the account (but | | | |
| | will be used as a credit to offset the usage fee owed for taxable VMT traveled between | | | |
| | the last and current TL1 charging sessions). | | | |
| 11. | The AT2P3S will have previously established an agreement with the VOPEUSP to | | | |
| | protect and treat confidentially information received from the VOPEUSP. | | | |
| | The AT2P3S will establish a database that is maintained on the basis of the HEV VIN. | | | |
| | Each VIN will be associated with the HEV's VOPEUSP by the VOPEUSP designator | | | |
| | and the HEV owner's VOPEUSP Account Number. No other personal information | | | |
| | relative to the HEV owner will be collected by the AT2P3S. The VOPEUSP | | | |
| | designator will be determined by the Public Utility Commission that maintains | | | |
| | oversight of the utility. | | | |
| | The AT2P3S will parse the information included in each VMT report received relative | | | |
| | to each VIN, and will calculate VMT usage fees based upon the rules established by | | | |
| | each relevant taxing authority where the HEV has logged VMT. This will require the | | | |
| | AT2P3S to continually update its tax or fee schedules for each tax jurisdiction in the | | | |
| | contiguous United States and, to the extent that tax or fee treaties are ratified with | | | |
| | contiguous countries, then the AT2P3S can be required to maintain respective tax/fee | | | |
| | schedules for those sovereignties as well. | | | |
| | The AT2P3S will calculate the taxes or fees that are due and payable to each | | | |
| | appropriate jurisdiction. | | | |
| | It can be important, legislatively, to ensure that AT2P3S's interface with each other to, | | | |
| | at a minimum, share information relative to VINs that are (a) registered or (b) engage | | | |
| | in charging sessions “within the VOPEUSP territories for which they are engaged to | | | |
| | process and store information“. | | | |
| | For example, there should not be duplicates of the same VIN throughout the North | | | |
| | American continent. If that occurs, then fraud is being perpetrated and an investigation | | | |
| | should ensue. | | | |
| | Separately, if an HEV owner determines that he or she would prefer to engage in a TL1 | | | |
| | charging session not only at home but, also, at the HEV owner's place of employment | | | |
| | then care must be taken to ensure that there is no duplication of VMT taxes or fees | | | |
| | charged. Should the HEV owner designate the employer's SHEVC as a Trust Level 1 | | | |
| | SHEVC, then usage fees should be determined on the basis of taxable VMT and such | | | |
| | usage fee charges should be passed along from the TL1 SHEVC to the employer's | | | |
| | VOPEUSP (and through appropriate AT2P3S's) to the HEV owner's VOPEUSP | | | |
| | (which can or can not be the same as the employer's VOPEUSP) and included in the | | | |
| | HEV owner's periodic utility bill received from his or her VOPEUSP. | | | |
| | In the event that the HEV owner lives in an area where the VOPEUSP is being serviced | | | |
| | by an AT2P3S that is separate and distinct from the AT2P3S that services the HEV | | | |
| | owner's employer's primary utility, then the two AT2P3S's need to communicate so | | | |
| | that appropriate charges can be included in the HEV owner's periodic billing. | | | |
| | It is also anticipated that the AT2P3S's will perform analytics to effectively “net” the | | | |
| | settlement payments that VOPEUSPs can be required to make to each other (see Use | | | |
| | Case # 5). | | | |
| | For example, assume that an HEV travels outside of its VOPEUSP to visit a friend or | | | |
| | family member. During the trip, the HEV owner will need to recharge the vehicle | | | |
| | battery, but does not want to designate the available charging unit as a Trust Level 1 | | | |
| | charger. The available charger does not have debit or credit card payment options | | | |
| | available, and so the HEV owner decides to engage in a Trust Level 2 charging session. | | | |
| | Assume that there is a single AT2P3S with responsibility for both utility service | | | |
| | territories, in addition to the following facts: | | | |
| | | | Taxable VMT Driven in Territory of | |
| | | | VOPEUSP 1 | Other Utility (OU) |
| | HEV 1 Mileage | | 120 | 75 |
| | Use Tax @ $0.06 per mile | | $7.20 | |
| | Electricity Purchased via | | | $20.00 |
| | TL2 charge session | | | |
| | Sales Tax @ | 30% | | $6.00 |
| | Use Tax @ $0.07 per mile | | | $5.25 |
| | Total owed to Tax Authority 1 | | 7.20 | |
| | Total owed to Tax Authority 2 | | | 5.25 |

| | |
|---|---|
| | In this example, the HEV Owner would owe tax of ($7.20 + $5.25) $12.45 for mileage |
| | driven during the trip, and those charges would be reflected on his or her periodic (e.g., |
| | month end) bill. Also, the electricity purchase of $20.00 from the Other Utility (“OU”) |
| | will be charged though the HEV owners periodic bill. |
| | The AT2P3S will receive information from the OU SHEVC relating to the HEV |
| | charging session attributable to the VIN, nad will compare that VIN data to the |
| | information collected from the HEV's VOPEUSP once a Trust Level 1 charging |
| | session is initiated. Assuming the two sources agree (i.e., the HEV purchased $20.00 |
| | of electricity and a sales tax of $6.00 is owed on that purchase), the AT2P3S will |
| | calculate a settlement transaction between the utilities. |
| | [Note, the $6.00 sales tax calculation would only become a factor if the vehicle were |
| | permanently disabled (e.g., as in an accident) such that TI.1 charging session were |
| | not subsequently engaged, or a year end safety inspection whereupo on Odometer |
| | reading audit process is engaged. If it is determined that HEV owner has not engaged |
| | in a TL1 charging session and has not paid the tax due in frequent intervals, a higher |
| | rate sales tax can be applied as opposed to a usage fee, or other penalties can be |
| | imposed.] |
| | In this use case, VOPEUSP 1 would collect $12.45 of tax and $20.00 in OU electricity |
| | purchases from the HEV Owner. The VOPEUSP 1 would need to send $7.20 to Tax |
| | Authority 1 (if not processed by the AT2P3S on behalf of the VOPEUSP), and $5.25 of |
| | that tax would need to be paid to OU which in turn will forward to Tax Authority 2 |
| | (unless the AT2P3S pays to the taxing authority on behalf of OU). Similarly, |
| | VOPEUSP 1 would transmit $20.00 to OU upon receipt of payment from the HEV |
| | owner. |
| | The VMT system would anticipate, however, that there can be HEV owners from OU's |
| | territory that would engage in TL2 charging sessions within the VOPEUSP 1 territory; |
| | and so electricity purchase settlements are expected to flow in the opposite direction as |
| | well. Therefore, the AT2P3S would determine the net amount required to be |
| | transferred between the utilities so that a separate transfer would not be required for |
| | every single transaction. The AT2P3S would offset the accumulated transactions |
| | during a period to achieve a single payment from one utility to another during each |
| | specified period. Also, the AT2P3S would provide instructions to the utilities with |
| | respect to each individual VIN related account relative to the settlement process. |
| | Again, if you extend the population of Tax Authorities to 50 states and 1 Federal |
| | Government (and possibly the District of Columbia), and to Canada and Mexico, in |
| | theory-absent the services of the AT2P3S's-every VOPEUSP could be obligated to |
| | make monthly remittances to over 50 separate and distinct taxing authorities. |
| | The recommended approach will be for the AT2P3S's to perform the remittance |
| | services (analysis, assessment, settlement and collection and payment) between and on |
| | behalf of VOPEUSP's under contract. If a single AT2P3S is representing both utilities, |
| | then each of the utilities will forward the taxes collected to the AT2P3S. The $12.45 |
| | collected by VOPEUSP 1 will be remitted to the respective tax authorities through the |
| | respective AT2P3S's (less an authorized processing fee). The VIN numbers and |
| | associated mileage (taxable and non-taxable) will be included in the report to the taxing |
| | authorities in support of the amounts remitted. |
| | The AT2P3S will transmit a file/report for the benefit of the VINs to each respective |
| | VOPEUSP or OU so that the respective web portal (or data base in the case of an OU) |
| | can be updated to reflect the tax payments made and the settlement of those taxes. |
| | In this example, if separate AT2P3S's represent the two VOPEUSP, the settlement can |
| | still occur at the AT2P3S level, and the VOPEUSPs would not be troubled with the tax |
| | authority reporting aspects. |
| 11. | As described in Step 10 above, it is anticipated that the usage fee charges for VMT |
| | traveled by an HEV will be calculated by an AT2P3S provider, on an individual basis, |
| | well before any netting process is initiated. |
| | The AT2P3S will submit its calculations (on the basis of the VIN) to the VOPEUSP |
| | who will, in turn, assign the calculations to the HEV owner's account. |
| | Thus, the HEV owner will receive a periodic billing that includes VMT usage fee |
| | charges. |
| | Summary |
| | There are many benefits to the Actors from the proposed approach: |
| | The HEV Owner |
| | pays in one implementation(s) only for the use of taxable roadways |
| | (not private drives, parking lots, off-road usage); |
| | provides an automated system so periodic manual reporst are not |
| | required; |
| | pays in one implementation(s) only after the fact for electricity |
| | (although an upfront sales tax can be required); and |
| | provides trust level charging options based on HEV owner's |
| | preference and security sensitivity |
| | The VOPEUSP |
| | has further visibility into the load that is on its network, along with the |
| | potential for V2G discharge should the need arise. |
| | The value of its AMI Network is further enhanced, making further |
| | investments in such infrastructure even more palatable to the PUC. |
| | There is the potential that the utility could receive a fee from the taxing |
| | authorities for reimbursement of costs incurred to implement an HEV |
| | information portal, etc. |
| | The use of third party settlement services would relieve a potentially |
| | onerous administrative burden. |
| | (not private drives, parking lots, off-road usage); |
| | The AT2P3S |
| | Sustains a business model: Receives compensation from the tax |
| | authorities to administer the tax collection/settlement/reporting and |
| | remittance functions. |
| | Opportunities for additional service revenues can exist (i.e., can |
| | support the VMT tax clearance process, especially for used HEVs) |
| | Can provide assistance to auditing process |
| | Taxing Authorities |
| | Introduces an automated approach to ensure that HEVs pay their fair |
| | share into roadway construction and maintenance funds |
| | Provides a method to allocate funds based on miles traveled within |
| | specific jurisdictions |
| | Provides a mechanism to establish higher rates for higher maintenance |
| | roadway classifications (e.g., bridges, dams, tunnels). |

Use Case 3: HEV Owner Commissions Residential SHEVC as Trusted Level 1; Trust
Level 3 Charging occurs at a remote remote/third party utility location (site not
specified).
Goal in Context: Secure and successful transmission of Hybrid plug-in/Electric Vehicle
(“HEV”) Vehicle Miles Traveled (“VMT”) information to Vehicle Owner's Primary Electric
Utility Service Provider (“VOPEUSP”) during a Trust Level 1 charging session via an
Advanced Metering Infrastructure (“AMI”) Network, billing of an energy purchase and a
related sales tax during a Trust Level 3 charging session via a credit or debit card,
dissemination of appropriate information by the VOPEUSP and an application for credit to
an Authorized Third Party Processing/Settlement/Storage Service (AT2P3S) via the Cloud
for TL1 transactions and by separate application (whether through a web portal, an email or
a snail mail, etc. process), and the subsequent return of VMT billing and settlement values
(including credit for “out of network” sales tax for HEV energy transference) via the
Cloud to the VOPEUSP for inclusion in periodic billing.
NOTE: This can represent an opportunity for an HEV owner's VOPEUSP to introduce its own
credit card for use in TL3 charging sessions.

| | |
|---|---|
| Scope: | Energy transference and related sales tax payable for energy transferred |
| | during Trust Level 3 charging session paid by credit or debit card, and VMT |
| | subsequently reported for settlement through Trusted Level 1 charging |
| | session. |
| Level: | Trust Levels 1 & 3 |
| Preconditions: | HEV Owner (Buyer) purchases or leases an SHEVC as described in Use |
| | Case 1; also, HEV Owner travels to areas where recharging can be necessary |
| | but HEV owner is concerned about security of transmitting roadway |
| | classifications traveled (which can contain waypoints, such as bridges) over |
| | the available SHEVCs. Therefore, another source of payment can be used |
| | (e.g., prepaid credit card). |
| Success End | An accurate VMT usage fee billing included within HEV owner's utility |
| Condition: | bill; credit for sales tax paid on energy transference applied for by HEV |
| | owner; credit included in subsequent utility billing; privacy maintained. |
| Failed End | Inaccurate billing and/or disclosure of confidential information to |
| Condition: | unauthorized recipients. |
| Primary | HEV Seller, HEV Buyer, HEV, Trust Level 1 SHEVC, Trust Level 3 |
| Actors: | SHEVC, AMI Meter, AMI Network, Han or LAN, VOPEUSP, Third Party |
| | Utility, Authorized Third Party Processing/Settlement/Storage Service, |
| | Taxing Authorities |
| Trigger: | Trust Level 3 HEV Charging Session followed by Trust Level 1 HEV |
| | Charging Session |

MAIN SUCCESS SCENARIO

| 1. | Prior to the purchase or lease of an HEV, the prospective owner or lessee determines | | | |
|---|---|---|---|---|
| | that he or she will also purchase or lease a dedicated SHEVC for the vehicle (or for | | | |
| | the premise if more than one owned, leased or authorized HEV will be serviced by | | | |
| | the SHEVC). The VOPEUSP that serves the territory where the SHEVC will reside | | | |
| | shall be contacted to determine the type of AMI communications technology that has | | | |
| | been placed in service within such territory to ensure that the SHEVC will be able to | | | |
| | connect to the AMI Network (either directly or indirectly as part of a HAN or a | | | |
| | LAN; for purposes of this Use Case, the AMI Network will be defined as including | | | |
| | the HAN or LAN node, any SHEVC submeter or the SHEVC as a node itself). The | | | |
| | VOPEUSP will specify which manufacturer(s) and respective models of SHEVCs | | | |
| | may be purchased (or leased) that have been registered for use in its service territory | | | |
| | for the make/model of vehicle that may be prospectively acquired. | | | |
| 2. | The prospective HEV owner purchases or leases an HEV that includes an integrated | | | |
| | VMT Meter Module that is capable of (a) preparing VMT trip reports/files and (b) | | | |
| | further transmitting the reports/files for analysis. | | | |
| | During the commissioning process of programming the HEV dashboard/display | | | |
| | settings, pre-setting radio stations, etc., the new HEV owner/lessee will establish | | | |
| | password credentials and will access a password protected user interface screen to (a) | | | |
| | identify his or her VOPEUSP and (b) insert his or her VOPEUSP Account Number | | | |
| | (to be used for VMT settlement purposes). | | | |
| | Note: | | | |
| | For purposes of this Success Scenario, the integrated HEV VMT Meter Module | | | |
| | is defined as an Electronic Control Unit (ECU) within the vehicle that accumulates | | | |
| | mileage traveled by the vehicle over (A) prescribed roadway classifications (e.g., | | | |
| | highways, local roads, private drives, parking lots, etc.) and (B) predefined taxing | | | |
| | jurisdictions (e.g., states or local jurisdictions); this information will be accumulated | | | |
| | through the VMT Meter Module's access to the vehicle's navigation system. The | | | |
| | VMT Meter Module will accumulate the VMT use information in tables which the | | | |
| | VMT Meter Module will format into files or reports suitable for transmitting over a | | | |
| | utility's AMI network upon the initiation of an authorized charging session. The | | | |
| | VMT Meter Module can also be capable of storing sales tax paid information from | | | |
| | SHEVC charging sessions that are not authorized a “Trust Level 1 VMT use charge” | | | |
| | session and can also store information relating to the amount of energy transferred | | | |
| | in to the vehicle during a TL2 charging session so that billing amounts can be | | | |
| | compared for accuracy during the settlement process. A TL3 charging session will | | | |
| | be prepaid, so no additional energy billing should be included in the HEV owner's | | | |
| | VOPEUSP bill, but TL3 charging session sales tax should be stored for purposes of | | | |
| | final VMT settlement. Finally, the VMT Meter Module (or another ECU) can be | | | |
| | capable of storing payment information that can be transmitted upon an authorized | | | |
| | TL2 or TL3 session. The VMT Meter Module will have access to other of the | | | |
| | vehicle's ECUs so that it is able to include certain additional information (other than | | | |
| | VMT data) within the HEV trip report (e.g., VIN, certain owner identification | | | |
| | information, etc.). The HEV's VMT Meter Module includes communication | | | |
| | capabilities that will enable the HEV to (1) connect with an SHEVC or an authorized | | | |
| | local area network (either directly or indirectly through a specified communication | | | |
| | capability of another of the HEV's available systems, such as the infotainment | | | |
| | system) (2) transmit VMT files during an authorized charging session and (3) clear | | | |
| | its registers at the conclusion of an authorized charging session/VMT file | | | |
| | transmission. | | | |
| 3. | In conjunction with the transfer of title or execution of the lease agreement (whether | | | |
| | the vehicle is sold/leased by a dealership or the transaction is consummated without | | | |
| | the assistance of a dealer), the required Odometer Disclosure Statement (which may | | | |
| | be obtained at https://www.dmv.org/odometer-disclosure-statement.php) must also | | | |
| | be sent to the VOPEUSP designated by the new HEV owner/lessee. The odometer | | | |
| | reading must be associated with the specific Vehicle Identification Number (VIN). | | | |
| | Ideally, the VOPEUSP will maintain a web portal capable of accepting Odometer | | | |
| | Disclosure Statements, such that the statements can be uploaded and held in a queue | | | |
| | and ultimately assigned to a specific customer Account Number once the HEV is | | | |
| | registered (step 7 below). The Odometer Disclosure Statement can also be | | | |
| | transmitted by the VOPEUSP to its designated AT2P3S for its processing and record | | | |
| | retention purposes. | | | |
| | Simultaneous with the production of the Odometer Disclosure Statement, a | | | |
| | certification should be provided that the VMT Meter Module register has been | | | |
| | cleared (i.e., the tax obligation for mileage as of that point in time has been paid or | | | |
| | will be paid by the seller). | | | |
| 4. | The VOPEUSP (or the AT2P3S (as defined below) that has been engaged to process | | | |
| | its filings) notifies the relevant State and/or Local Department(s) of Transportation | | | |
| | and taxing authority/authorities that a new VIN Odometer Disclosure Statement has | | | |
| | been received and has been attributed to an account in its service territory. As | | | |
| | indicated above, this notification can be processed by use of the authorized third | | | |
| | party processing/settlement/storage service (the “AT2P3S”). | | | |
| 5. | The HEV owner purchases (or leases) an SHEVC that is appropriate for charging the | | | |
| | HEV as referenced in step 1, and which contains communication equipment capable | | | |
| | of (a) transmitting messages to the HEV and (b) receiving messages, data and/or | | | |
| | prepared files from the HEV's VMT Meter Module. Further, the SHEVC will be | | | |
| | capable of transmitting files or other information to the VOPEUSP, and capable of | | | |
| | receiving requests or other information from the VOPEUSP. | | | |
| 6. | Upon installation of the SHEVC, the charger is commissioned for service by (a) | | | |
| | establishing a communication path with the VOPEUSP either (i) directly via the | | | |
| | SHEVC's internal AMI Meter with integrated communications capabilities or (ii) as | | | |
| | a node in a HAN or LAN that relies on a master smart/AMI Meter to relay files and | | | |
| | other information; and (b) establishing a communication path with the HEV itself, | | | |
| | whether (i) wired through either an Ethernet or CAN bus (or similar) connection (via | | | |
| | the charging cable), or (ii) wireless via Bluetooth or WiFi (or similar) connection | | | |
| | (which could be necessary especially in the event of an inductive charger or wireless | | | |
| | SHEVC). | | | |
| 7. | The SHEVC and HEV are registered with the VOPEUSP by contacting the | | | |
| | VOPEUSP and specifying the SHEVC Manufacturer and Serial Number of the | | | |
| | SHEVC located on the HEV owner's premise and the VIN (or VINs) that will be | | | |
| | associated with the HEV owner's VOPEUSP Account Number. Other identifying | | | |
| | information can be required at that time, such as an SHEVC specific submeter | | | |
| | identification number, an IP address for the SHEVC (if applicable), login credentials, | | | |
| | etc., as determined by the VOPEUSP. | | | |
| | The registration process will ideally occur through the VOPEUSP's web portal, but | | | |
| | can also be accomplished with alternative means (such as a VOPEUSP customer | | | |
| | service representative). It is anticipated that a primary email address will be | | | |
| | requested of the HEV owner. | | | |
| 8 | The HEV engages in its initial charging session with the newly commissioned | | | |
| | SHEVC. At this point, a VMT file/report will be requested by the SHEVC of the | | | |
| | HEV's VMT Meter Module and the HEV will forward said file to the SHEVC (or to | | | |
| | the HAN/LAN or AMI Meter or submeter if the SHEVC is wireless). Upon receipt | | | |
| | of the file, the SHEVC will forward the file to the VOPEUSP or, in the case of a | | | |
| | wireless SHEVC, the HAN/LAN/AMI Meter or submeter which will then forward | | | |
| | the file to the VOPEUSP via an appropriate path. | | | |
| | In addition to the VIN and the VOPEUSP identifier, the VMT Meter Module file will | | | |
| | contain the mileage driven by roadway classification AND the ending Odometer | | | |
| | reading. | | | |
| | Ideally, the HEV owner will be logged in to the VOPEUSP's web portal and will | | | |
| | monitor his or her account for acknowledgement that the SHEVC has been registered | | | |
| | and is communicating with the VOPEUSP. The HEV owner should be able to | | | |
| | observe (1) the presence of the mileage reported on the Odometer Disclosure | | | |
| | Statement (as the starting point for calculating the VMT charge owed) and (2) the | | | |
| | current odometer reading (as transmitted within the report). The portal should also | | | |
| | disclose the mileage driven by roadway classification and the total mileage driven for | | | |
| | roadway classifications as reported in the registers. | | | |
| | In the event that the beginning odometer reading as registered with the VOPEUSP by | | | |
| | means of the Odometer Disclosure Statement plus the total mileage driven by | | | |
| | roadway classifications does not agree with the ending or current odometer reading, | | | |
| | an error message or alert will be triggered. While not specifying the exact cause of | | | |
| | the error, the message will nevertheless signal that either (a) the VMT Module is not | | | |
| | accurately accumulating mileage by classification or (b) that the registers were not | | | |
| | cleared at the time that the title was transferred or the lease was executed. | | | |
| | In such event, the VMT charges should be quarantined. The VOPEUSP should | | | |
| | either directly, or through the AT2P3S, notify the taxing authorities that an | | | |
| | abnormality occurred and a request should be made to obtain a tax clearance | | | |
| | certification stating the mileage that had previously been reported to the taxing | | | |
| | authorities (including tax exempt mileage). If such reported mileage is considerably | | | |
| | less than the Odometer Disclosure Statement, then the taxing authorities should | | | |
| | pursue the prior HEV owner to collect any unpaid tax. If the mileage differential is | | | |
| | minor, then the HEV should be examined to determine if the VMT Meter Module is | | | |
| | malfunctioning (or needs to be adjusted to compensate for potential anomalies, such | | | |
| | as a miscalculation due to a mismatched tire size (considered “rounding” errors)). | | | |
| | It is possible, perhaps even likely, that the sum of the mileage collected by roadway | | | |
| | classification can not agree exactly with the difference between the beginning and | | | |
| | ending odometer readings, but the differences should be minimal and largely | | | |
| | attributable to rounding errors. Therefore, some allowance should likely be made | | | |
| | within the regulations for such possible rounding errors so that alarm events that | | | |
| | require tax clearance certificates are minimized. | | | |
| 9. | Assuming that the newly commissioned SHEVC has been successful in accessing the | | | |
| | VMT report/file from the HEV (or the wireless charging session initiation has caused | | | |
| | the HEV to transmit the VMT report/file to an authorized node in the AMI | | | |
| | Network), and the VMT report/file has been successfully transmitted to the | | | |
| | VOPEUSP, then the HEV Owner should be able to view a summary of his or her | | | |
| | VMT mileage in the web portal made available by the VOPEUSP. The personal | | | |
| | account on the web portal should present pertinent information, which can include all | | | |
| | (or a subset of) the following: | | | |
| | VOPEUSP Utility Account Number | | | |
| | Vehicle Identification Number associated with Utility Account Number | | | |
| | Odometer Reading at time of HEV acquisition (per the Odometer Disclosure | | | |
| | Statement) | | | |
| | (Ending) Odometer Reading as of the most recent charging session (which, in | | | |
| | the case of an initial charge of a newly acquired HEV, should be the same as | | | |
| | the odometer reading per the Odometer Disclosure Statement) | | | |
| | Mileage driven per (state or other taxing jurisdiction)/per roadway | | | |
| | classification since the last charging session (e.g.,): | | | |
| | MO-Highway Miles | | | |
| | MO-Bridge Miles | | | |
| | MO-Local Road Miles | | | |
| | MO-Private Drive Miles | | | |
| | MO-Parking Lot Miles | | | |
| | MO-Off-road Miles | | | |
| | MO-Etc. Miles | | | |
| | IL-Highway Miles | | | |
| | IL-Bridge Miles | | | |
| | IL-Local Road Miles | | | |
| | IL-Private Drive Miles | | | |
| | IL-Parking Lot Miles | | | |
| | Ending Odometer Reading | | | |
| | [Other: Prior charging session usage fee?; Prepaid tax credits?; Tax/fees | | | |
| | paid to non VOPEUSP taxing jurisdictions, etc.] | | | |
| | [Other: V2G discharges and related metrics? Historical cost (by mile; by | | | |
| | “taxable” mile, etc.) metrics? Other analytics/metrics?] | | | |
| | While the VMT usage fees amounts can be prepared by the VOPEUSP and | | | |
| | immediately disclosed on the web portal, it is expected that the tax calculation and | | | |
| | settlement process will entail the use of an AT2P3S. This expectation is driven by | | | |
| | the anticipated complexity that will be associated with calculating usage fees for | | | |
| | VMT across multiple taxing jurisdictions and the settlement process that can | | | |
| | potentially include credits for payments made during charging sessions outside of the | | | |
| | VOPEUSP territory or during Trust Level 2 or lower sessions. | | | |
| | Therefore, it is anticipated that Step 9 involves transmitting the VMT file | | | |
| | information to AT2P3S so that further analyses can be performed. | | | |
| 10. | For purposes of this use case, the HEV owner will travel such that the HEV will need | | | |
| | to be charged in a location that the owner does not have a high level of trust in terms | | | |
| | of sharing waypoint information, or the HEV owner is visiting a friend or relative but | | | |
| | does not want to designate their SHEVC as a TL1 SHEVC. In this case, the HEV | | | |
| | owner is willing to initiate payment for transferred energy with a debit or credit card | | | |
| | to engage in a TL3 charging session. | | | |
| | In this case, the HEV owner would engage in a charging session with the SHEVC by | | | |
| | designating the SHEVC as a Trust Level 3 SHEVC, and the SHEVC (and possibly | | | |
| | the HEV's VMT Meter Module) would meter the energy transferred during the | | | |
| | charging session. The SHEVC would collect the VIN and the debit or credit card | | | |
| | information from the HEV owner, and the HEV VMT Meter Module would record | | | |
| | the payment information (amount of energy purchased and related sales tax paid) in a | | | |
| | register. | | | |
| | In summary, at the conclusion of the charging session, the Trust Level 3 SHEVC will | | | |
| | communicate with the HEV's VMT Meter Module and transmit (for storage), at a | | | |
| | minimum, the following data (in table .txt format): | | | |
| | The VOPEUSP designator for the TL3 SHEVC | | | |
| | The amount of the energy transmitted (e.g., in watt-hours) | | | |
| | The amount of money that will be billed for the energy transmitted | | | |
| | A sales tax (which can reflect a percentage that is substantially higher than | | | |
| | the average usage fee charged on taxable VMT so as to ensure that there is an | | | |
| | incentive to engage in a subsequent TL1 settlement charging session) | | | |
| | The TL3 SHEVC will also transmit the energy consumption, billing amount and | | | |
| | sales tax amount to the TL3 SHEVC's VOPEUSP. This VOPEUSP will forward the | | | |
| | billing information (including VIN) along to its AT2P3S (see below) so that a | | | |
| | settlement process can be initiated with the HEV owner's specified VOPEUSP. | | | |
| | Upon a subsequent HEV TL1 charging session, the HEV will transmit its stored | | | |
| | information regarding the TL3 charging session from the HEV VMT Meter Module | | | |
| | memory to the TL1 SHEVC, which will transmit the information to the HEV | | | |
| | owner's VOPEUSP, which will further transmit the data to the HEV owner's | | | |
| | VOPEUSP's AT2P3S. | | | |
| | The HEV owner's VOPEUSP's AT2P3S will compare the HEV VMT Meter Module | | | |
| | data received from the HEV Owner's VMT Meter Module to the data received from | | | |
| | the TL3 SHEVC's VOPEUSP's AT2P3S relative to the TL3 charging session (that | | | |
| | is, such data can be received either directly or from a separate AT2P3S). Assuming | | | |
| | that the data agrees, then the AT2P3S will facilitate a settlement process, whereby | | | |
| | credit for the sale tax paid during the TL3 session will also be recorded to the HEV | | | |
| | owner's VOPEUSP account (and will be used as a credit to offset the usage fee owed | | | |
| | for “taxable” VMT traveled between the last and current TL 1 charging sessions). | | | |
| 11. | The AT2P3S will have previously established an agreement with the VOPEUSP to | | | |
| | protect and treat confidentially information received from the VOPEUSP. | | | |
| | The AT2P3S will have established a database that is maintained on the basis of the | | | |
| | HEV VIN. Each VIN will be associated with the HEV's VOPEUSP by the | | | |
| | VOPEUSP designator and the HEV Account Number. No other personal | | | |
| | information relative to the HEV owner will be collected by the AT2P3S. The | | | |
| | VOPEUSP designator will be determined by the Public Utility Commission that | | | |
| | maintains oversight of the utility. | | | |
| | The AT2P3S will parse the information included in each VMT report received | | | |
| | relative to each VIN, and will calculate VMT taxes and/or fees based upon the rules | | | |
| | established by each relevant taxing authority where the HEV has logged VMT. This | | | |
| | will require the AT2P3S to continually update its tax or fee schedules for each tax | | | |
| | jurisdiction in the contiguous United States and, to the extent that tax or fee treaties | | | |
| | are ratified with contiguous countries, then the AT2P3S can be required to maintain | | | |
| | respective tax/fee schedules for those sovereignties as well. | | | |
| | AT2P3S will calculate the taxes or fees that are due and payable to each appropriate | | | |
| | jurisdiction. | | | |
| | It will be important, legislatively, to ensure that AT2P3S's interface with each other | | | |
| | to, at a minimum, share information relative to VINs that are (a) registered or (b) | | | |
| | engage in charging sessions “within the VOPEUSP territories for which they are | | | |
| | engaged to process and store information”. | | | |
| | There should not be duplicates of the same VIN throughout the North American | | | |
| | continent. If that occurs, then fraud is being perpetrated and an investigation should | | | |
| | ensue. | | | |
| | In the event that the HEV owner lives in an area where the VOPEUSP is being | | | |
| | serviced by an AT2P3S that is separate and distinct from the AT2P3S that services | | | |
| | the HEV owner's employer's primary utility, then the two AT2P3S's need to | | | |
| | communicate so that appropriate charges can be included in the HEV owner's | | | |
| | periodic billing. | | | |
| | When an AT2P3S serves a territory where an HEV owner engages in a Trust Level 3 | | | |
| | charge such that a prepayment of sales tax occurs, that AT2P3S would need to share | | | |
| | the prepayment information with the HEV owner's VOPEUSP so that the owner can | | | |
| | receive appropriate credits on his or her subsequent bill. Therefore, it will be | | | |
| | important for AT2P3S's to share information relative to VIN charging sessions. | | | |
| | As in other use cases, it is anticipated that the AT2P3S's will perform analytics to | | | |
| | effectively “net“ the settlement payments that VOPEUSPs can be required to make | | | |
| | to each other. | | | |
| | Assume that there is an AT2P3S responsible for the VOPEUSP 1 territory, and a | | | |
| | separate AT2P3S responsible for the Other Utility (“OU”) service territory | | | |
| | (including remittance of tax payment to the local tax authorities) in addition to the | | | |
| | following facts: | | | |
| | | | Taxable VMT Driven in Territory of | |
| | | | VOPEUSP 1 | Other Utility (OU) |
| | HEV 1 Mileage | | 120 | 75 |
| | Use Tax @ $0.06 per mile | | $7.20 | |
| | Electricity Purchased via | | | $20.00 |
| | TL3 charge session | | | |
| | Sales Tax @ | 30% | | $6.00 |
| | Use Tax @ $0.07 per mile | | | $5.25 |
| | Total owed to Tax Authority 1 | | 7.20 | |
| | Total owed to Tax Authority 2 | | | 5.25 |

| | |
|---|---|
| | The HEV owner initiates a TL3 charging session at an SHEVC within the OU |
| | territory, and uses a prepaid credit card to pay for the session. In addition to |
| | providing a valid credit card, the HEV owner provides the VIN. |
| | The HEV Owner's selected payment method (e.g., Apply Pay, PayPal, credit card, |
| | etc.] is debited for $26.00 (i.e., the value of the electricity plus the value of the sales |
| | tax) by the SHEVC. The charging session information along with the payment |
| | information is transmitted to the OU. The OU retains the payment for the energy |
| | transferred, and transmits the charge session information to its AT2P3S. |
| | The AT2P3S determines whether the VIN is within its service territory. If not, the |
| | AT2P3S identifies the AT2P3S that provides services for the VIN, and transmits the |
| | charge session information to that AT2P3S. The TL3 SHEVC's VOPEUSP's |
| | AT2P3S will hold the $6.00 credit information in a file that is specific to the VIN |
| | until the conclusion of the billing cycle, at which point a VMT tax settlement process |
| | will be initiated. |
| | In this case, the HEV will report to its VOPEUSP that it traveled 120 miles in its |
| | designated VOPEUSP's service territory, and 75 miles in the OU's service territory. |
| | The HEV owner will be billed a total of $12.45 for road usage fee, but will receive a |
| | $6.00 credit for sales tax paid, and so the bill for the period from the HEV owner's |
| | VOPEUSP will include a net tax due of $6.45. |
| | Since the AT2P3S's will be collecting sales/usage fees from the utility service |
| | providers and remitting the true tax owed, the AT2P3S's will make settlement |
| | payments between themselves for relative taxes collected versus taxes owed. |
| | A total of $7.20 is owed by the HEV owner to the tax authorities in the HEV owner's |
| | VOPEUSP's service territory, but the VOPEUSP collects only $6.45. The |
| | VOPEUSP remits the $6.45 collected to its responsible AT2P3S. That AT2P3S then |
| | submits its settlement payment request, along with its statement of taxes actually |
| | owed within the OU's service territory, to the OU's AT2P3S in the amount of ($7.20- |
| | $6.45), or $0.75. The OU's AT2P3S, which has collected $6.00 in sales tax, remits |
| | $0.75 to the VOPEUSP AT2P3S, and therefore has $5.25 remaining to remit to the |
| | tax authorities in that jurisdiction (which, per the table above, happens to be the s |
| | owed for the VMT within the territory by the HEV owner). The VOPEUSP's |
| | AT2P3S likewise remits the $7.20 that it has amassed to the tax authorities that |
| | oversee the VOPEUSP territories. |
| | As in the other use cases, the recommended approach will be for the AT2P3S's to |
| | perform the remittance services (analysis, assessment, settlement and collection and |
| | payment) on behalf of VOPEUSP's under contract. If a single AT2P3S is |
| | representing both utilities, then each of the utilities will forward the taxes collected to |
| | the AT2P3S. The $6.45 collected by VOPEUSP 1 and the $6.00 collected by the OU |
| | will be remitted to the respective tax authorities (less an authorized processing fee). |
| | The VIN numbers and associated mileage (taxable and non-taxable) will be included |
| | in the report to the taxing authorities in support of the amounts remitted. |
| | The AT2P3S will transmit a file/report for the benefit of the VINs to each |
| | respective VOPEUSP or OU so that the respective web portal (or data base in the |
| | case of an OU) can be updated to reflect the tax payments made and the settlement of |
| | those taxes. |
| 12. | As described in Step 10 above, it is anticipated that the usage fee charges for VMT |
| | traveled by an HEV will be calculated by an AT2P3S provider, on an individual |
| | basis, well before any netting process is initiated. |
| | The AT2P3S will submit its calculations (on the basis of the VIN) to the VOPEUSP |
| | who will, in turn, assign the calculations to the HEV owner's account. |
| | Thus, the HEV owner will receive a periodic billing that includes VMT usage fee |
| | charges. |
| | Summary |
| | There are many benefits to the Actors from the proposed approach: |
| | The HEV Owner |
| | pays in one implementation(s) only for the use of taxable roadways |
| | (not private drives, parking lots, off-road usage); |
| | provides an automated system so periodic manual reports are not |
| | required; and |
| | provides trust level charging options based on HEV owner's |
| | preference and security sensitivity |
| | The VOPEUSP |
| | has further visibility into the load that is on its network, along with the |
| | potential for V2G discharge should the need arise. |
| | The value of its AMI Network is further enhanced, making further |
| | investments in such infrastructure even more palatable to the PUC. |
| | There is the potential that the utility could receive a fee from the |
| | taxing authorities for reimbursement of costs incurred to implement |
| | an HEV information portal, etc. |
| | The use of third party settlement services would relieve a potentially |
| | onerous administrative burden. |
| | The AT2P3S |
| | Sustains a business model: Receives compensation from the tax |
| | authorities to administer the tax collection/settlement/reporting and |
| | remittance functions. |
| | Opportunities for additional service revenues can exist (i.e., can |
| | support the VMT tax clearance process, especially for used HEVs) |
| | Can provide assistance to auditing process |
| | Taxing Authorities |
| | Introduces an automated approach to ensure that HEVs pay their fair |
| | share into roadway construction and maintenance funds |
| | Provides a method to allocate funds based on miles traveled within |
| | specific jurisdictions |
| | Provides a mechanism to establish higher rates for higher maintenance |
| | roadway classifications (e.g., bridges, dams, tunnels). |

Use Case 4: HEV Owner does not have access to a Trust Level 1 SHEVC on a frequent
basis.
Goal in Context: To describe the process for settlement of VMT related taxes attributable to
HEVs that do not transmit (on a frequent basis) information relating to the VMT roadway
classifications.

| | |
|---|---|
| Scope: | VMT settlement occurs infrequently. |
| Level: | Trust Level 1 rarely, Trust Level 2 more common; potential Trust Level 3 |
| Preconditions: | sessions |
| | Potential HEV owner purchases or leases an HEV that includes a VMT |
| | Meter Module with embedded communication capabilities (or access to an |
| | ECU that includes communication capabilities) that would be able to |
| | communicate with an SHEVC that itself would be capable of |
| | interoperability with the VOPEUSP meter or a VOPEUSP supported Local |
| | Area Network (LAN) if the HEV were to pair with such an SHEVC. |
| Success End | An accurate VMT billing included within utility bill, which can include a fee |
| Condition: | or penalty to generate a “time value of money“ due to lack of periodic |
| | reporting; privacy maintained. |
| Failed End | Inaccurate billing, including lack of a billing to reflect a “time value of |
| Condition: | money”; and/or disclosure of confidential information to unauthorized |
| | recipients. |
| Primary | HEV Seller, HEV Buyer, HEV, SHEVC, AMI Meter, AMI Network, LAN, |
| Actors: | VOPEUSP, Authorized 3rd Party Data Processing & Storage Center, Taxing |
| | Authorities |
| Trigger: | Multiple Trust Level 2 or 4 HEV Charging Sessions, infrequent TL1 |
| | Charging Sessions |

MAIN SUCCESS SCENARIO

| 1. | Prior to the purchase or lease of an HEV, the prospective owner or lessee determines | | | |
|---|---|---|---|---|
| | that he or she will NOT purchase or lease a dedicated SHEVC for the vehicle. A | | | |
| | variety of “trusted” SHEVCs (that will offer connector apparatus capable of | | | |
| | interacting with vehicle receptacle types) within the HEV owner's VOPEUSP will | | | |
| | be available for public use at one or more public service locations such as (i) a | | | |
| | police department (ii) a post office (iii) a public library or (iv) an HEV dealership. | | | |
| | Secure SHEVCs should also be installed at authorized HEV service facilities that are | | | |
| | licensed to perform annual safety inspections. The aforementioned SHEVCs will be | | | |
| | monitored to ensure that the security of the information transmitted is at the highest | | | |
| | level. Those SHEVCs will also contain AMI communications technology that will | | | |
| | enable the transport of VMT Meter Module files to the VOPEUSP over the available | | | |
| | AMI Network. | | | |
| 2. | The prospective HEV owner purchases or leases an HEV that includes an integrated | | | |
| | VMT Meter Module that is capable of (a) preparing VMT trip reports/files and (b) | | | |
| | further transmitting the reports/files for analysis. | | | |
| | During the commissioning process of programming the HEV dashboard/display | | | |
| | settings, pre-setting radio stations, etc., the new HEV owner/lessee will establish | | | |
| | password credentials and will access a password protected user interface screen to | | | |
| | (a) identify his or her VOPEUSP and (b) insert his or her VOPEUSP Account | | | |
| | Number (to be used for VMT settlement purposes). | | | |
| | Note: | | | |
| | For purposes of this Success Scenario, the integrated HEV VMT Meter | | | |
| | Module is defined as an Electronic Control Unit (ECU) within the vehicle that | | | |
| | accumulates mileage traveled by the vehicle over (A) prescribed roadway | | | |
| | classifications (e.g., highways, local roads, private drives, parking lots, etc.) and (B) | | | |
| | predefined taxing jurisdictions (e.g., states or local jurisdictions); this information | | | |
| | will be accumulated through the Meter Module's access to the vehicle's navigation | | | |
| | system. The Meter Module will accumulate the VMT use information in tables | | | |
| | which the Meter Module will format into files or reports suitable for transmitting | | | |
| | over a utility's AMI network upon the initiation of an authorized charging session. | | | |
| | The VMT Meter Module can also be capable of storing sales tax paid information | | | |
| | from SHEVC charging sessions that are not authorized a “Trust Level 1 VMT use | | | |
| | charge“ session and can also store information relating to the amount of energy | | | |
| | transferred in to the vehicle during a TL2 charging session so that billing amounts | | | |
| | can be compared for accuracy during the settlement process. A TL3 charging | | | |
| | session will be prepaid, so no additional energy billing should be included in the | | | |
| | HEV owner's VOPEUSP bill, but TL3 charging session sales tax should be stored | | | |
| | for purposes of final VMT settlement. Finally, the VMT Meter Module (or another | | | |
| | ECU) can be capable of storing payment information that can be transmitted upon | | | |
| | an authorized TL2 or TL3 session. The Meter Module will have access to other of | | | |
| | the vehicle's ECUs so that it is able to include certain additional information (other | | | |
| | than VMT data) within the HEV trip report (e.g., VIN, certain owner identification | | | |
| | information, etc.). The HEV's VMT Meter Module includes communication | | | |
| | capabilities that will enable the HEV to (1) connect with an SHEVC or an | | | |
| | authorized local area network (either directly or indirectly through a specified | | | |
| | communication capability of another of the HEV's available systems, such as the | | | |
| | infotainment system) (2) transmit VMT files during an authorized charging session | | | |
| | and (3) clear its registers at the conclusion of an authorized charging session/VMT | | | |
| | file transmission. | | | |
| 3. | In conjunction with the transfer of title or execution of the lease agreement (whether | | | |
| | the vehicle is sold/leased by a dealership or the transaction is consummated without | | | |
| | the assistance of a dealer), the required Odometer Disclosure Statement (which may | | | |
| | be obtained at https://www.dmv.org/odometer-disclosure-statement.php) must also | | | |
| | be sent to the VOPEUSP designated by the new HEV owner/lessee. The odometer | | | |
| | reading must be associated with a specific Vehicle Identification Number (VIN). | | | |
| | Ideally, the VOPEUSP will maintain a web portal capable of accepting Odometer | | | |
| | Disclosure Statements, such that the statements can be uploaded and held in a queue | | | |
| | and ultimately assigned to a specific customer Account Number once the HEV is | | | |
| | registered (step 7 below). The Odometer Disclosure Statement can also be | | | |
| | transmitted by the VOPEUSP to its designated AT2P3S for its processing and record | | | |
| | retention purposes. | | | |
| | Simultaneous with the production of the Odometer Disclosure Statement, a | | | |
| | certification should be provided that the VMT Meter Module register has been | | | |
| | cleared (i.e., the tax obligation for mileage as of that point in time has been paid or | | | |
| | will be paid by the seller). | | | |
| 4. | The VOPEUSP (or the AT2P3S (as defined below) that has been engaged to process | | | |
| | its filings) notifies the relevant State and/or Local Department(s) of Transportation | | | |
| | and taxing authority/authorities that a new VIN Odometer Disclosure Statement | | | |
| | has been received and has been attributed to an account in its service territory. As | | | |
| | indicated above, this notification can be processed by use of the authorized third | | | |
| | party processing/settlement/storage service (the “AT2P3S”). | | | |
| 5. | This use case assumes that the HEV owner generally recharges his or her HEV at a | | | |
| | location that the owner considers to be untrustworthy in terms of sharing | | | |
| | confidential information. This can be a situation, for example, where the HEV | | | |
| | owner resides at a multi-tenant apartment building and works in an area where | | | |
| | public charging may not receive as much security oversight as deemed desirable, | | | |
| | and therefore the HEV owner is unwilling to designate any SHEVC in close | | | |
| | proximity to his or her residence or work-site as a Trust Level 1 SHEVC. | | | |
| | In the event that a new HEV owner-at the time of purchase (or lease)-determines | | | |
| | that he or she will not purchase or lease a designated SHEVC to establish a Trust | | | |
| | Level 1 SHEVC, the new owner must be notified by the seller of the options for | | | |
| | Trust Level 1 SHEVC charging, which can include: | | | |
| | Periodic charging at an available SHEVC at a police station, post office or | | | |
| | public library | | | |
| | At the location of a facility that performs an annual safety inspection (i.e., a | | | |
| | state licensed vehicle repair service station) | | | |
| | The notification must include information describing the requirements for periodic | | | |
| | Trust Level 1 reporting and the fact that additional fees, penalties or charges can be | | | |
| | imposed if taxable VMT mileage is not reported for an established period of time or | | | |
| | for a threshold number of taxable miles or possibly both. | | | |
| 6. | The trusted, yet publicly available, SHEVC will be previously commissioned and | | | |
| | will be reporting VIN specific VMT reports to the VOPEUSP that services the area | | | |
| | in which the SHEVC resides. | | | |
| 7. | The HEV is registered with the VOPEUSP by contacting the VOPEUSP and | | | |
| | specifying that the VIN will be associated with the HEV owner's VOPEUSP | | | |
| | Account Number. Other identifying information can be required at that time, such | | | |
| | as login credentials, etc., as determined by the VOPEUSP. | | | |
| | The registration process will ideally occur through the VOPEUSP's web portal, but | | | |
| | can also be accomplished with alternative means (such as a VOPEUSP customer | | | |
| | service representative). It is anticipated that a primary email address will be | | | |
| | requested of the HEV owner. | | | |
| 8. | The HEV engages in its initial charging session at the time of title transfer, which | | | |
| | will take place at a trusted SHEVC. This can be at the dealership, at the Sellers | | | |
| | preferred TL1 SHEVC, or at a public trusted charger (e.g., a police station, a post | | | |
| | office, a public library, a department of transportation/license bureau, etc.). | | | |
| | At this point, a VMT file/report will be requested by the SHEVC of the HEV and | | | |
| | the HEV will forward said file to the SHEVC (or to the LAN or AMI Meter or | | | |
| | submeter if the SHEVC is wireless). Upon receipt of the file, the SHEVC will | | | |
| | forward the file to the VOPEUSP or, in the case of a wireless SHEVC, the | | | |
| | LAN/AMI Meter or submeter which will then forward the file to the VOPEUSP via | | | |
| | an appropriate path. | | | |
| | In addition to the VIN and the VOPEUSP identifier, the file will contain the mileage | | | |
| | driven by roadway classification AND the ending Odometer reading. | | | |
| | Ideally, the HEV owner will be logged in to the VOPEUSP's web portal and will | | | |
| | monitor his or her account for acknowledgement that the SHEVC has been | | | |
| | registered and is communicating with the VOPEUSP. The HEV owner should be | | | |
| | able to observe (1) the presence of the mileage reported on the Odometer Disclosure | | | |
| | Statement (as the starting point for calculating the VMT charge owed), (2) the | | | |
| | current odometer reading (as transmitted within the report). The portal should also | | | |
| | disclose the mileage driven by roadway classification and the total mileage driven | | | |
| | for roadway classifications as reported in the registers. | | | |
| | To the extent that the beginning odometer reading plus the total mileage driven by | | | |
| | roadway classifications exceeds the ending or current odometer reading, an error | | | |
| | message or alert will be triggered. While not specifying the exact cause of the error, | | | |
| | the message will nevertheless indicate that either (a) the VMT Module is not | | | |
| | accurately accumulating mileage by classification or (b) that the registers were not | | | |
| | cleared at the time that the title was transferred or the lease was executed. | | | |
| | In such event, the VMT charges should be quarantined. The VOPEUSP should | | | |
| | either directly, or through the AT2P3S, notify the taxing authorities that an | | | |
| | abnormality occurred and a request should be made to obtain a tax clearance | | | |
| | certification stating the mileage that had previously been reported to the taxing | | | |
| | authorities (including tax exempt mileage). If such reported mileage is considerably | | | |
| | less than the Odometer Disclosure Statement, then the taxing authorities should | | | |
| | pursue the prior HEV owner to collect the tax. If the mileage differential is minor, | | | |
| | then the HEV should be examined to determine if the VMT Meter Module is | | | |
| | malfunctioning (or needs to be adjusted to compensate for potential anomalies, such | | | |
| | as a miscalculation due to a mismatched tire size (considered “rounding” errors)). | | | |
| | It is possible, perhaps even likely, that the sum of the mileage collected by roadway | | | |
| | classification may not agree exactly with the difference between the beginning and | | | |
| | ending odometer readings, but the differences should be minimal and largely | | | |
| | attributable to rounding errors. Therefore, some allowance should likely be made | | | |
| | within the regulations for such possible rounding errors so that alarm events that | | | |
| | require tax clearance certificates are minimized. | | | |
| | At the conclusion of future trusted charging sessions, then the HEV Owner should | | | |
| 9. | be able to view a summary of his or her VMT mileage in the web portal made | | | |
| | available by the VOPEUSP. The personal account on the web portal should present | | | |
| | pertinent information, which can include all (or a subset of) the following: | | | |
| | VOPEUSP Utility Account Number | | | |
| | Vehicle Identification Number associated with Utility Account Number | | | |
| | Odometer Reading at time of HEV acquisition (per the Odometer Disclosure | | | |
| | Statement) | | | |
| | (Ending) Odometer Reading as of the most recent charging session (which, | | | |
| | in the case of an initial charge of a newly acquired HEV, should be the same | | | |
| | as the odometer reading per the Odometer Disclosure Statement) | | | |
| | Mileage driven per (state or other taxing jurisdiction)/per roadway | | | |
| | classification since the last charging session (in the case of an initial charge, | | | |
| | the mileage should be noon); for example: | | | |
| | MO-Highway Miles | | | |
| | MO-Bridge Miles | | | |
| | MO-Local Road Miles | | | |
| | MO-Private Drive Miles | | | |
| | MO-Parking Lot Miles | | | |
| | MO-Off-road Miles | | | |
| | MO-Etc. Miles | | | |
| | Ending Odometer Reading | | | |
| | [Other: Prior charging session usage fee?; Prepaid tax credits?; Tax/fees | | | |
| | paid to non VOPEUSP taxing jurisdictions, etc.] | | | |
| | [Other: V2G discharges and related metrics? Historical cost (by mile; by | | | |
| | “taxable” mile, etc.) metrics? Other analytics/metrics?] | | | |
| | While the VMT usage fee amounts can be prepared by the VOPEUSP and | | | |
| | immediately disclosed on the web portal, it is expected that the tax calculation and | | | |
| | settlement process will entail the use of an AT2P3S. This expectation is driven by | | | |
| | the anticipated complexity that will be associated with calculating usage fees for | | | |
| | VMT across multiple taxing jurisdictions and the settlement process that can | | | |
| | potentially include credits for payments made during charging sessions outside of | | | |
| | the VOPEUSP territory or during Trust Level 2 or Trust Level 3 sessions. | | | |
| | Therefore, it is anticipated that Step 9 involves transmitting the VMT file | | | |
| | information to an AT2P3S so that further analyses can be performed. | | | |
| 10. | For purposes of this use case, the HEV owner will rarely engage in a TL1 charging | | | |
| | session. This may be due to circumstances and not choice. However, when relying | | | |
| | upon TL2 or TL3 charging sessions, it is likely that VMT usage fees that can be | | | |
| | appropriately allocated to taxing jurisdictions outside of the “TL2 or TL3 charging | | | |
| | session territory” are not settled on a timely basis. | | | |
| | For example, an HEV owner can engage with a single TL3 SHEVC in Territory A | | | |
| | for a 12 month period, prepaying for energy transferences and sales tax on such | | | |
| | energy, and the VOPEUSP for Territory A will collect the associated sales tax. | | | |
| | However, it can be that a majority of the taxable VMT occurs in Territory B. | | | |
| | Absent a TL1 session, the calculation of usage fee owed relative to Territory B, and | | | |
| | payment of that amount, is deferred. | | | |
| | In this instance, the VMT settlement would occur at the conclusion of the 12 month | | | |
| | period-at the time of the vehicle inspection. This would require that an authorized | | | |
| | vehicle safety inspection facility also serve as an “auditor” of sorts for VMT usage | | | |
| | fee purposes. | | | |
| | Assuming that AT2P3S(s) report to the taxing authorities the VMT settlements that | | | |
| | occur for each VIN on a monthly basis, the vehicle inspection facility should be able | | | |
| | to log into a DOT database to determine the most recent reporting of VMT. Based | | | |
| | upon regulation (in terms of un-settled mileage or time), it can be that the safety | | | |
| | inspection cannot be issued absent a TL1 charging session (and the safety inspection | | | |
| | facility itself should be able to offer such a secure TL1 charging session as a part of | | | |
| | its service if so required). | | | |
| | Considering an extreme case, where sales tax has been paid 100% to the Tax | | | |
| | Authorities in Territory A, but 95% of the taxable VMT during the unreported | | | |
| | period is attributable to Territory B, a true up payment should be made. This | | | |
| | example will be explored in section 12 below. | | | |
| | Back to the specifics of the TL3 charging session itself, the HEV owner would | | | |
| | engage in a charging session with the SHEVC by designating the SHEVC as a Trust | | | |
| | Level 3 SHEVC, and the SHEVC (and possibly the HEV's VMT Meter Module) | | | |
| | would meter the energy transferred during the charging session. The SHEVC would | | | |
| | collect the VIN and the debit or credit card information from the HEV owner, and | | | |
| | the HEV VMT Meter Module would record the payment information (amount of | | | |
| | energy purchased and related sales tax paid) in a register. | | | |
| | At the conclusion of the charging session, the Trust Level 3 SHEVC will | | | |
| | communicate with the HEV's VMT Meter Module and transmit (for storage), at a | | | |
| | minimum, the following data (in table .txt format): | | | |
| | The VOPEUSP designator for the TL3 SHEVC | | | |
| | The amount of the energy transmitted (e.g., in watt-hours) | | | |
| | The amount of money that will be billed for the energy transmitted | | | |
| | A sales tax (which can reflect a percentage that is substantially higher than | | | |
| | the average usage fee charged on taxable VMT so as to ensure that there is | | | |
| | an incentive to engage in a subsequent TL1 settlement charging session) | | | |
| | The TL3 SHEVC will also transmit the energy consumption, billing amount and | | | |
| | sales tax amount to the TL3 SHEVC's VOPEUSP. This VOPEUSP will forward the | | | |
| | billing information (including VIN) along to its AT2P3S (see below) so that a | | | |
| | settlement process can be initiated with the HEV owner's specified VOPEUSP. | | | |
| | Upon a subsequent HEV TL1 charging session (say, during the safety inspection), | | | |
| | the HEV will transmit its stored information regarding the TL3 charging session(s) | | | |
| | from the HEV VMT Meter Module memory to the TL1 SHEVC, which will | | | |
| | transmit the information to the HEV owner's VOPEUSP, which will further transmit | | | |
| | the data to the HEV owner's VOPEUSP's AT2P3S. | | | |
| | The HEV owner's VOPEUSP's AT2P3S will compare the HEV VMT Meter | | | |
| | Module data received from the HEV Owner's VMT Meter Module to the data | | | |
| | received from the TL3 SHEVC's VOPEUSP's AT2P3S relative to the TL3 charging | | | |
| | session (that is, such data can be received either directly or from a separate | | | |
| | AT2P3S). Assuming that the data agrees, then the AT2P3S will facilitate a | | | |
| | settlement process, whereby credit for the sale tax paid during the TL3 session will | | | |
| | also be recorded to the HEV owner's VOPEUSP account (and will be used as a | | | |
| | credit to offset the usage fee owed for taxable VMT traveled between the last and | | | |
| | current TL1 charging sessions). | | | |
| 11. | The AT2P3S will have previously established an agreement with the VOPEUSP to | | | |
| | protect and treat confidentially information received from the VOPEUSP. | | | |
| | The AT2P3S will have established a database that is maintained on the basis of the | | | |
| | HEV VIN. Each VIN will be associated with the HEV's VOPEUSP by the | | | |
| | VOPEUSP designator and the HEV Account Number. No other personal | | | |
| | information relative to the HEV owner will be collected by the AT2P3S. | | | |
| | The AT2P3S will parse the information included in each VMT report received | | | |
| | relative to each VIN, and will calculate VMT taxes and/or fees based upon the rules | | | |
| | established by each relevant taxing authority where the HEV has logged VMT. This | | | |
| | will require the AT2P3S to continually update its tax or fee schedules for each tax | | | |
| | jurisdiction in the contiguous United States and, to the extent that tax or fee treaties | | | |
| | are ratified with contiguous countries, then the AT2P3S can be required to maintain | | | |
| | respective tax/fee schedules for those sovereignties as well. | | | |
| | AT2P3S will calculate the taxes or fees that are due and payable to each appropriate | | | |
| | jurisdiction. | | | |
| | It will be important, legislatively, to ensure that AT2P3S's interface with each other | | | |
| | to, at a minimum, share information relative to VINs that are (a) registered or (b) | | | |
| | engage in charging sessions “within the VOPEUSP territories for which they are | | | |
| | engaged to process and store information”. | | | |
| | There should not be duplicates of the same VIN throughout the North American | | | |
| | continent. If that occurs, then fraud is being perpetrated and an investigation should | | | |
| | ensue. | | | |
| | In the event that the HEV owner lives in an area where the VOPEUSP is being | | | |
| | serviced by an AT2P3S that is separate and distinct from the AT2P3S that services | | | |
| | the HEV owner's employer's primary utility, then the two AT2P3S's need to | | | |
| | communicate so that appropriate charges can be included in the billing. | | | |
| | As previously stated, to the extent that an AT2P3S serves a territory where an HEV | | | |
| | owner engages in a Trust Level 3 charge such that a prepayment of sales tax occurs, | | | |
| | that AT2P3S would need to share the prepayment information with the HEV | | | |
| | owner's VOPEUSP so that the owner can receive appropriate credits on his or her | | | |
| | subsequent bill. Therefore, it will be important for AT2P3S's to share information | | | |
| | relative to VIN charging sessions. | | | |
| | As in other use cases, it is anticipated that the AT2P3S's will perform analytics to | | | |
| | effectively “net” the settlement payments that VOPEUSPs can be required to make | | | |
| | to each other. | | | |
| | Ultimately, the HEV owner will need to engage in a TL1 charge session so that | | | |
| | VMT information can be transmitted to a utility and an AT2P3S for a settlement | | | |
| | process. If the sales tax paid based upon the TL3 charging sessions exceeds the | | | |
| | amount of tax owed attributable to taxable VMT usage fees outstanding upon the | | | |
| | instance of the TL1 settlement process, then the HEV owner will be able to carry the | | | |
| | credit forward to future periods or request a refund. However, if the settlement | | | |
| | process reveals an underpayment of usage fees, then an assessment should be made | | | |
| | as to the extent of the underpayment and the duration of the underpayment. | | | |
| | Regulations should be drafted to provide guidance. | | | |
| | The amount of any penalty imposed for lack of periodic reporting should be | | | |
| | apportioned based upon the portion of the tax owed to the taxing authorities that has | | | |
| | been outstanding during the hiatus of TL1 charging sessions. This pro-ration will be | | | |
| | handled by the AT2P3Ss that are responsible for settlement payments in the | | | |
| | applicable taxing jurisdictions. | | | |
| | The AT2P3Ss will transmit a file/report for the benefit of the VINs to each | | | |
| | respective VOPEUSP or OU so that the respective web portal (or data base in the | | | |
| | case of an OU) can be updated to reflect the tax payments made and the settlement | | | |
| | of those taxes. | | | |
| 12. | Assume that there is an AT2P3S responsible for the VOPEUSP 1 territory, and a | | | |
| | separate AT2P3S responsible for the Other Utility service territory (including | | | |
| | remittance of tax payment to the local tax authorities) in addition to the following | | | |
| | facts: | | | |
| | HEV Owner in one implementation(s) only engages in TL3 charging | | | |
| | sessions | | | |
| | HEV Owner relies on a single charger in an Other Utility service territory | | | |
| | 95% of taxable VMT during a 12 month period occurred in HEV Owner's | | | |
| | VOPEUSP 1 territory | | | |
| | 5% of taxable VMT occurred in the Other Utility service territory | | | |
| | Settlement of VMT usage fees occurs during an annual safety inspection | | | |
| | | | Taxable VMT Driven in Territory of | |
| | | | | Other |
| | | | VOPEUSP 1 | Utility (OU) |
| | HEV 1 Mileage | | 11,400 | 600 |
| | Use Tax @ $0.06 per mile | | $684.00 | |
| | Electricity Purchased via | | | $2,904.00 |
| | TL3 charge session | | | |
| | Sales Tax @ | 30% | | $871.20 |
| | Use Tax @ $0.07 per mile | | | $42.00 |
| | Total owed to Tax Authority 1 | | 684.00 | |
| | Total owed to Tax Authority 2 | | | 42.00 |
| | In this example, the HEV owner has received his or her annual vehicle inspection | | | |
| | notice, and proceeds to the nearest authorized inspection facility to comply with the | | | |
| | regulations (and so that a license renewal occurs). | | | |
| | owner has not engaged in a TL1 charging session since the last annual safety | | | |
| | inspection, and has 12,000 taxable VMT since that time. State law requires a TL1 | | | |
| | session at least every 3,000 taxable VMT, or once every 3 months, without penalty. | | | |
| | In this example, the penalty calculation is based on a series of rules (assumed as | | | |
| | follows): | | | |
| | Is based on the VMT miles driven outside of the taxing territory where sale | | | |
| | tax has been collected | | | |
| | Assumes an even distribution of VMT during the year. | | | |
| | Provides an incremental 5% fee per quarter (compounded) to the taxing | | | |
| | authority to which timely payments were not made. | | | |
| | The attendant will notify the HEV owner of the requirement, and a TL1 session is | | | |
| | initiated at the inspection facility. | | | |
| | The VMT report is transmitted from the HEV VMT Meter Module to the SHEVC, | | | |
| | on to the SHEVC's VOPEUSP, and on to that VOPEUSP's AT2P3S for analysis. | | | |
| | Based upon the VIN, the AT2P3S determines that, over the course of the last 12 | | | |
| | months, the HEV owner has paid (via his or her credit card) $871.20 via TL3 | | | |
| | SHEVC charge sessions. However, upon the engagement of a TL1 session, it is | | | |
| | revealed that the taxable VMT usage fee charges should have amounted to ($684.00 + | | | |
| | $42.00 =) $726.00. | | | |
| | A settlement calculation is generated as follows: | | | |
| | Amount owed to Taxing Authority | | $684.00 | |
| | serving VOPEUSP 1 | | | |
| | Flat Quarterly (3 month) Values | | $171.00 | Q1 Amount |
| | Quarter 2 Penalty | 5% | $8.55 | |
| | | | 179.55 | Q2 Amount |
| | Quarter 3 Penalty | 5% | $8.98 | |
| | | | $188.53 | Q3 Amount |
| | Quarter 4 Penalty | 5% | $9.43 | |
| | | | $197.95 | Q3 Amount |
| | Assuming that this was the only vehicle in the world, the settlement process would | | | |
| | entail petitioning the tax authority that oversees the OU service territory to refund | | | |
| | ($871.20-$42.00) $829.20 to the AT2P3S, which will then see that $710.95 of the | | | |
| | funds are transmitted to the benefit of the tax authority that oversees the VOPEUSP | | | |
| | 1 territory. The remaining ($829.20-$710.95) $118.25 would be reflected as a | | | |
| | credit in the account of the HEV driver (less, potentially, some processing fee). | | | |
| | Note that the OU taxing authority has had the benefit of the full $871.20 during the | | | |
| | 12 month period, and therefore would not be entitled to collect any penalty for | | | |
| | underpayment. | | | |
| | In summary, the HEV owner would have paid sales tax during the year for TL3 | | | |
| | charging sessions in the amount of $871.20. The ultimate disposition of those funds | | | |
| | is: | | | |
| | Taxing Authority for OU | | | $42.00 |
| | Service Territory | | | |
| | Taxing Authority for VOPEUSP 1 | | | |
| | Service Territory | | | |
| | | Tax | $684.00 | |
| | | Penalty | $26.95 | |
| | | Total | $710.95 | $710.95 |
| | Refund to HEV Owner | | | $118.25 |
| | | | | $871.20 |

In practice, the taxing aurthority that collected the sales tax would typically not be
petitioned for a refund (absent a title transfer, death of the HEV owner, or some
other specific circumstance) but rather the AT2P3S(s) would set off future payment
obligations via its ongoing settlement processes.
Summary
There are many benefits to the Actors from the proposed approach:
The HEV Owner
pays in one implementation(s) only for the use of taxable roadways
(not private drives, parking lots, off-road usage);
provides an automated system so periodic manual reports are not
required; and
provides trust level charging options based on HEV owner's
preference and security sensitivity
The VOPEUSP
has further visibility into the load that is on its network, along with
the potential for V2G discharge should the need arise.
The value of its AMI Network is further enhanced, making further
investments in such infrastructure even more palatable to the PUC.
There is the potential that the utility could receive a fee from the
taxing authorities for reimbursement of costs incurred to implement
an HEV information portal, etc.
The use of third party settlement services would relieve a potentially
onerous administrative burden.
The AT2P3S
Sustains a business model: Receives compensation from the tax
authorities to administer the tax collection/settlement/reporting and
remittance functions.
Opportunities for additional service revenues can exist (i.e., can
support the VMT tax clearance process, especially for used HEVs)
Can provide assistance to auditing process
Taxing Authorities
Introduces an automated approach to ensure that HEVs pay their fair
share into roadway construction and maintenance funds
Provides a method to allocate funds based on miles traveled within
specific jurisdictions
Provides a mechanism to establish higher rates for higher
maintenance roadway classifications (e.g., bridges, dams, tunnels).
Provides a mechanism to compensate for the lost time value of
money.

Use Case 5: Multiple HEV Owners/Multiple Primary Electric Utility Service Providers
(VOPEUSP)/Multiple Authorized 3rd Party Processing, Settlement & Storage Service
Centers (AT2P3S); Trust Level 1, 2 and 3 Charging Sessions: Energy Purchase, Sales
Tax and VMT Usage Fee Settlements across the AT2P3S's, VOPEUSPs and HEV
Owners
Goal in Context: Building off of Use Cases 1-4, this Use Case # 5 includes a variety of trust
level charging sessions-both within the HEV's VOPEUSP territory and outside of such
territory, and the settlement process that will occur. The complexity of this Use Case # 5
will demonstrate the value of the AT2P3S's in settling payments between VOPEUSP's and
facilitating payments to taxing authorities.

| | |
|---|---|
| Scope: | VMT occurs throughout multiple taxing jurisdictions. |
| Level: | Trust Levels 1, 2 & 3 |
| Preconditions: | Potential HEV owner commits and purchases or leases an HEV and has |
| | access to a Smart Hybrid-electric Vehicle Charger (“SHEVC”) that includes |
| | communication capabilities that are interoperable with the VOPEUSP meter |
| | or a VOPEUSP supported Home Area Network (HAN) or Local Area |
| | Network (LAN) |
| Success End | An accurate utility bill which can reflect energy purchased from a utility that |
| Condition: | is not the HEV owner's VOPEUSP, credit for sales tax (if any) and a VMT |
| | usage fee, as appropriate, with any associated penalties or fees included |
| | within utility bill; privacy maintained. |
| Failed End | Inaccurate billing and/or disclosure of confidential information to |
| Condition: | unauthorized recipients. |
| Primary | [HEV Seller] HEV Buyer/Owners, HEVs, SHEVCs, AMI Meters, AMI |
| Actors: | Network(s), Han or LAN, VOPEUSPs, Authorized 3rd Party Data Processing |
| | & Storage Centers, Taxing Authorities |
| Trigger: | HEV Charging Session |

MAIN SUCCESS SCENARIO

| 1. | Generally, the Success Attributes of Use Cases 1-4 are considered as applicable to | | | | | | | | | |
|---|---|---|---|---|---|---|---|---|---|---|
| | this Use Case # 5, as this Use Case demonstrates the complex ecosystem of various | | | | | | | | | |
| | trust level charge sessions across several different utility service territories that are | | | | | | | | | |
| | located in a mix of taxing jurisdictions. | | | | | | | | | |
| | This Use Case assumes that the HEV owner (or lessee) has registered its HEV with an | | | | | | | | | |
| | appropriate VOPEUSP and has access to a commissioned TL1 SHEVC that is capable | | | | | | | | | |
| | of transmitting VMT usage fee related reports. This Use Case also deals with a variety | | | | | | | | | |
| | of “time frequencies” with which an HEV Owner can initiate a TL1 session, and | | | | | | | | | |
| | describes the potential for fines or penalties associated with infrequent reporting of | | | | | | | | | |
| | taxable VMT. | | | | | | | | | |
| 2. | As indicated in the recitals section, this Use Case considers TL1, TL2 and TL3 | | | | | | | | | |
| | charging sessions. This Use Case provides an example of the fee calculations for each | | | | | | | | | |
| | Trust Level, and then presents a summarization of the charges to be considered by the | | | | | | | | | |
| | various AT2P3Ss during the settlement process. The following table provides | | | | | | | | | |
| | assumed VMT reported during TL1 charging sessions for purposes of this broader | | | | | | | | | |
| | example: | | | | | | | | | |
| | Trust Level 1 Charging | | | | | | | | | |
| | | | Taxable Vehicle Miles Traveled | | | | | | AT2P3S4 | Total |
| | | | AT2P3S 1 | | AT2P3S 2 | | AT2P3S 3 | | G | Miles |
| | Utility Territory | | A | B | C | D | E | F | AR | Driven |
| | State | | MO | MO | KS | KS | IL | IL | | |
| | HEV Owner's | | | | | | | | | |
| | Primary Utility | | | | | | | | | |
| | HEV 1 | A | — | — | | | — | | | |
| | MO Interstate Highways | | 95 | 65 | | | | | | 160 |
| | MO Bridges | | 2 | 1 | | | | | | 3 |
| | MO Local Roads | | 53 | 34 | | | | | | 87 |
| | IL Interstate Highways | | | | | | 60 | | | 60 |
| | IL Bridges | | | | | | 2 | | | 2 |
| | IL Local Roads | | | | | | 18 | | | 18 |
| | HEV 2 | B | | | | | | | | |
| | MO Interstate Highways | | 85 | | | | | | | 85 |
| | MO Bridges | | 3 | | | | | | | 3 |
| | MO Local Roads | | 12 | | | | | | | 12 |
| | AR Interstate Highways | | | | | | | | 60 | 60 |
| | AR Bridges | | | | | | | | 3 | 3 |
| | AR Local Roads | | | | | | | | 30 | 30 |
| | KS Interstate Highways | | | | 94 | 75 | | | | 169 |
| | KS Bridges | | | | 3 | 2 | | | | 5 |
| | KS Local Roads | | | | 3 | 23 | | | | 26 |
| | IL Interstate Highways | | | | | | 40 | | | 40 |
| | IL Bridges | | | | | | 5 | | | 5 |
| | IL Local Roads | | | | | | 55 | | | 55 |
| | HEV 3 | C | | | | | | | | |
| | KS Interstate Highways | | | | 80 | | | | | 80 |
| | KS Bridges | | | | 4 | | | | | 4 |
| | KS Local Roads | | | | 91 | | | | | 91 |
| | IL Interstate Highways | | | | | | | 5 | | 5 |
| | IL Bridges | | | | | | | 1 | | 1 |
| | IL Local Roads | | | | | | | 14 | | 14 |
| | HEV 4* | D | | | | | | | | |
| | HEV 5 | E | | | | | | | | |
| | MO Interstate Highways | | 40 | 45 | | | | | | 85 |
| | MO Bridges | | 1 | 3 | | | | | | 4 |
| | MO Local Roads | | 4 | 27 | | | | | | 31 |
| | IL Interstate Highways | | | | | | 55 | | | 55 |
| | IL Bridges | | | | | | 3 | | | 3 |
| | IL Local Roads | | | | | | 32 | | | 32 |
| | HEV 6 | F | | | | | | | | 85 |
| | IL Interstate Highways | | | | | | | 2 | | 2 |
| | IL Bridges | | | | | | | 53 | | 53 |
| | IL Local Roads | | | | | | | | | |
| | HEV 7 ** | A | | | | | | | | |

| | IL Interstate Highways | | | | | 195 | 20 | | | | 215 |
|---|---|---|---|---|---|---|---|---|---|---|---|
| | IL Bridges | | | | | 5 | 2 | | | | 7 |
| | IL Local Roads | | | | | | 28 | | | | 28 |
| | | 195 | 275 | 275 | 100 | 470 | 210 | 93 | | | 1,618 |
| | *In this example, HEV4 will not engage in TL1 or TL2 charging sessions often, as the | | | | | | | | | | |
| | owner resides in a multi-tenant building and works in an area where SHEVCs are not | | | | | | | | | | |
| | “secure”. In this example, there are a total of 7 HEV Owners that are serviced by 6 | | | | | | | | | | |
| | separate utilities (A-F). A seventh utility (G) does not act as a VOPEUSP for any of | | | | | | | | | | |
| | the HEV owners. The utilities have contracted with 4 different AT2P3S's to assist | | | | | | | | | | |
| | them with settlements with other utilities and for compliance with both sales and usage | | | | | | | | | | |
| | fee reporting purposes. The states that will be owed taxes for VMT include Missouri | | | | | | | | | | |
| | (MO), Kansas (KS), Illinois (IL) and Arkansas (AR). | | | | | | | | | | |
| | ** Assumes that HEV 7 owner is on vacation, incurring miles during the entire billing | | | | | | | | | | |
| | period outside of his or her VOPEUSP. | | | | | | | | | | |
| 3. | For purposes of calculating VMT Usage Fees, we will assume that the following | | | | | | | | | | |
| | Usage Fee rate schedule is in effect: | | | | | | | | | | |
| | | VMT Usage Fee per “Taxable Mile” | | | | | | | | | |
| | State | MO | | AR | | KS | | IL | | | |
| | Federal Interstate | $0.010 | | | | | | | | | |
| | MO Interstate Highways | $0.015 | | | | | | | | | |
| | MO Bridges | $0.050 | | | | | | | | | |
| | MO Local Roads | $0.0075 | | | | | | | | | |
| | AR Interstate Highways | | | $0.016 | | | | | | | |
| | AR Bridges | | | $0.0525 | | | | | | | |
| | AR Local Roads | | | $0.0078 | | | | | | | |
| | KS Interstate Highways | | | | | $0.017 | | | | | |
| | KS Bridges | | | | | $0.055 | | | | | |
| | KS Local Roads | | | | | $0.0080 | | | | | |
| | IL Interstate Highways | | | | | | | $0.020 | | | |
| | IL Bridges | | | | | | | $0.070 | | | |
| | IL Local Roads | | | | | | | $0.0084 | | | |
| 4. | The following table calculates the usage fees owed by the respective HEV Owners (to | | | | | | | | | | |
| | the state collection agencies) and the utilities that will be responsible for collecting | | | | | | | | | | |
| | such fees: | | | | | | | | | | |
| | Utility Territory | A | B | C | D | E | F | G | Fed- | State | |
| | State | MO | MO | KS | KS | IL | IL | AR | eral | Totals | |
| | HEV 1 MO Highways | 1.425 | 0.975 | | | | | | 1.600 | 2.400 | |
| | MO Bridges | 0.100 | 0.050 | | | | | | | 0.150 | |
| | MO Local Roads | 0.398 | 0.255 | | | | | | | 0.653 | |
| | IL Highways | | | | | 1.200 | | | 0.600 | 1.200 | |
| | IL Bridges | | | | | 0.140 | | | | 0.140 | |
| | IL Local Rds | | | | | 0.151 | | | | 0.151 | |
| | | 1.923 | 1.280 | — | — | 1.491 | — | — | 2.200 | 4.694 | 6.89 |
| | HEV 2 | | | | | | | | | — | |
| | MO Highways | | 1.275 | | | | | | 0.850 | 1.275 | |
| | MO Bridges | | 0.150 | | | | | | | 0.150 | |
| | MO Local Roads | | 0.090 | | | | | | | 0.090 | |
| | AR Interstate Hwys | | | | | | | 0.960 | 0.600 | 0.960 | |
| | AR Bridges | | | | | | | 0.158 | | 0.158 | |
| | AR Local Roads | | | | | | | 0.233 | | 0.233 | |
| | KS Highways | | | 1.598 | 1.275 | | | | 1.690 | 2.873 | |
| | KS Bridges | | | 0.165 | 0.110 | | | | | 0.275 | |
| | KS Local Roads | | | 0.024 | 0.184 | | | | | 0.208 | |
| | IL Highways | | | | | 0.800 | | | 0.400 | 0.800 | |
| | IL Bridges | | | | | 0.350 | | | | 0.350 | |
| | IL Local Roads | | | | | 0.462 | | | | | |
| | | — | 1.515 | 1.787 | 1.569 | 1.612 | — | 1.350 | 3.540 | 7.833 | 11.37 |
| | HEV 3 KS Highways | | | 1.360 | | | | | 0.800 | 1.360 | |
| | KS Bridges | | | 0.220 | | | | | | 0.220 | |
| | KS Local Roads | | | 0.728 | | | | | | 0.728 | |
| | IL Highways | | | | | | 0.100 | | 0.050 | 0.100 | |
| | IL Bridges | | | | | | 0.070 | | | 0.070 | |
| | IL Local Roads | | | | | | 0.118 | | | 0.118 | |
| | | — | — | 2.308 | — | — | 0.288 | — | 0.850 | 2.596 | 3.45 |
| | HEV 5 MO Highways | 0.600 | 0.675 | | | | | | 0.850 | 1.275 | |
| | MO Bridges | 0.050 | 0.150 | | | | | | | 0.200 | |
| | MO Local Roads | 0.030 | 0.203 | | | | | | | 0.233 | |
| | IL Highways | | | | | 1.100 | | | 0.550 | 1.100 | |
| | IL Bridges | | | | | 0.210 | | | | 0.210 | |
| | IL Local Roads | | | | | 0.269 | | | | 0.269 | |
| | | 0.680 | 1.025 | — | — | 1.579 | — | — | 1.400 | 3.286 | 4.69 |
| | HEV 6 IL Highways | | | | | | 1.700 | | 0.850 | 1.700 | |
| | IL Bridges | | | | | | 0.140 | | | 0.140 | |
| | IL Local Roads | | | | | | 0.445 | | | 0.445 | |
| | | — | — | — | — | — | 2.285 | — | 0.850 | 2.285 | 3.14 |
| | HEV 7 IL Highways | | | | | 3.900 | 0.400 | | 2.150 | 4.300 | |
| | IL Bridges | | | | | 0.350 | 0.140 | | | 0.490 | |
| | IL Local Roads | | | | | — | 0.235 | | | 0.235 | |
| | | — | — | — | — | 4.250 | 0.775 | — | 2.150 | 5.025 | 7.18 |

| 5. | A summary of the TL1 Usage Fee Calculations follows: | | | | | | | | |
|---|---|---|---|---|---|---|---|---|---|
| | Summary of TL1 Usage Fee Calculations | | | | | | | | |
| | Collected by Utility: | A | B | C | D | E | F | G | Totals |
| | HEV 1 | 6.894 | | | | | | | 6.894 |
| | HEV 2 | | 11.373 | | | | | | 11.373 |
| | HEV 3 | | | 3.446 | | | | | 3.446 |
| | HEV 5 | | | | | 4.686 | | | 4.686 |
| | HEV 6 | | | | | | 3.135 | | 3.135 |
| | HEV 7 | 7.175 | | | | | | | 7.175 |
| | Totals | 14.069 | 11.373 | 3.446 | — | 4.686 | 3.135 | — | 36.709 |
| | Transferred to: | | | | | | | | |
| | AT2P3S 1 | 14.069 | 11.373 | | | | | | 25.442 |
| | AT2P3S 2 | | | 3.446 | | | | | 3.446 |
| | AT2P3S 3 | | | | | 4.686 | 3.135 | | 7.822 |
| | | 14.069 | 11.373 | 3.446 | — | 4.686 | 3.135 | | 36.709 |
| | Owed to: | | | | | | | | |
| | Fed | (4.350) | (3.540) | (0.850) | | (1.400) | (0.850) | | (10.990) |
| | MO | (3.203) | (1.515) | | | (1.708) | | | (6.425) |
| | AR | | | | | | | (1.350) | (1.350) |
| | KS | | (3.356) | (2.308) | | | | | (5.664) |
| | IL | (6.516) | (1.612) | (0.288) | | (1.579) | (2.285) | | (12.280) |
| | | (14.069) | (10.023) | (3.446) | — | (4.686) | (3.135) | (1.350) | (36.709) |

| | The segments of this summary show that, overall, VMT usage fee totaling $36.71 | | | | | | | | |
|---|---|---|---|---|---|---|---|---|---|
| | should be collected by the VOPEUSPs during the billing period relative to 6 of the 7 | | | | | | | | |
| | vehicles (HEV 4 excluded). The VOPEUSPs transfer the collected taxes to 3 of the | | | | | | | | |
| | AT2P3Ss for processing and settlement, and the AT2P3Ss-absent settlements related | | | | | | | | |
| | to TL2 and TL3 charge sessions-would then initiate payments to the collection | | | | | | | | |
| | agencies as shown above, in an amount totaling $36.71. | | | | | | | | |
| 6. | This Use Case continues on to consider an example of TL2 charging sessions | | | | | | | | |
| | occurring during the period. Assume the following TL2 charges during the considered | | | | | | | | |
| | billing period: | | | | | | | | |
| | | | | | | | | | Total |
| | | Base energy $$ payable for session(s) | | | | | | | External |
| | | AT2P3S 1 | | AT2P3S 2 | | AT2P3S 3 | | AT2P3S4 | AT2P3S |
| | Utility Territory | A | B | C | D | E | F | G | Settlement |
| | HEV Owner's | | | | | | | | |
| | Primary Utility | | | | | | | | |
| | HEV 1 A | | | | $20.0 | | | | $20.0 |
| | HEV 2 B | | | | $15.0 | | | $15.0 | $30.0 |
| | HEV 3 C | | | | | | | | — |
| | HEV 4* D | | | $40.0 | $60.0 | | | | — |
| | HEV 5 E | | | | $10.0 | | | | $10.0 |
| | HEV 6 F | | | | | | | | — |
| | HEV 7 ** A | | | | | | | | — |
| | | $- | $- | $40.0 | $105.0 | $- | $- | $- | $60.0 |

| | In this example, TL2 Energy Charges for Utility A & B Customers (HEV 1 & HEV 2, | | | | |
|---|---|---|---|---|---|
| | respectively) occur outside of AT2P3S 1 Service Territory; the charge of $20 for HEV | | | | |
| | 1 is billed by Utility D through AT2P3S2 which settles with AT2P3S1. AT2P3S1 | | | | |
| | instructs Utility A (in its service territory) to bill HEV 1. | | | | |
| | Similarly, Utility G notifies AT2P3S 4 that HEV 2 (via its VIN) has purchased on | | | | |
| | account $15 of energy; AT2P3S 4 identifies the VIN as belonging to AT2P3S 1 and | | | | |
| | initiates a settlement charge; AT2P3S 1 pushes a charge of $15 to Utility B for HEV | | | | |
| | 2's purchase of energy from Utility G. | | | | |
| | Likewise, Utility D notifies AT2P3S 3 that HEV 2 (via its VIN) has purchased on | | | | |
| | account $15 of energy; AT2P3S 3 identifies the VIN as belonging to AT2P3S 1 and | | | | |
| | initiates a settlement charge; AT2P3S 1 pushes a charge of $15 to Utility B for HEV | | | | |
| | 2's purchase of energy from Utility D. | | | | |
| | During the period, the owner of HEV 4 purchases $40 of electricity from Utility C. | | | | |
| | Utility C notifies its AT2P3S 2 that a sale has been made to HEV 4 as designated by | | | | |
| | its VIN. AT2P3S 2 identifies HEV 4 as having registered with VOPEUSP D, which is | | | | |
| | within its service territory. AT2P3S settles the charge between utilities C and D, | | | | |
| | instructing utility D to include the $40 purchase in the HEV 4 owners billing. | | | | |
| | Also during the period, HEV 4 owner purchases $60 of energy within its VOPEUSP | | | | |
| | territory. The SHEVC notifies Utility D of the charges, Utility D notifies AT2PS3 2 | | | | |
| | of the VIN; AT2P3S 2 informs Utility D that HEV 4 is a customer of Utility D, and | | | | |
| | advised Utility D to include the $60 charge in its next scheduled bill to the owner of | | | | |
| | HEV 4. | | | | |
| 7. | For purposes of calculating deferred TL2 Sales taxes, and the actual TL3 Sales taxes, | | | | |
| | we will assume that the following Sales Tax rate schedule is in effect: | | | | |
| | VMT Sales Rate on HEV Electricity Purchases | | | | |
| | 15% | 15% | 15% | 15% | |
| | MO | AR | KS | IL | |
| | 15% | | | | |
| | 15% | | | | |
| | 15% | | | | |
| | | 14% | | | |
| | | 14% | | | |
| | | 14% | | | |
| | | | 15% | | |
| | | | 15% | | |
| | | | 15% | | |
| | | | | | 17% |
| | | | | | 17% |
| | | | | | 17% |

| The tentative TL2 sales tax calculation (which information will be stored in the | | | | | | | | | | |
|---|---|---|---|---|---|---|---|---|---|---|
| memory of the HEV VMT Meter Module until a TL1 charging session settlement | | | | | | | | | | |
| occurs) would be as follows: | | | | | | | | | | |
| Tentative TL2 Tax Calculation | | | | | | | | | | |
| | | Base energy $$ payable for session(s) | | | | | | AT2P3S | | |
| | | AT2P3S 1 | | AT2P3S 2 | | AT2P3S 3 | | 4 | | Total |
| Utility Territory | | A | B | C | D | E | F | G | | Payable |
| State | | MO | MO | KS | KS | IL | IL | AR | Federal | to States |
| | HEV | | | | | | | | | |
| | Owner's | | | | | | | | | |
| | Primary | | | | | | | | | |
| | Utility | | | | | | | | | |
| HEV 1 | A | | | | $3.00 | | | | $3.00 | $3.00 |
| HEV 2 | B | | | | $2.25 | | | $2.10 | $4.50 | $4.35 |
| HEV 3 | C | | | | | | | | | |
| HEV 4* | D | | | $6.00 | $9.00 | | | | $2.25 | $15.00 |
| HEV 5 | E | | | | $10.00 | | | | $1.20 | $10.00 |
| HEV 6 | F | | | | | | | | | |
| HEV 7** | A | | | | | | | | | |
| | | $- | $- | $6.00 | $24.25 | $- | $- | $2.10 | $11.25 | $32.25 |

| 8. | This Use Case continues on to consider an example of TL3 charging sessions | | | | | | | | |
|---|---|---|---|---|---|---|---|---|---|
| | occurring during the period. The assumed TL3 charges and associated Sales Tax | | | | | | | | |
| | during the billing period follows: | | | | | | | | |
| | Trust Level 3 Charging | | | | | | | | |
| | | | | | | Sales Tax Rate on | | | |
| | | | | | | HEV | | | |
| | VMT Usage Tax per Taxable Mile | | | | | Electricity Purchases | | | |
| | Federal Insterstate | $0.010 | | | | 15% | 15% | 15% | 15% |
| | State | MO | AR | KS | IL | MO | AR | KS | IL |
| | MO Interstate Highways | $0.015 | | | | 15% | | | |
| | MO Bridges | $0.050 | | | | 15% | | | |
| | MO Local Roads | $0.0075 | | | | 15% | | | |
| | AR Interstate Highways | | $0.016 | | | | 14% | | |
| | AR Bridges | | $0.0525 | | | | 14% | | |
| | AR Local Roads | | $0.0078 | | | | 14% | | |
| | KS Interstate Highways | | | | | | | 15% | |
| | KS Bridges | | | | | | | 15% | |
| | KS Local Roads | | | | | | | 15% | |
| | IL Interstate Highways | | | | | | | | 17% |
| | IL Bridges | | | | | | | | 17% |
| | IL Local Roads | | | | | | | | 17% |

| Prepaid base energy $$ for sessions(s) | | | | | | | | | | |
|---|---|---|---|---|---|---|---|---|---|---|
| | | | | | | | | AT2P3S | | Total |
| | | AT2P3S 1 | | AT2P3S 2 | | AT2P3S 3 | | 4 | Fed- | Payable |
| Utility Territory | | A | B | C | D | E | F | G | eral | to States |
| | HEV | | | | | | | | | |
| | Owner's | | | | | | | | | |
| | Primary | | | | | | | | | |
| | Utility | | | | | | | | | |
| HEV 1 | A | | | $30.0 | | | | | | $30.0 |
| HEV 2 | B | | | | | $20.0 | | | | $20.0 |
| HEV 3 | C | | | | | | | | | |
| HEV 4* | D | | | | | $25.0 | | | | $25.0 |
| HEV 5 | E | | | | | | | | | |
| HEV 6 | F | | | | | | | | | |
| HEV 7** | A | | | | $25.0 | | | | | $25.0 |
| | | $- | $- | $30.0 | $25.0 | $45.0 | $- | $- | | $100.0 |

| *Owner lives in an apartment complex | | |
|---|---|---|
| *Owner on vacation; engages with a LT1 SHEVC in a remote location. | | |
| TL3 Tax Calculation | | |
| | Sale Taxes collected on Base energy $$ purchased | |
| | with credit or debit card | Total |
| | AT2P3S | Payable |

| | | | | |
|---|---|---|---|---|
| 1 | AT2P3S 2 | AT2P3S 3 | AT2P3S4 | to |

| | | | | | | | | |
|---|---|---|---|---|---|---|---|---|
| Utility Territory | A | B | C | D | E | F | G | States |

| State | | MO | MO | KS | KS | IL | IL | AR | Federal | AR |
|---|---|---|---|---|---|---|---|---|---|---|
| | HEV | | | | | | | | | |
| | Owner's | | | | | | | | | |
| | Primary | | | | | | | | | |
| | Utility | | | | | | | | | |
| HEV 1 | A | | | $4.50 | | | | | $4.50 | $4.50 |
| HEV 2 | B | | | | | $3.40 | | | $3.00 | $3.40 |
| HEV 3 | C | | | | | | | | | |
| HEV 4* | D | | | | | $4.25 | | | | |
| HEV 5 | E | | | | | | | | | |
| HEV 6 | F | | | | | | | | | |
| HEV 7** | A | | | $3.75 | | | | | $3.75 | $3.75 |
| | | $- | $- | $4.50 | $3.75 | $7.65 | $- | $- | $15.00 | $100.0 |

| 9. | The AT2P3Ss will receive the VMT information and TL2 energy purchase | | | | | | | | |
|---|---|---|---|---|---|---|---|---|---|
| | information from the VOPEUSPs that it serves, which collects the data from SHEVCs | | | | | | | | |
| | within their respective service territories. | | | | | | | | |
| | The AT2P3Ss will process the data to determine the amount of tax that should be paid | | | | | | | | |
| | to the taxing authorities on behalf of the client VOPEUSPs and their HEV owner/ | | | | | | | | |
| | lessee customers. Further, the AT2P3Ss will determine the amount of tax and energy | | | | | | | | |
| | purchases owed to other AT2P3Ss, so that an effective “netting” can take place that | | | | | | | | |
| | will minimize cash transfers. | | | | | | | | |
| | Setting aside the Federal Tax payments, which on the surface do not require inter- | | | | | | | | |
| | AT2P3S settlement, the Non-Federal TL1 Charging settlement analyses driven by the | | | | | | | | |
| | aforementioned assumptions would be as follows: | | | | | | | | |
| | Non Federal Tax Analysis TL1 Charging | | | | | | | | |
| | | 1 | 1 | 1 | 1 | 2 | 2 | 2 | 2 |
| | | Re- | owes | owes | owes | Re- | owes | owes | owes |
| | | tains | 2 | 3 | 4 | tains | 1 | 3 | 4 |
| | Tax Owed | 3.203 | | | | | | | |
| | by HEV 1, | | | | | | | | |
| | Colletected | | | | | | | | |
| | by AT2P3S | | | | | | | | |
| | 1 owed to | | | | | | | | |
| | AT2P3S 1 | | | | | | | | |
| | Tax Owed | | | | | | | | |
| | by HEV 1, | | | | | | | | |
| | Colletected | | | | | | | | |
| | by AT2P3S | | | | | | | | |
| | 1 owed to | | | | | | | | |
| | AT2P3S 2 | | | | | | | | |
| | Tax Owed | | | 1.491 | | | | | |
| | by HEV 1, | | | | | | | | |
| | Colletected | | | | | | | | |
| | by AT2P3S | | | | | | | | |
| | 1 owed to | | | | | | | | |
| | AT2P3S 3 | | | | | | | | |
| | Tax Owed | 1.515 | | | | | | | |
| | by HEV 2, | | | | | | | | |
| | Colletected | | | | | | | | |
| | by AT2P3S | | | | | | | | |
| | 1 owed to | | | | | | | | |
| | AT2P3S 1 | | | | | | | | |
| | Tax Owed | | 3.356 | | | | | | |
| | by HEV 2, | | | | | | | | |
| | Colletected | | | | | | | | |
| | by AT2P3S | | | | | | | | |
| | 1 owed to | | | | | | | | |
| | AT2P3S 2 | | | | | | | | |
| | Tax Owed | | | 1.612 | | | | | |
| | by HEV 2, | | | | | | | | |
| | Colletected | | | | | | | | |
| | by AT2P3S | | | | | | | | |
| | 1 owed to | | | | | | | | |
| | AT2P3S 3 | | | | | | | | |
| | Tax Owed | | | | 1.350 | | | | |
| | by HEV 2, | | | | | | | | |
| | Colletected | | | | | | | | |
| | by AT2P3S | | | | | | | | |
| | 1 owed to | | | | | | | | |
| | AT2P3S 4 | | | | | | | | |
| | Tax Owed | | | | | 2.308 | | | |
| | by HEV 3, | | | | | | | | |
| | Colletected | | | | | | | | |
| | by AT2P3S | | | | | | | | |
| | 2 owed to | | | | | | | | |
| | AT2P3S 2 | | | | | | | | |
| | Tax Owed | | | | | | | | |
| | by HEV 3, | | | | | | | | |
| | Colletected | | | | | | | | |
| | by AT2P3S | | | | | | | | |
| | 2 owed to | | | | | | | | |
| | AT2P3S 1 | | | | | | | | |
| | Tax Owed | | | | | | | 0.288 | |
| | by HEV 3, | | | | | | | | |
| | Colletected | | | | | | | | |
| | by AT2P3S | | | | | | | | |
| | 2 owed to | | | | | | | | |
| | AT2P3S 3 | | | | | | | | |
| | Tax Owed | | | | | | | | |
| | by HEV 5, | | | | | | | | |
| | Colletected | | | | | | | | |
| | by AT2P3S | | | | | | | | |
| | 3 owed to | | | | | | | | |
| | AT2P3S 3 | | | | | | | | |
| | Tax Owed | | | | | | | | |
| | by HEV 5, | | | | | | | | |
| | Colletected | | | | | | | | |
| | by AT2P3S | | | | | | | | |
| | 3 owed to | | | | | | | | |
| | AT2P3S 1 | | | | | | | | |
| | Tax Owed | | | | | | | | |
| | by HEV 5, | | | | | | | | |
| | Colletected | | | | | | | | |
| | by AT2P3S | | | | | | | | |
| | 3 owed to | | | | | | | | |
| | AT2P3S 2 | | | | | | | | |
| | Tax Owed | | | | | | | | |
| | by HEV 6, | | | | | | | | |
| | Colletected | | | | | | | | |
| | by AT2P3S | | | | | | | | |
| | 3 owed to | | | | | | | | |
| | AT2P3S 3 | | | | | | | | |
| | Tax Owed | | | | | | | | |
| | by HEV 6, | | | | | | | | |
| | Colletected | | | | | | | | |
| | by AT2P3S | | | | | | | | |
| | 3 owed to | | | | | | | | |
| | AT2P3S 1 | | | | | | | | |
| | Tax Owed | | | | | | | | |
| | by HEV 6, | | | | | | | | |
| | Colletected | | | | | | | | |
| | by AT2P3S | | | | | | | | |
| | 3 owed to | | | | | | | | |
| | AT2P3S 2 | | | | | | | | |
| | Tax Owed | | | | | | | | |
| | by HEV 7, | | | | | | | | |
| | Colletected | | | | | | | | |
| | by AT2P3S | | | | | | | | |
| | 1 owed to | | | | | | | | |
| | AT2P3S 1 | | | | | | | | |
| | Tax Owed | | | | | | | | |
| | by HEV 7, | | | | | | | | |
| | Colletected | | | | | | | | |
| | by AT2P3S | | | | | | | | |
| | 1 owed to | | | | | | | | |
| | AT2P3S 2 | | | | | | | | |
| | Tax Owed | | | 5.025 | | | | | |
| | by HEV 7, | | | | | | | | |
| | Colletected | | | | | | | | |
| | by AT2P3S | | | | | | | | |
| | 1 owed to | | | | | | | | |
| | AT2P3S 3 | | | | | | | | |
| | | 4.718 | 3.356 | 8.128 | 1.350 | 2.308 | — | 0.288 | |
| | Settlement | | (3.356) | | | | 3.356 | | |
| | of 1 and 2- | | | | | | | | |
| | 1 pays 2 | | | | | | | | |
| | Settlement | | | (6.421) | | | | | |
| | of 1 and 3- | | | | | | | | |
| | 1 pays 3 | | | | | | | | |
| | Settlement | | | | (1.350) | | | | |
| | of 1 and 4- | | | | | | | | |
| | 1 pays 4 | | | | | | | | |
| | Settlement | | | | | | | (0.288) | |
| | of 2 and 3- | | | | | | | | |
| | 2 pays 3 | | | | | | | | |
| | | 4.718 | — | 1.708 | — | 2.308 | 3.356 | — | |
| | | AT2P3S 1 $$ Post | | | | AT2P3S 2 $$ Post | | | |
| | | Settlement | | | | Settlement | | | |
| | Total $$ | | | 6.43 | | | | 5.66 | |
| | Settled | | | | | | | | |
| | Relative to | | | | | | | | |
| | AT2P3S | | | | | | | | |
| | | | | MO | | | | KS | |
| | Non Federal Tax Analysis TL1 Charging | | | | | | | | |
| | | 3 | 3 | 3 | 3 | 4 | 4 | 4 | 4 |
| | | Re- | owes | owes | owes | Re- | owes | owes | owes |
| | | tains | 1 | 2 | 4 | tains | 1 | 2 | 3 |
| | Tax Owed | | | | | | | | |
| | by HEV 1, | | | | | | | | |
| | Colletected | | | | | | | | |
| | by AT2P3S | | | | | | | | |
| | 1 owed to | | | | | | | | |
| | AT2P3S 1 | | | | | | | | |
| | Tax Owed | | | | | | | | |
| | by HEV 1, | | | | | | | | |
| | Colletected | | | | | | | | |
| | by AT2P3S | | | | | | | | |
| | 1 owed to | | | | | | | | |
| | AT2P3S 2 | | | | | | | | |
| | Tax Owed | | | | | | | | |
| | by HEV 1, | | | | | | | | |
| | Colletected | | | | | | | | |
| | by AT2P3S | | | | | | | | |
| | 1 owed to | | | | | | | | |
| | AT2P3S 3 | | | | | | | | |
| | Tax Owed | | | | | | | | |
| | by HEV 2, | | | | | | | | |
| | Colletected | | | | | | | | |
| | by AT2P3S | | | | | | | | |
| | 1 owed to | | | | | | | | |
| | AT2P3S 1 | | | | | | | | |
| | Tax Owed | | | | | | | | |
| | by HEV 2, | | | | | | | | |
| | Colletected | | | | | | | | |
| | by AT2P3S | | | | | | | | |
| | 1 owed to | | | | | | | | |
| | AT2P3S 2 | | | | | | | | |
| | Tax Owed | | | | | | | | |
| | by HEV 2, | | | | | | | | |
| | Colletected | | | | | | | | |
| | by AT2P3S | | | | | | | | |
| | 1 owed to | | | | | | | | |
| | AT2P3S 3 | | | | | | | | |
| | Tax Owed | | | | | | | | |
| | by HEV 2, | | | | | | | | |
| | Colletected | | | | | | | | |
| | by AT2P3S | | | | | | | | |
| | 1 owed to | | | | | | | | |
| | AT2P3S 4 | | | | | | | | |
| | Tax Owed | | | | | | | | |
| | by HEV 3, | | | | | | | | |
| | Colletected | | | | | | | | |
| | by AT2P3S | | | | | | | | |
| | 2 owed to | | | | | | | | |
| | AT2P3S 2 | | | | | | | | |
| | Tax Owed | | | | | | | | |
| | by HEV 3, | | | | | | | | |
| | Colletected | | | | | | | | |
| | by AT2P3S | | | | | | | | |
| | 2 owed to | | | | | | | | |
| | AT2P3S 1 | | | | | | | | |
| | Tax Owed | | | | | | | | |
| | by HEV 3, | | | | | | | | |
| | Colletected | | | | | | | | |
| | by AT2P3S | | | | | | | | |
| | 2 owed to | | | | | | | | |
| | AT2P3S 3 | | | | | | | | |
| | Tax Owed | 1.579 | | | | | | | |
| | by HEV 5, | | | | | | | | |
| | Colletected | | | | | | | | |
| | by AT2P3S | | | | | | | | |
| | 3 owed to | | | | | | | | |
| | AT2P3S 3 | | | | | | | | |
| | Tax Owed | | 1.708 | | | | | | |
| | by HEV 5, | | | | | | | | |
| | Colletected | | | | | | | | |
| | by AT2P3S | | | | | | | | |
| | 3 owed to | | | | | | | | |
| | AT2P3S 1 | | | | | | | | |
| | Tax Owed | | | | | | | | |
| | by HEV 5, | | | | | | | | |
| | Colletected | | | | | | | | |
| | by AT2P3S | | | | | | | | |
| | 3 owed to | | | | | | | | |
| | AT2P3S 2 | | | | | | | | |
| | Tax Owed | 2.285 | | | | | | | |
| | by HEV 6, | | | | | | | | |
| | Colletected | | | | | | | | |
| | by AT2P3S | | | | | | | | |
| | 3 owed to | | | | | | | | |
| | AT2P3S 3 | | | | | | | | |
| | Tax Owed | | | | | | | | |
| | by HEV 6, | | | | | | | | |
| | Colletected | | | | | | | | |
| | by AT2P3S | | | | | | | | |
| | 3 owed to | | | | | | | | |
| | AT2P3S 1 | | | | | | | | |
| | Tax Owed | | | | | | | | |
| | by HEV 6, | | | | | | | | |
| | Colletected | | | | | | | | |
| | by AT2P3S | | | | | | | | |
| | 3 owed to | | | | | | | | |
| | AT2P3S 2 | | | | | | | | |
| | Tax Owed | | | | | | | | |
| | by HEV 7, | | | | | | | | |
| | Colletected | | | | | | | | |
| | by AT2P3S | | | | | | | | |
| | 1 owed to | | | | | | | | |
| | AT2P3S 1 | | | | | | | | |
| | Tax Owed | | | | | | | | |
| | by HEV 7, | | | | | | | | |
| | Colletected | | | | | | | | |
| | by AT2P3S | | | | | | | | |
| | 1 owed to | | | | | | | | |
| | AT2P3S 2 | | | | | | | | |
| | Tax Owed | | | | | | | | |
| | by HEV 7, | | | | | | | | |
| | Colletected | | | | | | | | |
| | by AT2P3S | | | | | | | | |
| | 1 owed to | | | | | | | | |
| | AT2P3S 3 | | | | | | | | |
| | | 3.864 | 1.708 | — | | | | | |
| | Settlement | | | | | | | | |
| | of 1 and 2- | | | | | | | | |
| | 1 pays 2 | | | | | | | | |
| | Settlement | | 6.421 | | | | | | |
| | of 1 and 3- | | | | | | | | |
| | 1 pays 3 | | | | | | | | |
| | Settlement | | | | | | 1.350 | | |
| | of 1 and 4- | | | | | | | | |
| | 1 pays 4 | | | | | | | | |
| | Settlement | | | 0.288 | | | | | |
| | of 2 and 3- | | | | | | | | |
| | 2 pays 3 | | | | | | | | |
| | | 3.864 | 8.128 | 0.288 | | — | 1.350 | — | |
| | | AT2P3S 3 $$ Post | | | | AT2P3S 4 $$ Post | | | |
| | | Settlement | | | | Settlement | | | |
| | Total $$ | | | 12.28 | | | | 1.350 | |
| | Settled | | | | | | | | |
| | Relative to | | | | | | | | |
| | AT2P3S | | | | | | | | |
| | | | | IL | | | | AR | |

| | The settlement values are computed and displayed at the bottom of the analysis, noting | | | | | | | | |
|---|---|---|---|---|---|---|---|---|---|
| | that AT2P3S 1 will make payments to each of AT2P3S 2, 3 & 4; and AT2P3S 2 can | | | | | | | | |
| | be required to make a payment to AT2P3S 3. In a further netting of payments, it is | | | | | | | | |
| | conceivable that AT2P3S 2 can instruct AT2P3S 1 to reduce its receivable of $3.356 | | | | | | | | |
| | by the $0.288 owed by it to AT2P3S 3, and to instead pay an additional $0.288 to | | | | | | | | |
| | AT2P3S 3 on its behalf, causing the settlement payment by AT2P3S 1 to AT2P3S 2 to | | | | | | | | |
| | be $3.07 and the payment by AT2P3S 1 to AT2P3S 3 to be $6.71, thereby requiring in | | | | | | | | |
| | one implementation(s) only 3 settlement payments as opposed to 4. | | | | | | | | |
| | At the conclusion of the settlement process, AT2P3S 1 will have collected net taxes of | | | | | | | | |
| | $6.43 which will be paid to the state of Missouri, AT2P3S 2 will have collected net | | | | | | | | |
| | taxes of $5.66 which will be paid to the state of Kansas, AT2P3S 3 will have collected | | | | | | | | |
| | net taxes of $12.28 which will be paid to the state of Illinois, and AT2P3S 4 will have | | | | | | | | |
| | collected $1.35 which will be paid to the state of Arkansas. Total tax collected and | | | | | | | | |
| | paid during this billing cycle relative to the 7 vehicles amounts to ($6.43 + 5.66 + | | | | | | | | |
| | 12.28 + 1.35 =) $25.72. | | | | | | | | |
| 10. | The taxes that are attributable to each HEV has also been processed by the AT2P3S's | | | | | | | | |
| | and will be recorded as having been charged to the HEV based on the specific VIN. In | | | | | | | | |
| | addition to the state tax amounts (SALT), the Federal tax levies will be computed and | | | | | | | | |
| | added to their period billing. A summary of taxes relative to the respective HEV | | | | | | | | |
| | follows: | | | | | | | | |
| | | | | | | | SALT | FED | TOTAL |
| | Amount | HEV 1 | 3.20 | | 1.49 | | 4.69 | 2.20 | 6.89 |
| | Owed by | HEV 2 | 1.52 | 3.36 | 1.61 | 1.35 | 7.83 | 3.54 | 11.37 |
| | | HEV 3 | | 2.31 | 0.29 | | 2.60 | 0.85 | 3.45 |
| | | HEV 4 | | | | | | | |
| | | HEV 5 | 1.71 | | 1.58 | | 3.29 | 1.40 | 4.69 |
| | | HEV 6 | | | 2.29 | | 2.29 | 0.85 | 3.14 |
| | | HEV 7 | | | 5.03 | | 5.03 | 2.15 | 7.18 |
| | | | 6.43 | 5.66 | 12.28 | 1.35 | 25.72 | 10.99 | 36.71 |
| | | | | | Total | | | | |
| | | MO | KS | IL | AR | SALT | FED | Sum | |
| | Utility A | 3.20 | — | | — | 4.69 | 2.20 | 6.89 | |
| | Collects | | | | | | | | |
| | from HEV 1 | | | | | | | | |
| | Utility B | 1.52 | 3.36 | | 1.35 | 7.83 | 3.54 | 11.37 | |
| | Collects | | | | | | | | |
| | from HEV 2 | | | | | | | | |
| | Utility C | — | 2.31 | | — | 2.60 | 0.85 | 3.45 | |
| | Collects | | | | | | | | |
| | from HEV 3 | | | | | | | | |
| | Utility D | — | — | | — | — | — | — | |
| | Collects | | | | | | | | |
| | from HEV 4 | | | | | | | | |
| | Utility E | 1.71 | — | | — | 3.29 | 1.40 | 4.69 | |
| | Collects | | | | | | | | |
| | from HEV 5 | | | | | | | | |
| | Utility F | — | — | | — | 2.29 | 0.85 | 3.14 | |
| | Collects | | | | | | | | |
| | from HEV 6 | | | | | | | | |
| | Utility A | — | — | | — | 5.03 | 2.15 | 7.18 | |
| | Collects | | | | | | | | |
| | from HEV 7 | | | | Totals | 25.72 | 10.99 | 36.71 | |

| | SALT | FED | Sum |
|---|---|---|---|
| AT2P3S 1 Collects | 9.72 | 4.35 | 14.07 |
| from Utility A | | | |
| AT2P3S 1 Collects | 7.83 | 3.54 | 11.37 |
| from Utility B | | | |
| | | 7.89 | 25.44 |
| AT2P3S 2 Collects | 2.60 | 0.85 | 3.45 |
| from Utility C | | | |
| AT2P3S 2 Collects | — | — | — |
| from Utility D | | 0.85 | 3.45 |
| AT2P3S 3 Collects | 3.29 | 1.40 | 4.69 |
| from Utility E | | | |
| AT2P3S 3 Collects | 3.29 | 0.85 | 3.14 |
| from Utility F | | 2.25 | 7.82 |
| AT2P3S 4 Collects | 1.35 | | 1.35 |
| from Utility B | | | 1.35 |

| 11. | With respect to settlements concerning TL2 Energy Purchases, summary | | | | | | | | | | | | |
|---|---|---|---|---|---|---|---|---|---|---|---|---|---|
| | the following processing would be produced for purposes of the HEV | | | | | | | | | | | | |
| | owner/lessee's billing from their respective VOPEUSP: | | | | | | | | | | | | |
| | Positive transmitted by TL2 SHEVC's to their VOPEUSPs; negatives by HEV VMT Meter Module | | | | | | | | | | | | |
| | SHEVV's | | | | A | B | C | D | | E | | F | G |
| | VOPEUSP | | HEV's | State | MO | MO | KS | KS | | IL | | IL | AR |
| | VOPEUSP | | | | | | | | | | | | |
| | Purchased by HEV 1 | | A | | | | | | | | | | |
| | from Utility A | | | | | | | | | | | | |
| | Purchased by HEV 1 | | A | | | | | | | | | | |
| | from Utility B | | | | | | | | | | | | |
| | Purchased by HEV 1 | | A | | | | | | | | | | |
| | from Utility C | | | | | | | | | | | | |
| | Purchased by HEV 1 | | A | | 20.00 | | | (20.00) | | | | | |
| | from Utility D | | | | | | | | | | | | |
| | Purchased by HEV 1 | | A | | | | | | | | | | |
| | from Utility E | | | | | | | | | | | | |
| | Purchased by HEV 1 | | A | | | | | | | | | | |
| | from Utility F | | | | | | | | | | | | |
| | Purchased by HEV 1 | | A | | | | | | | | | | |
| | from Utility G | | | | | | | | | | | | |
| | Purchased by HEV 2 | | B | | | | | | | | | | |
| | from Utility A | | | | | | | | | | | | |
| | Purchased by HEV 2 | | B | | | | | | | | | | |
| | from Utility B | | | | | | | | | | | | |
| | Purchased by HEV 2 | | B | | | | | | | | | | |
| | from Utility C | | | | | | | | | | | | |
| | Purchased by HEV 2 | | B | | | 15.00 | | (15.00) | | | | | |
| | from Utility D | | | | | | | | | | | | |
| | Purchased by HEV 2 | | B | | | | | | | | | | |
| | from Utility E | | | | | | | | | | | | |
| | Purchased by HEV 2 | | B | | | | | | | | | | |
| | from Utility F | | | | | | | | | | | | |
| | Purchased by HEV 2 | | B | | | 15.00 | | | | | | | (15.00) |
| | from Utility G | | | | | | | | | | | | |
| | Purchased by HEV 4 | | D | | | | | | | | | | |
| | from Utility A | | | | | | | | | | | | |
| | Purchased by HEV 4 | | D | | | | | | | | | | |
| | from Utility B | | | | | | | | | | | | |
| | Purchased by HEV 4 | | D | | | | (40.00) | 40.00 | | | | | |
| | from Utility C | | | | | | | | | | | | |
| | Purchased by HEV 4 | | D | | | — | | 60.00 | | | | | |
| | from Utility D | | | | | | | | | | | | |
| | Purchased by HEV 4 | | D | | | | | | | | | | |
| | from Utility E | | | | | | | | | | | | |
| | Purchased by HEV 4 | | D | | | | | | | | | | |
| | from Utility F | | | | | | | | | | | | |
| | Purchased by HEV 4 | | D | | | — | | | | | | | — |
| | from Utility G | | | | | | | | | | | | |
| | Purchased by HEV 5 | | E | | | | | | | | | | |
| | from Utility A | | | | | | | | | | | | |
| | Purchased by HEV 5 | | E | | | | | | | | | | |
| | from Utility B | | | | | | | | | | | | |
| | Purchased by HEV 5 | | E | | | | | | | | | | |
| | from Utility C | | | | | | | | | | | | |
| | Purchased by HEV 5 | | E | | | | | (9.75) | | 10.00 | | | |
| | from Utility D | | | | | | | | | | | | |
| | Purchased by HEV 5 | | E | | | | | | | | | | |
| | from Utility E | | | | | | | | | | | | |
| | Purchased by HEV 5 | | E | | | | | | | | | | |
| | from Utility F | | | | | | | | | | | | |
| | Purchased by HEV 5 | | E | | | | | | | | | | |
| | from Utility G | | | | | | | | | | | | |
| | The red highlighted numbers indicate a discrepancy between the value of the energy | | | | | | | | | | | | |
| | transferred and recorded by the SHEVC and the amount that the HEV's VMT Meter Module | | | | | | | | | | | | |
| | has recorded as being transferred during the TL2 charging session. | | | | | | | | | | | | |
| | In this case, the HEV owner/lessee is notified that a discrepancy has been identified and that | | | | | | | | | | | | |
| | the SHEVC will be assessed to determine if there is an issue with the SHEVC's readings. | | | | | | | | | | | | |
| | This Use Case assumes that the SHEVC charge will stand until the discrepancy has been | | | | | | | | | | | | |
| | resolved, as it is equally possible that the HEV VMT Meter Module can be experiencing | | | | | | | | | | | | |
| | errors. | | | | | | | | | | | | |
| | A condensed summary of the “out of network” energy purchases by the HEV owner/lessee | | | | | | | | | | | | |
| | from specific utilities, the utility to utility “billing” that should occur to settle the amounts of | | | | | | | | | | | | |
| | the deferred energy purchases (recall that TL2 charges are not paid at the time of energy | | | | | | | | | | | | |
| | transference but, rather, billed at a later point via the HEV owner/lessees VOPEUSP billing), | | | | | | | | | | | | |
| | and the amount of the funds flowing from AT2P3Ss representing the various utilities is | | | | | | | | | | | | |
| | presented in the following table: | | | | | | | | | | | | |
| | Summary of out of | | | | | | | | | | | | |
| | network energy | | | | A | B | C | D | | E | | F | G |
| | purchases | | | | MO | MO | KS | KS | | IL | | IL | AR |
| | HEV 1 Purchased | | D | Billed | 20.00 | | | | | | | | |
| | Energy from Utility | | | to | | | | | | | | | |
| | HEV 2 Purchased | | D | | | 15.00 | | | | | | | |
| | Energy from Utility | | | | | | | | | | | | |
| | HEV 3 Purchased | | G | | | 15.00 | | | | | | | |
| | Energy from Utility | | | | | | | | | | | | |
| | HEV 4 Purchased | | C | | | | | 40.00 | | | | | |
| | Energy from Utility | | | | | | | | | | | | |
| | Inter AT2P3S-Billed | | D | | | | | (40.00) | | | | | |
| | via Utility | | | | | | | | | | | | |
| | HEV 5 Purchased | | D | | | | | | | 10.00 | | | |
| | Energy from Utility | | | | | | | | | | | | |
| | | | | | 20.00 | 30.00 | — | — | | 10.00 | | — | — |
| | Utility A to collect | | | | 20.00 | | | | | | | | |
| | from HEV 1 | | | | | | | | | | | | |
| | Utility B to collect | | | | | 30.00 | | | | | | | |
| | from HEV 2 | | | | | | | | | | | | |
| | Utility D to collect | | | | | | | — | | | | | |
| | from HEV 4 | | | | | | | | | | | | |
| | Utility E to collect | | | | | | | | | 10.00 | | | |
| | from HEV 5 | | | | 20.00 | 30.00 | — | — | | 10.00 | | — | — |
| | AT2P3S 1 to collect | | A | | 20.00 | | | | | | | | |
| | from Utility | | | | | | | | | | | | |
| | AT2P3S 1 to collect | | B | | | 30.00 | | | | | | | |
| | from Utility | | | | | | | | | | | | |
| | Total AT2P3S | | | | | 50.00 | | | | | | | |
| | Collections | | | | | | | | | | | | |
| | AT2P3S 2 to collect | | D | | | | | — | | | | | |
| | from Utility | | | | | | | | | | | | |
| | AT2P3S 3 to collect | | E | | | | | | | 10.00 | | | |
| | from Utility | | | | | | | | | | | | |
| 12. | Combining the TL1, TL2 and TL3 charges recorded during the billing period into a summary | | | | | | | | | | | | |
| | assessment yields the following assessment: | | | | | | | | | | | | |
| | AT2P3S Collection & Disbursements (TL1 Charging Sessions): Use Tax | | | | | | | | | | | | |
| | | | | | (B) | | | | | | | | |
| | | | | (A) | Settlement Payments to: | | | | | (C) | | | |
| | | | | Collect- | AT2P3S | AT2P3S | AT2P3S | AT2P3S | | Fed Tax | | | |
| | | | | ions | 1 | 2 | 3 | 4 | | Payments | | | |
| | AT2P3S | | (MO) | 25.44 | | (3.356) | (6.421) | (1.350) | | (7.89) | | | |
| | 1 | | | | | | | — | | | | | |
| | AT2P3S | | (KS) | 3.45 | | 3.356 | (0.288) | | | (0.85) | | | |
| | 2 | | | | | | | | | | | | |
| | AT2P3S | | (IL) | 7.82 | | | 6.709 | | | (2.25) | | | |
| | 3 | | | | | | | | | | | | |
| | AT2P3S | | (AR) | | | | | 1.350 | | | | | |
| | 4 | | | | | | | | | | | | |
| | | | Totals | 36.71 | — | — | — | — | | (10.99) | | | |
| | | | | (D) | | | | | | | | | |
| | | | | SALT Payments | | | | | | | | | |
| | | | | MO | KS | IL | AR | NET | | | | | |
| | AT2P3S | | (MO) | (6.425) | | | | — | | | | | |
| | 1 | | | | | | | | | | | | |
| | AT2P3S | | (KS) | | (5.66) | | | | | | | | |
| | 2 | | | | | | | | | | | | |
| | AT2P3S | | (IL) | | | (12.28) | | (0.00) | | | | | |
| | 3 | | | | | | | | | | | | |
| | AT2P3S | | (AR) | | | | (1.35) | — | | | | | |
| | 4 | | | | | | | | | | | | |
| | | | Totals | (6.43) | (5.66) | (12.28) | (1.35) | (0.00) | | | | | |
| | AT2P3S Collections & Disbursements (TL2 Charging Sessions): Energy | | | | | | | | | | | | |
| | [NOTE: Taxes should be settled during TLI Sessions] | | | | | | | | | | | | |
| | | | | | (B) | | | | | | | | |
| | | | (A) | | Billings Paid to: | | | | | | | | |
| | | | Collect- | | AT2P3S | AT2P3S | AT2P3S | AT2P3S | | | | | |
| | | | ions | | 1 | 2 | 3 | 4 | | Subtotal | | | |
| | From HEV1 | | $(20.00) | | $20.00 | | | | | — | | | |
| | Billings | | | | | | | | | | | | |
| | From HEV 2 | | $(30.00) | | $30.00 | | | | | | | | |
| | Billings | | | | | | | | | | | | |
| | From HEV 3 | | $- | | $- | | | | | — | | | |
| | Billings | | | | | | | | | | | | |
| | From HEV 4 | | $- | | $- | $- | | | | — | | | |
| | Billings | | | | | | | | | | | | |
| | From HEV 5 | | $(10.00) | | | | $10.00 | | | — | | | |
| | Billings | | | | | | | | | | | | |
| | From HEV 6 | | $- | | $- | | | | | — | | | |
| | Billings | | | | | | | | | | | | |
| | From HEV 7 | | $- | | $- | | | | | — | | | |
| | Billings | | | | | | | | | | | | |
| | | | (D) | | | | | | | | | | |
| | | | SALT Payments | | | | | | | | | | |
| | | | AT2P3S | | AT2P3S | AT2P3S | AT2P3S | | | | | | |
| | | | 1 | | 2 | 3 | 4 | NET | | | | | |
| | From HEV1 | | | | | | | $20.00 | | | | | |
| | Billings | | | | | | | | | | | | |
| | From HEV 2 | | | | | | | $30.00 | | | | | |
| | Billings | | | | | | | | | | | | |
| | From HEV 3 | | | | | | | | | | | | |
| | Billings | | | | | | | | | | | | |
| | From HEV 4 | | | | | | | | | | | | |
| | Billings | | | | | | | | | | | | |
| | From HEV 5 | | | | | | | $10.00 | | | | | |
| | Billings | | | | | | | | | | | | |
| | From HEV 6 | | | | | | | $- | | | | | |
| | Billings | | | | | | | | | | | | |
| | From HEV 7 | | | | | | | $- | | | | | |
| | Billings | | | | | | | | | | | | |
| | | | | Settlement Paid to: | | | | | | | | | |
| | | | | AT2P3S | AT2P3S | AT2P3S | AT2P3S | | | | | | |
| | | | | 1 | 2 | 3 | 4 | | | | | | |
| | AT2P3S | (MO) | | (50.00) | 35.000 | — | 15.000 | — | — | | | | $- |
| | 1 | | | | | | | | | | | | |
| | AT2P3S | (KS) | — | | | — | — | — | — | — | | | $- |
| | 2 | | | | | | | | | | | | |
| | AT2P3S | (IL) | | | 10.000 | (10.000) | | — | | | — | — | $- |
| | 3 | | | | | | | | | | | | |
| | AT2P3S | (AR) | | | | | | — | | | — | — | $- |
| | 4 | Totals | — | — | 45.00 | — | 15.00 | — | — | — | — | — | 60.00 |

| AT2P3S Collections & Disbursements (TL3 Charging Sessions): Sales Tax | | | | | | | | |
|---|---|---|---|---|---|---|---|---|
| | | | | | (B) | | | |
| | | | | (A) | Settlement Payments to: | | | |
| | | | | Collec- | AT2P3S | AT2P3S | AT2P3S | AT2P3S |
| | | | | tions | 1 | 2 | 3 | 4 |
| | AT2P3S | (MO) | | 11.65 | | | | |
| | 1 | | | | | | | |
| | AT2P3S | (KS) | 16.50 | (8.25) | 4.250 | | | (8.25) |
| | 2 | | | | | | | |
| | ATP3S | (IL) | 14.40 | (3.40) | (4.250) | | | (6.75) |
| | 3 | | | | | | | |
| | AT2P3S | (AR) | | | | | | |
| | 4 | Totals | 30.9 | — | — | — | — | (15.00) |
| | | (D) | | | | | | |
| | | SALT Payments | | | | | | |
| | | MO | KS | IL | AR | NET | | |
| AT2P3S | (MO) | (11.650) | | | | — | | |
| 1 | | | | | | | | |
| AT2P3S | (KS) | | (4.25) | | | — | | |
| 2 | | | | | | | | |
| ATP3S | (IL) | | | — | — | — | | |
| 3 | | | | | | | | |
| AT2P3S | (AR) | | | | | — | | |
| 4 | Totals | (11.65) | (4.25) | — | — | (0.00) | | |

| HEV Owners will owe, at the end of the billing cycle (collectively) $36.71 for | | | | | | | | |
|---|---|---|---|---|---|---|---|---|
| “taxable” VMT usage fee (but will have a collective credit of $30.90 for sales tax paid | | | | | | | | |
| relative to TL3 charging sessions), and will also owe $60.00 with respect to deferred | | | | | | | | |
| energy purchases. | | | | | | | | |
| The net amount of tax to be collected and processed, therefore, by the AT2P3Ss will | | | | | | | | |
| be $60.00 + $36.71-$30.90 = $65.81. | | | | | | | | |
| A reconciliation of the amounts to be reflected on the billings to the HEV owners | | | | | | | | |
| during the cycle is as follows: | | | | | | | | |
| Summary of AT2P3S Settlement/Billing Line Items | | | | | | | | |
| | | Memo | | | | | | |
| | | In- | Out of | | | | | |
| | | Network | Network | | | | SALT | |
| | | TL2 | Energy | Federal | Federal | SALT | Sales | |
| | | Pur- | Pur- | Use | Sales Tax | Use | Tax | |
| | | chases | chases | Tax | Credit | Tax | Credit | Totals |
| HEV | 1 | | 20.00 | 2.20 | (4.50) | 4.69 | (4.50) | 17.89 |
| HEV | 2 | | 30.00 | 3.54 | (3.00) | 7.83 | (3.40) | 34.97 |
| HEV | 3 | | — | 0.85 | — | 2.60 | — | 3.45 |
| HEV | 4 | 100.00 | — | — | (3.75) | — | (4.25) | (8.00) |
| HEV | 5 | | 10.00 | 1.40 | — | 3.29 | — | 14.69 |
| HEV | 6 | | — | 0.85 | — | 2.29 | — | 3.14 |
| HEV | 7 | | — | 2.15 | (3.75) | 5.03 | (3.75) | (0.32) |
| | | | 60.00 | 10.99 | (15.00) | 25.75 | (15.90) | 65.81 |

| The following mock statements reflect the billing statements for the current cycle that | | | | |
|---|---|---|---|---|
| would be sent to the HEV owner's for both their residential and HEV charges, | | | | |
| including both in-network and out-of-network energy purchases and related federal | | | | |
| and state use fees and sales tax credits: | | | | |
| HEV Owner/Lessee # 1: | | | | |
| Utility A Logo | | | | |
| Joe Smith | | | | |
| 1 Maple Drive | | | | |
| St. Louis, MO 63000 | | | | |
| Account # 12345-0006789 | | | | |
| Electric Energy Charge- | | 100.00 | | |
| Residential | | | | |
| Other Residential Charges | | 20.00 | | |
| Federal Tax | | 1.20 | | |
| Local Tax | | 7.20 | | |
| Total Residential Amount Due | | 128.40 | 128.40 | |
| Plug-in Hybrid/Fully Electric | | | | |
| Vehicle | | | | |
| Electric Energy Charge-Charging | TL1 | 110.00 | | |
| Station | | | | |
| In-Network | TL2 | | | |
| Vehicle to Grid Rebate | | (25.00) | | |
| Out of Network Energy | TL2 | 20.00 | | |
| Purchases | | | | |
| VMT Use Tax | | | | |
| Federal | | 2.20 | | |
| Federal Sales Tax Credit | | (4.50) | | |
| State | | 4.69 | | |
| State Sales Tax Credit | | (4.50) | | |
| | | 102.89 | 102.89 | |
| Total Due for Period | | | 231.29 | |
| Meter Information | | | | |
| | Meter | Current | Previous | Current |
| | Number | Reading | Reading | Net Usage |
| Residential | 9999999 | 11000 | 9800 | 1,200 kWh |
| HEV VIN | ZP1424L . . . | 2300 | 1000 | 1,300 kWh |
| HEV Alerts (if any) | | | | |
| HEV Owner/Lessee # 2: | | | | |
| Utility B Logo | | | | |
| Joe Apple | | | | |
| 10 Oak Drive | | | | |
| St. Joseph, MO 63001 | | | | |
| Account # 12345-0006750 | | | | |
| Electric Energy Charge- | | 150.00 | | |
| Residential | | | | |
| Other Residential Charges | | 30.00 | | |
| Federal Tax | | 1.80 | | |
| Local Tax | | 10.80 | | |
| Total Residential Amount Due | | 192.60 | 192.60 | |
| Plug-in Hybrid/Fully Electric | | | | |
| Vehicle | | | | |
| Electric Energy Charge-Charging | TL1 | 130.00 | | |
| Station | | | | |
| In-Network | TL2 | | | |
| Vehicle to Grid Rebate | | (30.00) | | |
| Out of Network Energy | TL2 | 30.00 | | |
| Purchases | | | | |
| VMT Use Tax | | | | |
| Federal | | 3.54 | | |
| Federal Sales Tax Credit | | (3.00) | | |
| State | | 7.83 | | |
| State Sales Tax Credit | | (3.40) | | |
| | | 134.97 | 134.97 | |
| Total Due for Period | | | 327.57 | |
| Residential | 9999999 | 12000 | 9800 | 2,200 kWh |
| HEV VIN | ZPQ424L . . . | 2500 | 1500 | 1,500 kWh |
| HEV Alerts (if any) | | | | |
| HEV Owner/Lessee # 3: | | | | |
| Utility C Logo | | | | |
| Joe Blow | | | | |
| 100 Spruce Drive | | | | |
| Kansas City, Kansas 63002 | | | | |
| Account # 12345-0006775 | | | | |
| Electric Energy Charge- | | 140.00 | | |
| Residential | | | | |
| Other Residential Charges | | 25.00 | | |
| Federal Tax | | 1.65 | | |
| Local Tax | | 9.90 | | |
| Total Residential Amount Due | | 176.55 | 176.55 | |
| Plug-in Hybrid/Fully Electric | | | | |
| Vehicle | | | | |
| Electric Energy Charge-Charging | TL1 | 90.00 | | |
| Station | | | | |
| In-Network | TL2 | | | |
| Vehicle to Grid Rebate | | | — | |
| Out of Network Energy | TL2 | | — | |
| Purchases | | | | |
| VMT Use Tax | | | | |
| Federal | | 0.85 | | |
| Federal Sales Tax Credit | | — | | |
| State | | 2.60 | | |
| State Sales Tax Credit | | — | | |
| Total Due for Period | | 93.45 | 93.45 | |
| | | | 270.00 | |
| Residential | 9999999 | 10500 | 9800 | 700 kWh |
| HEV VIN | ZPQ424L . . . | 1700 | 1000 | 700 kWh |
| HEV Alerts (if any) | | | | |
| HEV Owner/Lessee # 4: | | | | |
| Utility D Logo | | | | |
| Joe King | | | | |
| 1000 Pine Drive, Apt 27 | | | | |
| Mission, KS 63003 | | | | |
| Account # 12345-0006800 | | | | |
| Electric Energy Charge- | | 70.00 | | |
| Residential | | | | |
| Other Residential Charges | | 5.00 | | |
| Federal Tax | | 0.75 | | |
| Local Tax | | 4.50 | | |
| Total Residential Amount Due | | 80.25 | 80.25 | |
| Plug-in Hybrid/Fully Electric | | | | |
| Vehicle | | | | |
| Electric Energy Charge-Charging | TL1 | | | |
| Station | | | | |
| In-Network | TL2 | 100.00 | | |
| Vehicle to Grid Rebate | | — | | |
| Out of Network Energy | TL2 | — | | |
| Purchases | | | | |
| VMT Use Tax | | | | |
| Federal | | — | | |
| Federal Sales Tax Credit | | (3.75) | | |
| State | | — | | |
| State Sales Tax Credit | | (4.25) | | |
| | | 92.00 | 92.00 | |
| Total Due for Period | | | 172.25 | |
| Residential | 9999999 | 10500 | 9800 | 700 kWh |
| HEV VIN | ZPQ424L . . . | 1700 | 1000 | 700 kWh |
| HEV Alerts (if any) | | | | |
| VMT USe Taxes deferred; may | | | | |
| be subject to penalty or fee at | | | | |
| settlement for late payment. | | | | |
| HEV Owner/Lessee # 5: | | | | |
| Utility E Logo | | | | |
| Joe Fough | | | | |
| 200 Shady Drive | | | | |
| East St. Louis, IL 63004 | | | | |
| Account # 12345-0006850 | | | | |
| Electric Energy Charge- | | 105.00 | | |
| Residential | | | | |
| Other Residential Charges | | 17.50 | | |
| Federal Tax | | 1.23 | | |
| Local Tax | | 7.35 | | |
| Total Residential Amount Due | | 131.08 | 131.08 | |
| Plug-in Hybrid/Fully Electric | | | | |
| Vehicle | | | | |
| Electric Energy Charge-Charging | TL1 | 95.00 | | |
| Station | | | | |
| In-Network | TL2 | — | | |
| Vehicle to Grid Rebate | | — | | |
| Out of Network Energy | TL2 | 10.00 | | |
| Purchases | | | | |
| VMT Use Tax | | | | |
| Federal | | 1.40 | | |
| Federal Sales Tax Credit | | — | | |
| State | | 3.29 | | |
| State Sales Tax Credit | | — | | |
| | | 14.69 | 14.69 | |
| Total Due for Period | | | 145.76 | |
| Residential | 9999999 | 10500 | 9800 | 700 kWh |
| HEV VIN | ZPQ424L . . . | 1700 | 1000 | 700 kWh |
| HEV Alerts (if any) | | | | |
| The Out of Network charge of $10.00 exceeds the amount recorded by the HEV's VMT | | | | |
| Meter Module, which indicated an amount due of $9.75. A trouble ticket has been issued to | | | | |
| investigate the reporting SHEVC to determine if the remote charger has been experiencing | | | | |
| anomalies. As of now, your billing reflects the full amount of the SHEVC charge. Please call | | | | |
| customer service if you wish to protest the charge at this time. If not, we will investigate and | | | | |
| credit your subsequent billing should the investigation determine that you have been | | | | |
| overcharged. | | | | |
| HEV Owner/Lessee # 6: | | | | |
| Utility F Logo | | | | |
| Joe Gudo | | | | |
| 201 Olive Drive | | | | |
| Carbondale, IL 63005 | | | | |
| Account # 12345-0006890 | | | | |
| Electric Energy Charge- | | 112.00 | | |
| Residential | | | | |
| Other Residential Charges | | 14.75 | | |
| Federal Tax | | 1.27 | | |
| Local Tax | | 7.61 | | |
| Total Residential Amount Due | | 135.62 | 135.62 | |
| Plug-in Hybrid/Fully Electric | | | | |
| Vehicle | | | | |
| Electric Energy Charge-Charging | TL1 | 80.00 | | |
| Station | | | | |
| In-Network | TL2 | — | | |
| Vehicle to Grid Rebate | | — | | |
| Out of Network Energy | TL1 | — | | |
| Purchases | | | | |
| VMT Use Tax | | | | |
| Federal | | 0.85 | | |
| Federal Sales Tax Credit | | — | | |
| State | | 2.29 | | |
| State Sales Tax Credit | | — | | |
| | | 3.14 | 3.14 | |
| Total Due for Period | | | 138.76 | |
| Meter Information | | | | |
| | Meter | Current | Previous | Current |
| | Number | Reading | Reading | Net Usage |
| Residential | 9999999 | 10500 | 9800 | 700 kWh |
| HEV VIN | ZPQ424L . . . | 1700 | 1000 | 700 kWh |
| HEV Alerts (if any) | | | | |
| HEV Owner/Lessee # 7: | | | | |
| Utility A Logo | | | | |
| Joe Hard | | | | |
| 11 Magnolia Drive | | | | |
| St. Louis, MO 63000 | | | | |
| Account # 12345-0006900 | | | | |
| Electric Energy Charge- | | 200.00 | | |
| Residential | | | | |
| Other Residential Charges | | 40.00 | | |
| Federal Tax | | 2.40 | | |
| Local Tax | | 14.50 | | |
| Total Residential Amount Due | | 256.80 | 256.80 | |
| Plug-in Hybrid/Fully Electric | | | | |
| Vehicle | | | | |
| Electric Energy Charge-Charging | TL1 | 130.00 | | |
| Station | | | | |
| In-Network | TL2 | | | |
| Vehicle to Grid Rebate | | (12.00) | | |
| Out of Network Energy | TL1 | — | | |
| Purchases | | | | |
| VMT Use Tax | | | | |
| Federal | | 2.15 | | |
| Federal Sales Tax Credit | | (3.75) | | |
| State | | 5.03 | | |
| State Sales Tax Credit | | (3.75) | | |
| | | 117.68 | 117.68 | |
| Total Due for Period | | | 374.48 | |
| Residential | 9999999 | 11000 | 9800 | 1,200 kWh |
| HEV VIN | ZPQ424L . . . | 2300 | 1000 | 1,300 kWh |
| HEV Alerts (if any) | | | | |

### Example 8

Basis for Applying Fees to Support Maintenance of Currently Existing Roads and Construction of New Roads

As described above, the current method of collecting fees on HEVs is for the state of registration to charge a flat annual fee (which varies based upon vehicle weight) designed to approximate an average amount of fuel tax collections on respective vehicles. As further described, while this approach is a relatively simple method of assessing a fee to support our nation's transportation infrastructure, it is clearly inherently unfair to HEV owners who drive mileage below the regional average number of miles driven annually. Furthermore, this method does little to ensure that a fair allocation of the fees collected to the states or jurisdictions where miles are driven.

Therefore, it is clear that a method of assessing HEV owners based upon the vehicle miles traveled (VMT) is a more equitable approach. Furthermore, the VMT fee collection approach should include the following attributes:
Allow for fee collection for usage of publicly funded roadways based upon their classification (e.g., highway or side street), but no fees for travel off-road or over privately funded avenues
Provide for payment of fees to the jurisdictional authorities that maintain the roads where the vehicle is actually driven
Provide the vehicle owner/driver with privacy so that specific routes or locations visited by the driver are not reported to authorities
Be automated so as not to require excessive data collection or reporting obligations

Fee Collection on Usage of Roadways Based Upon their Classification

Absent a legally determined exempt usage, both Federal and State level excise taxes are applied to each gallon of gasoline, diesel or gasohol that is supplied, distributed, transported and purchased; with a majority of the federal tax placed into a Highway Trust Fund to be used on roadway maintenance and construction. State tax collections are generally disbursed to the respective State Department of Transportation and county and city departments within the state that are responsible for state and local road construction and maintenance.

Recent administrations announced plans to dedicate at least 25 percent of the Federal infrastructure funds to grants that support rural projects including U.S. territories and Tribal communities. Under those plans he Federal government could identify areas of national priority to direct disbursements from the Federal funds (e.g., in the form of grants) to support the development of key projects or to allocate funds to areas of the country which are not otherwise able to meet the matching funds requirements (for example, rural roads in Montana where there are few residents but the roads nevertheless remain important).

Ideally the Federal and State authorities will devise a universal VMT categorization of roadway classes for HEV usage that will allow fees to be assessed at levels that will support authorized budgets for maintenance and construction. For example, a mile traveled on an Interstate highway may be more expensive to drive upon as compared to a mile of a state highway (due to above average wear and tear, multiple lanes of thoroughfare, construction administration costs, and other factors). It may be determined, therefore, that an HEV owner should pay $0.07 per mile driven on an Interstate highway as opposed to $0.055 per mile driven on a state highway. Furthermore, an ideal VMT usage fee system may charge a premium for driving on a bridge or overpass, as the cost to construct and/or maintain that infrastructure exceeds a roadway located on graded land.

The organization known as “The Constructor” (a site devoted to Civil Engineering) has provided a contractor's perspective of ‘Classifications or Types of Roads’ which analyzes roadways based on the following factors:
Materials used in the construction
Location & function
Traffic volume
Width
Economy
Traffic type
Rigidity; and
Topography

Materials utilized in the construction process can have a significant impact on the cost of the roadways and should be considered as a factor when determining VMT usage charges. The Constructor site identifies, in addition to the WBM process described earlier, the following road types based on materials utilized:
Earthen roads
Gravel roads
Murrum roads
Kankar roads
Bituminous roads (including Chipseal); and
Concrete roads

The other listed factors should also be considered, with weights perhaps assigned to each factor. Topography, for example, may be an important aspect in assigning a higher per mile charge for a given stretch of roadway. With the above factors in mind, the following listing of roadways should be considered in making a determination as to the classification of roadways and the respective usage fees to be charged on each; provided, however, that adjustments may be required based on the aforementioned civil engineering considerations:

While the above noted roadway (and off-road) designations have been identified by the U.S. Department of Transportation and various state Department of Transportations, there remains uncertainty between various states and various state agencies as to which of the above classifications should be considered “taxable” versus “non-taxable” (as evidenced by the example of Oregon above wherein the state lacks a clear definition and of what constitutes a “non-public road”, which may enter into a coding issue for collection of VMT usage fees).

For a system to function properly across state lines, a common classification of roadways for the purposes of a VMT system would ideally be put in place and would likely require legislation by the Federal government in order to settle state to state disputes.

In theory, even if the above noted classifications were broadly adopted, each state may decide to place roadways into their own preferred groupings (e.g., in Missouri usage fees for all rural, urban and state park roads are collected at a specific charge per mile; whereas in Illinois fees for all rural & urban roads are collected at one tier and state park roads at another).

For purposes of determining VMT usage fees it will be necessary for the VMT Use Fee Collection System to have “taxable” miles driven collected in “buckets”, as per the following example of a vehicle traveling in the states of MO & IL:
Miles driven on Interstate Highways by state (charged at $0.03 per mile Federal; $0.04 per mile MO and $0.05 per mile IL)
Miles driven on Interstate Bridges by state (charged at $0.05 per mile Federal; $0.05 per mile MO and $0.07 per mile IL)
Miles driven on state highways, by state (charged at $0.055 per mile in MO; $0.065 per mile IL)
Miles driven on state highway bridges, by state (charged at $0.075 per mile in MO; $0.09 per mile in IL)
Miles driven on rural and urban roads, by state (charged at $0.04 per mile in MO; $0.045 per mile in IL)
Miles driven on state park roads, by state (charged at $0.04 per mile in MO; $0.12 per mile in IL).
Miles driven on special purpose roads, by state (charged depending upon special purpose designator)
Miles driven on exempt roads by state (no charge: off-road; private roads*, driveways, parking lots)
Private roads will be addressed later as a potential source of VMT fee collection but would not directly benefit the state or federal transportation funds in this example.

In order to develop a robust VMT Usage Fee Collection System, it will be critical for each and every HEV to be equipped with a vehicle navigation system that (a) includes mapping software that is capable of identifying the appropriate roadway classifications for each state and (b) a data logging system that collects the mileage attributable to each such classification.

Mapping

A key attribute of a navigation system that must be present in order to arrive at the lowest cost route (or to communicate the cost of an express route) would be a consistent method of classifying roads across jurisdictional boundaries for purposes of fee calculations. Such road classifications should be made available in the navigation system maps and the routing algorithms should be able to determine an estimated fee calculation based upon the anticipated mileage to be driven over the various road classes.

Unfortunately, there does not appear to be standardization across the navigation maps in terms of roadway classifications. For example, TomTom has published the following road classes that it employs in its software¹:

| FRC | | |
|---|---|---|
| VALUE | Short Description | Long Description |
| 0 | Motorways; | All roads that are officially assigned as motorways. |
| | Freeways; | |
| | Major Roads | |
| 1 | Major Roads less | All roads of high importance, but not officially assigned as |
| | important than | motorways, that are part of a connection used for international |
| | Motorways | and national traffic and transport. |
| 2 | Other Major Roads | All roads used to travel between different neighboring regions |
| | | of a country. |
| 3 | Secondary Roads | All roads used to travel between different parts of the same |
| | | region. |
| 4 | Local Connecting | All roads making all settlements accessible or making parts |
| | Roads | (north, south, east, west and central) of a settlement accessible. |
| 5 | Local Roads of High | All local roads that are the main connections in a settlement. |
| | Importance | These are the roads where important through traffic is possible |
| | | e.g .: |
| | | arterial roads within suburban areas, industrial areas or |
| | | residential areas; |
| | | a rural road, which has the sole function of connecting |
| | | to a national park or important tourist attraction. |
| 6 | Local Roads | All roads used to travel within a part of a settlement or roads of |
| | | minor connecting importance in a rural area. |
| 7 | Local Roads of Minor | All roads that only have a destination function, e.g. dead-end |
| | Importance | roads, roads inside living area, alleys: narrow roads between |
| | | buildings, in a park or garden. |
| 8 | Other Roads | All other roads that are less important for a navigation system: |
| | | a path: a road that is too small to be driven by a passenger car; |
| | | bicycle paths or footpaths that are especially designed as such; |
| | | stairs; |
| | | pedestrian tunnel; |
| | | pedestrian bridge, |
| | | alleys that are too small to be driven by a passenger car. |

As previously noted, TomTom mapping services are utilized in certain onboard systems (e.g., Hyundai and Kia) but are also employed in mobile apps, such as Apple Maps2 (although it appears that Apple Maps has recently begun to develop their systems to be less reliant upon TomTom³).

Alternatively, the WAZE map application utilizes the following classifications⁴:
1 Overview
   1.1 A hybrid system
      1.1.1 Functional classification
      1.1.2 Highway systems
   1.2 Importance of road types
      1.2.1 Exceptions
   1.3 Before editing
2 Public roads
   2.1 Unpaved check box
      2.1.1 When to select the Unpaved attribute
      2.1.2 User setting options for the Unpaved attribute
   2.2 Highways
      2.2.1 Freeway
      2.2.2 Major Highway
      2.2.3 Minor Highway
      2.2.4 Ramps
   2.3 Streets
      2.3.1 Primary Street
      2.3.2 Street
      2.3.3 Passageway
      2.3.4 Service Road
   2.4 Quick reference chart
3 Other drivable roads
   3.1 Off-road/Not maintained Road
   3.2 Parking Lot Road
   3.3 Private Road
      3.3.1 Emergency Vehicle and DOT Service Roads
   3.4 Ferry
4 Non-drivable roads
   4.1 Walking Trails
   4.2 Railroad
   4.3 Runway/Taxiway
5 Special case roads not covered
   5.1 Bus or taxi only lanes
   5.2 Driveways

While there are similarities, there are also several differences between roadway classifications when comparing these two (Tom-Tom and Waze) mapping solutions. For example, there is no provision for private roads in the TomTom schema, whereas WAZE's architecture recognizes Private Roads as category 3.3. This may be an important distinction, as governments may not be entitled to collect fees for roads that are privately maintained, and the TomTom mapping system does not appear to be structured to accommodate that distinction.

It is unlikely that proprietary mapping systems will compare neatly to either of the TomTom or Waze roadway classification schemas, and so it is fair to say that there are inconsistencies in mapping services across the board.

Another notable source of roadway mapping that has increasingly received a growing following is the OpenStreetMap initiative. Whereas the aforementioned mapping services (Tom Tom and Waze) are proprietary and may charge a license fee for use of their copyrighted data, the OpenStreetMap organization makes their mapping available without charge. Although WAZE (owned by Google) opens its mapping software to unpaid “editors” that can modify or improve the application, the system remains proprietary.⁵ OpenStreetMap provides programmers and others with a free dataset without being limited by the constraints of a proprietary system.⁶ The OSM wiki identifies the various tags (including roadway classifications) that are common in the OSM model⁷, inclusive of renderings and photo tags to accompany the Key Values. See Appendix A for a listing of OSM tags. While the OSM tags appear to be more thorough and complete compared to the classifications of the TomTom mapping or WAZE mapping services, it is interesting to note that the only reference to “private” in the OSM tags is for a parking space and NOT private roadways; and so this is yet another example as to how the roadway classifications differ across the various mapping solutions.

Many states and counties have their own mapping resources that are available to the public. For example, the state of North Carolina has published its own “Eleven-Digit Route Number” Guide⁸ that describes its roadways (utilized for its mapping) by assigning: Route (Road) Class, a Qualifier, an Inventory Code, a specified Number, and a County Code.

Counties in certain states also provide maps and apps, such as St. Louis (Mo.) County⁹ which offers an API that allows users to explore a rich dataset of information, including a “Street Centerlines” product that includes Highway classes. However, it is important to inspect the source data carefully, as the St. Louis County database is subject to copyright by vendors including ESRI, HERE and Garmin.
1 https://developer.tomtom.com/traffic-stats/support/faq/what-are-functional-road-classes-frc
2 https://www.businessinsider.com/tomtom-apple-maps-2012-9
3 https://www.reuters.com/article/us-apple-tomtom-idUSKBN1JP32S
4 https://wazeopedia.waze.com/wiki/USA/Road types
5 See WAZE article on pages A1 and A10 of the Wall Street Journal dated Thursday, Mar. 21, 2019—VOL. CCLXXIII No. 66
6 https://wiki.openstreetmap.org/wiki/FAQ#Is_it_OpenStreetMap_or_Open_Street_Maps.3F
7 https://wiki.openstreetmap.org/wiki/Key:highway
8.https://xfer.services.ncdot.gov/gisdot/DistDOTData/Guide%20to%20the%20NCDOT%20Eleven-Digit%20Route%20Number%20-%20Rome%20Implementation.pdf
9.http://sticogis.maps.arcgis.com/apps/MapSeries/index.html?appid=0c8450a868ee4e29aa8daf7 2f964dc59
   [reserved]
      [reserved]
   [reserved]
      [reserved]

What is claimed is:

1. A system for assessing electric vehicle usage fees comprising:
an electric vehicle comprising an electric vehicle user interface having a plurality of selectable trust level inputs;
a navigation system comprising mapping software that calculates the geographic position of the electric vehicle and distinguishes road classes and waypoints in communication with a datalogger;
an electronic control unit that stores information comprising vehicle information and user information in communication with the datalogger;
wherein the datalogger creates a report based on a selected trust level that comprises vehicle information and user information retrieved from the electronic control unit, and information from the navigation system comprising mileage traveled by road classes and waypoints;
a local area network comprising a plurality of communicating nodes;
wherein the electric vehicle is a communicating node that transmits the report based on the selected trust level, and
wherein a remotely located receiver node is a communicating node that receives the report based on the selected trust level.

2. The system of claim 1, wherein the remotely located receiver node comprises an electric utility service provider, or third party, vehicle database and a processor that calculates a usage fee owed to a fee collecting jurisdictional authority.

3. The system of claim 1, wherein the system includes one or more of the following such that the report:
comprises a sequence of data that is not encrypted,
comprises a sequence of data that is encrypted,
is not encrypted and comprises compiled data, and/or
is encrypted and comprises compiled data.

4. The system of claim 2, further comprising:
an electric utility service provider, or a third party, billing system comprising a further processor that receives usage fee information from a plurality of electric utility service provider, and/or third party, vehicle databases and prepares usage fee remittance advice to one or more fee collecting jurisdictional authority;

5. The system of claim 4, wherein:
at least one fee collecting jurisdictional authority determines the usage fee to be a tax.

6. The system of claim 1, wherein the datalogger memory is cleared based on the selected trust level or is cleared by an end of life decommissioning of the vehicle.

7. The system of claim 1, wherein:
the remotely located receiver node comprises a wireless transceiver, or
the remotely located receiver node comprises a modem, or
the electric vehicle communicating node comprises a wireless transceiver, or
the electric vehicle communicating node comprises a modem, or
the local area network comprises a personal area network or home area network.

8. The system of claim 1, further comprising electric vehicle charging equipment in communication with the electric vehicle, and
wherein an electric utility meter is a communicating node that collects charging session information and the datalogger report and transmits both as a table to an electric utility service provider vehicle database, and
further comprising a processor that calculates a usage fee owed to a fee collecting jurisdictional authority.

9. The system of claim 8, wherein the electric vehicle charging equipment comprises an embedded local area network node.

10. The system of claim 8 configured whereby the user causes the electric vehicle to store in long-term erasable memory the trust level selection for specific electric vehicle charging equipment by means of the electric vehicle user interface.

11. A method of assessing electric vehicle usage fees comprising:
configuring an electric vehicle comprising an electric vehicle user interface having a plurality of selectable trust level inputs;
calculating the geographic position of the electric vehicle and distinguishing road classes and waypoints with a navigation system that is in communication with a datalogger;
storing information comprising vehicle information and user information with an electronic control unit that is in communication with the datalogger;
creating a report with the datalogger based on a selected trust level that comprises vehicle information and user information retrieved from the electronic control unit, and information from the navigation system comprising mileage traveled by road classes and waypoints;
transmitting the report based on the selected trust level to a local area network comprising a plurality of communicating nodes,
wherein the electric vehicle is a communicating node that transmits the report, and
wherein a remotely located receiver node is a communicating node that receives the report based on the selected trust level.

12. The method of claim 11, wherein the method includes one or more of the following such that the report:
comprises a sequence of data that is not encrypted,
comprises a sequence of data that is encrypted,
is not encrypted and comprises compiled data, and/or
is encrypted and comprises compiled data.

13. The method of claim 11, further comprising:
calculating a usage fee owed to one or more fee collecting jurisdictional authority,
issuing a usage fee billing to a vehicle user, and
collecting a usage fee from a vehicle user.

14. The method of claim 13, further comprising remitting the collected usage fee:
directly to a fee collecting jurisdictional authority, or
to an authorized third party settlement agency, or
to an electric utility service provider, or
to an electric utility service provider that further remits the collected usage fee to a fee collecting jurisdictional authority or other authorized third party.

15. The method of claim 13, wherein at least one fee collecting jurisdictional authority determines the usage fee to be a tax.

16. The method of claim 11, wherein the datalogger memory is cleared based on the selected trust level or is cleared by an end of life decommissioning of the vehicle.

17. The method of claim 11, wherein:
the remotely located receiver node comprises a wireless transceiver, or
the remotely located receiver node comprises a modem, or
the electric vehicle communicating node comprises a wireless transceiver, or
the electric vehicle communicating node comprises a modem, or
the local area network comprises a personal area network or home area network.

18. The method of claim 11, further comprising charging the electric vehicle, collecting charging session information and the datalogger report and transmitting both to an electric utility service provider that is a communicating node.

19. The method of claim 11, further comprising storing the trust level selection for specific electric vehicle charging equipment by means of the electric vehicle user interface.

20. A system for settling electric vehicle usage fees between electric utility service providers and jurisdictional authorities comprising:
a means of communication for an authorized party to digitally and securely collect electric vehicle user information from an electric utility service provider;
an authorized third party database that collects electric vehicle user information and thoroughfare usage attributable to discrete jurisdictions traveled from a plurality of electric utility service provider databases;
an authorized third party processor that determines the amount of usage fees to be billed to an individual electric vehicle user;
a further authorized third party processor that determines the collective usage fees attributable to one or more electric vehicle user to be collected by an electric utility service provider that will be remitted to a jurisdictional authority for a defined billing period;
a means of communication allowing the authorized third party to transmit the remittance calculations to one or more electric utility service provider for inclusion in the electric vehicle user periodic billing;
a further authorized third party processor that calculates remittance amounts owed between jurisdictional authorities and prepares a usage fee remittance advice to a fee collecting jurisdictional authority;
an authorized third party collection and remittance processor that facilitates payment received from an electric utility service provider and transmits monetary sums to one or more jurisdictional authority;
an authorized third party collection and remittance processor that facilitates payment received from a jurisdictional authority and transmits monetary sums to one or more jurisdictional authority

21. The system of claim 20, wherein the authorized third party database collects billing determinants and usage information, computes electric vehicle user fees owed to one or more private entity attributable to said users travel over respective private thoroughfare, communicates with utility service providers to enable collection of usage fees from one or more electric vehicle user, provides periodic reports to one or more private entity, facilitates collection of payment from one or more utility service provider and transmits payment to one or more private entity.
